(19) United States
(12) Patent Application Publication
(10) Pub. No.: US 2026/0368477 A1
(43) Pub. Date: Nov. 19, 2026

(54) DATAFLOW PROCESSING ARCHITECTURE FOR NEURAL NETWORK EXECUTION USING DATA-DRIVEN SCHEDULING, TILE-BASED COMPUTATION, AND BUFFERED PRODUCER-CONSUMER COORDINATION

(71) Applicant: Mythic, Inc., Round Rock, TX (US)

(72) Inventors: Malav Parikh, Austin, TX (US); Laura Fick, Hutto, TX (US); Dave Fick, Hutto, TX (US); Paul Toth, Austin, TX (US); Andrew Morten, Austin, TX (US); Pei-Ci Wu, Austin, TX (US)

(73) Assignee: Mythic, Inc., Round Rock, TX (US)

(21) Appl. No.: 19/684,356

(22) Filed: May 21, 2026

Related U.S. Application Data
(63) Continuation of application No. PCT/US26/27967, filed on May 13, 2026.
(60) Provisional application No. 64/064,112, filed on May 12, 2026.
(60) Provisional application No. 63/805,230, filed on May 13, 2025.

(51) Int. Cl. G06N 3/042

(52) U.S. Cl. CPC G06N 3/042

(57) ABSTRACT

A dataflow processing system and method for executing neural network operations using asynchronous producer-consumer buffering are disclosed. A processing system may allocate producer-consumer buffers between dependent operations of a neural network graph and may enable consumer operations to begin execution prior to completion of full output generation by producer operations. Buffer management circuitry may maintain buffer state indicators, tokenized dependency indicators, readiness conditions, and producer-consumer counters associated with availability of intermediate data. A dataflow processing unit may coordinate streaming execution pipelines, heterogeneous compute resources, and data movement operations using buffer access structures and scheduling logic. In some embodiments, line-buffer architectures, tile-level streaming, scatter-gather transfers, and in-stream operations may support overlapping execution, reduced memory utilization, improved data locality, reduced synchronization overhead, and increased throughput for neural network processing within integrated circuits, accelerator devices, chiplet architectures, and distributed processing systems.

### CROSS-REFERENCE TO RELATED APPLICATIONS

This application is a continuation of US PCT Patent Application number PCT/US26/27967, filed 13 MAY 2026, which claims the benefit of US Provisional Application number 63/805,230, filed 13 MAY 2025, and US Provisional Application number 64/064,112, filed 12 MAY 2026, which are incorporated herein their entireties by this reference.

### TECHNICAL FIELD

The present application relates generally to computing architectures for executing machine learning workloads, and more particularly to hardware-accelerated dataflow processing architectures for executing neural network graphs. More specifically, the present application relates to systems and methods for performing neural network computations using tile-based data processing, buffered producer–consumer coordination, and data-driven scheduling mechanisms implemented in a dataflow processing unit that orchestrates computation and data movement across heterogeneous compute resources and memory subsystems.

### BACKGROUND

Artificial intelligence workloads, including deep neural network models, have become increasingly prevalent across a wide range of computing environments, including cloud computing systems, edge devices, and embedded systems. Execution of such workloads typically involves performing a sequence of computational operations organized as a neural network graph, in which nodes correspond to operations and edges represent data dependencies between the operations.

Traditional approaches for executing neural network graphs often rely on sequential or layer-by-layer processing models. In such approaches, a given operation is executed only after completion of one or more preceding operations, and intermediate data corresponding to entire tensors is materialized and stored before subsequent operations begin. While such approaches may simplify scheduling and control flow, such approaches may result in underutilization of compute resources, increased memory bandwidth consumption, and elevated latency, particularly for large-scale neural network models.

To improve performance, some systems employ parallel processing techniques in which multiple operations may be executed concurrently. However, existing parallel processing approaches often rely on coarse-grained synchronization mechanisms, such as global barriers or stage-level coordination, which may introduce inefficiencies. For example, even when portions of data required for downstream operations are available, such downstream operations may be forced to wait until all required data has been produced, thereby limiting opportunities for overlapping computation and data movement.

In addition, conventional execution models frequently depend on centralized scheduling mechanisms, such as processor-managed instruction streams or software-based runtime systems, to coordinate execution of operations. Such centralized control structures may introduce bottlenecks, particularly in systems comprising multiple heterogeneous compute units. Furthermore, such approaches may incur overhead associated with runtime dependency tracking, scheduling decisions, and synchronization management, which may reduce overall system efficiency.

Memory management also presents significant challenges in neural network execution. Many existing systems allocate memory for intermediate data at a granularity corresponding to entire tensors or large data structures. Such approaches may require substantial on-chip or off-chip memory capacity and may result in inefficient data movement, particularly when only portions of the data are required at any given time. In some cases, data may be repeatedly transferred between memory hierarchies, increasing power consumption and reducing performance.

Attempts to address these challenges have included the use of tiling or partitioning techniques, in which large data structures are divided into smaller portions for processing. However, such techniques are often implemented in conjunction with static scheduling strategies or rigid execution models that do not fully exploit the potential for fine-grained data availability. As a result, such systems may not achieve optimal overlap between computation and data movement and may still suffer from inefficiencies associated with synchronization and memory utilization.

Furthermore, existing hardware architectures for neural network acceleration often separate computation, memory access, and scheduling into loosely coordinated subsystems. Such separation may limit the ability of the system to dynamically adapt execution based on real-time data availability and resource conditions. In particular, lack of tight integration between data movement mechanisms, buffering structures, and execution control may result in idle compute resources, stalled pipelines, and suboptimal throughput.

Accordingly, there exists a need for improved computing architectures and execution techniques for neural network workloads that address one or more of the foregoing limitations. In particular, there exists a need for systems that enable fine-grained execution based on partial data availability, reduce reliance on centralized scheduling, improve utilization of on-chip memory resources, and support efficient coordination of computation and data movement across heterogeneous hardware components.

### BRIEF SUMMARY OF THE EMBODIMENTS

In one embodiment, a method of accelerating execution of a neural network graph includes receiving, at an input data buffer of the neural network graph, an input dataset partitioned into a plurality of execution tiles, wherein each execution tile comprises a subset of the input dataset. The neural network graph may be configured with a partial-data execution condition that, when satisfied, causes execution of the neural network graph using less than an entirety of the input dataset. Execution of the neural network graph may be repeated across a plurality of instances corresponding to the plurality of execution tiles. The method further includes causing execution of the neural network graph responsive to detecting storage of a given execution tile within the input data buffer, wherein execution is repeated until a tile output corresponding to each execution tile is generated and stored within an output data buffer.

In one embodiment, the neural network graph comprises a plurality of graphical nodes representing data transformations connected by graphical edges representing data dependencies, wherein each execution tile propagates independently through a sequence of the plurality of graphical nodes until a corresponding tile output is generated.

In one embodiment, the method includes configuring a token counter associated with execution of the plurality of instances of the neural network graph, wherein the token counter is configured based on a number of execution tiles associated with the input dataset.

In one embodiment, accumulation of execution tiles generates one or more execution tokens that, when detected, satisfy the partial-data execution condition for initiating execution of one or more graphical nodes of the neural network graph.

In one embodiment, execution of a downstream graphical node is initiated prior to completion of generation of an entire tensor output by an upstream graphical node. The downstream graphical node may consume a first subset of tensor data while the upstream graphical node concurrently generates a second subset of tensor data.

In one embodiment, the partial-data execution condition is satisfied responsive to detection of a threshold quantity of stored tensor data or a threshold quantity of execution tiles within one or more data buffers associated with the neural network graph.

In one embodiment, the plurality of execution tiles are processed in a pipelined execution sequence, wherein a first execution tile is consumed by a downstream graphical node while a second execution tile is concurrently generated by an upstream graphical node.

In one embodiment, the plurality of execution tiles are generated during a compilation process configured to partition the input dataset according to tensor dimensions, memory constraints, hardware buffer capacity, or execution scheduling constraints.

In one embodiment, the token counter is incremented or decremented responsive to completion of processing associated with one or more execution tiles of the plurality of execution tiles.

In one embodiment, the output data buffer comprises a producer-consumer buffer configured to store tile outputs generated by upstream graphical nodes and to make the tile outputs accessible to downstream graphical nodes prior to completion of processing of an entirety of the input dataset.

In another embodiment, a dataflow processing system for accelerating execution of a neural network graph includes one or more compute resources, a memory storing input data and intermediate data, a buffer access cluster configured to move data between the memory and the one or more compute resources, and a token and operation manager configured to schedule execution of operations of the neural network graph. The token and operation manager may be configured to receive a neural network graph comprising a plurality of operations and data dependencies, partition input data associated with at least one operation into a plurality of execution tiles, identify a subset of execution tiles required to initiate execution of a target operation, determine that a partial-data execution condition is satisfied based on availability of the subset of execution tiles without requiring availability of all input data associated with the target operation, dispatch the target operation to one or more compute resources, generate one or more intermediate tile outputs, and make the one or more intermediate tile outputs available to at least one downstream operation prior to completion of processing of all execution tiles associated with the target operation.

In one embodiment, the partial-data execution condition comprises a multi-dimensional readiness condition requiring: (i) availability of a minimum number of execution tiles corresponding to a tile-processing window associated with the target operation, (ii) availability of output buffer capacity for storing generated intermediate tile outputs, and (iii) availability of at least one compute resource capable of executing the target operation.

In one embodiment, the token and operation manager repeatedly dispatches the target operation across successive subsets of execution tiles such that execution of the target operation is performed incrementally and in a streaming manner as additional execution tiles become available.

In one embodiment, intermediate tile outputs are written to a producer-consumer buffer and one or more tokenized dependency indicators are generated to update one or more resource counters associated with one or more downstream operations of the neural network graph.

In another embodiment, a method for accelerating execution of a neural network graph using a dataflow processing system includes receiving a neural network graph comprising a plurality of operations and data dependencies, partitioning input data associated with at least one operation into a plurality of execution tiles, identifying a subset of execution tiles required to initiate execution of a target operation, determining that a partial-data execution condition is satisfied based on availability of the subset of execution tiles without requiring availability of all input data associated with the target operation, dispatching the target operation to at least one compute resource, generating one or more intermediate tile outputs using the subset of execution tiles, and making the one or more intermediate tile outputs available to one or more downstream operations prior to completion of processing associated with all execution tiles corresponding to the target operation.

In one embodiment, determining that the partial-data execution condition is satisfied includes evaluating a multi-dimensional readiness condition comprising: (i) availability of a minimum number of execution tiles corresponding to a tile-processing window, (ii) availability of output buffer capacity, and (iii) availability of a compute resource capable of executing the target operation.

In one embodiment, dispatching the target operation includes repeatedly dispatching the target operation across successive subsets of execution tiles such that execution of the target operation is performed incrementally in a streaming manner.

In one embodiment, making the one or more intermediate tile outputs available includes writing the one or more intermediate tile outputs to a producer-consumer buffer and generating one or more tokenized dependency indicators corresponding to availability of the one or more intermediate tile outputs.

In one embodiment, generating the one or more intermediate tile outputs includes executing the target operation on a subset of input data corresponding to a tile-processing window and accumulating partial results across multiple subsets of execution tiles to generate a complete output.

In one embodiment, a method for executing operations of a neural network graph using asynchronous producer-consumer buffering includes receiving, by a processing system comprising one or more hardware compute resources, a neural network graph comprising a plurality of operations. The method further includes allocating, within a memory structure, a producer-consumer buffer between a producer operation and a consumer operation of the plurality of operations, writing, by the producer operation, data associated with execution of the producer operation into the producer-consumer buffer, and maintaining, by buffer management circuitry, one or more buffer state indicators associated with the producer-consumer buffer. The one or more buffer state indicators may indicate availability of data stored within the producer-consumer buffer. The method further includes determining that a consumption condition associated with the consumer operation is satisfied based on the one or more buffer state indicators indicating that at least a threshold amount of data is available within the producer-consumer buffer, initiating execution of the consumer operation responsive to satisfaction of the consumption condition prior to completion of generation of a full output dataset by the producer operation, and continuing, concurrently with execution of the consumer operation, writing additional data into the producer-consumer buffer by the producer operation, wherein execution timing of the producer operation is decoupled from execution timing of the consumer operation using the producer-consumer buffer such that execution of the consumer operation progresses asynchronously relative to execution of the producer operation without requiring global synchronization across the neural network graph.

In one embodiment, the producer-consumer buffer comprises a circular buffer configured to reuse buffer storage locations by advancing a write pointer and a read pointer through the circular buffer during execution of the producer operation and the consumer operation.

In one embodiment, the buffer management circuitry determines a buffer occupancy associated with the producer-consumer buffer based on a relative position of the write pointer and the read pointer and generates one or more execution readiness indicators based on the buffer occupancy satisfying the consumption condition associated with the consumer operation.

In one embodiment, the producer operation continues generating and writing additional data into the producer-consumer buffer while the consumer operation simultaneously reads previously written data from the producer-consumer buffer such that production and consumption of the data temporally overlap without requiring completion of the producer operation prior to initiation of the consumer operation.

In one embodiment, the producer-consumer buffer is implemented using on-chip memory comprising static random-access memory (SRAM) configured to store intermediate data exchanged between the producer operation and the consumer operation.

In one embodiment, the producer-consumer buffer is configured as a line buffer that stores a subset of rows of an input tensor required for execution of the consumer operation.

In one embodiment, the method further includes tracking, by scheduling circuitry, one or more producer-consumer counters associated with the producer-consumer buffer, wherein the one or more producer-consumer counters indicate quantities of produced data and consumed data associated with the producer-consumer buffer, and wherein execution of the consumer operation is initiated based on the one or more producer-consumer counters satisfying the consumption condition.

In one embodiment, the scheduling circuitry increments a producer counter responsive to writes performed by the producer operation into the producer-consumer buffer and decrements available buffer capacity responsive to reads performed by the consumer operation.

In one embodiment, the consumption condition is satisfied when less than an entirety of an output dataset generated by the producer operation has been written into the producer-consumer buffer.

In one embodiment, the producer operation comprises a data movement operation executed by a direct memory access (DMA) engine and the consumer operation comprises a compute operation executed by a hardware accelerator such that the DMA engine streams data into the producer-consumer buffer concurrently with execution of the compute operation.

In one embodiment, the producer-consumer buffer is configured to support continuous streaming execution by reusing previously consumed storage regions of the producer-consumer buffer for newly produced data associated with subsequent execution operations.

In one embodiment, the consumer operation initiates execution responsive to detection that a minimum quantity of input data required for performing the consumer operation is present within the producer-consumer buffer.

In one embodiment, the method further includes coordinating, by a hardware scheduler, execution of the producer operation and the consumer operation based on buffer state information associated with the producer-consumer buffer, wherein the hardware scheduler causes execution of the consumer operation without requiring a centralized processor to sequence execution of the producer operation and the consumer operation.

In one embodiment, the producer operation and the consumer operation correspond to graphical nodes of the neural network graph that execute asynchronously based on availability of intermediate data within the producer-consumer buffer rather than completion of execution of upstream graphical nodes.

In one embodiment, the producer-consumer buffer forms part of a streaming execution pipeline in which multiple operations of the neural network graph concurrently execute on different subsets of tensor data.

In one embodiment, a first operation of the streaming execution pipeline writes a first subset of tensor data into the producer-consumer buffer while a second operation of the streaming execution pipeline simultaneously consumes a second subset of tensor data previously stored within the producer-consumer buffer.

In another embodiment, a system for executing operations of a neural network graph using asynchronous producer-consumer buffering includes one or more hardware compute resources configured to execute a plurality of operations associated with a neural network graph, a memory structure comprising a producer-consumer buffer allocated between a producer operation and a consumer operation of the plurality of operations, and buffer management circuitry configured to maintain one or more buffer state indicators associated with the producer-consumer buffer and determine that a consumption condition associated with the consumer operation is satisfied based on the one or more buffer state indicators indicating that at least a threshold amount of data is available within the producer-consumer buffer. The producer operation may be configured to write data associated with execution of the producer operation into the producer-consumer buffer, the consumer operation may be configured to initiate execution responsive to satisfaction of the consumption condition prior to completion of generation of a full output dataset by the producer operation, and the producer operation may continue writing additional data into the producer-consumer buffer concurrently with execution of the consumer operation such that execution timing of the producer operation is decoupled from execution timing of the consumer operation using the producer-consumer buffer and execution of the consumer operation progresses asynchronously relative to execution of the producer operation.

In one embodiment, the producer-consumer buffer decouples a rate of data production associated with the producer operation from a rate of data consumption associated with the consumer operation such that temporary mismatches between production throughput and consumption throughput do not stall execution of the producer operation or the consumer operation.

In one embodiment, the buffer management circuitry permits initiation of execution of the consumer operation responsive to availability of a partial subset of tensor data within the producer-consumer buffer prior to storage of an entirety of tensor data generated by the producer operation.

In one embodiment, the producer operation is executed by a direct memory access (DMA) engine configured to stream tensor data into the producer-consumer buffer and the consumer operation is executed by a hardware accelerator configured to consume the tensor data from the producer-consumer buffer concurrently with continued streaming of additional tensor data by the DMA engine.

In one embodiment, a method of scheduling execution of operations within a neural network graph includes storing, within one or more memory structures of a dataflow processing architecture, a plurality of execution readiness conditions associated with a plurality of operations of the neural network graph. The method further includes maintaining, by scheduling circuitry of the dataflow processing architecture, one or more resource counters corresponding to at least input data availability associated with one or more producer-consumer buffers and output buffer capacity associated with one or more destination buffers. The method further includes receiving one or more dataflow trigger events generated responsive to at least one of completion of a data transfer, production of intermediate data, consumption of buffered data, or update of a dependency state associated with an operation of the neural network graph, updating the one or more resource counters responsive to the one or more dataflow trigger events, evaluating the plurality of execution readiness conditions using the one or more updated resource counters to determine whether a selected operation of the neural network graph is eligible for execution, determining that the selected operation is eligible for execution based on determining that a threshold amount of input data is available within a producer-consumer buffer associated with the selected operation and determining that sufficient output buffer capacity exists for storing output data generated by the selected operation, dispatching the selected operation to a hardware execution resource responsive to determining that the selected operation is eligible for execution, and initiating execution of the selected operation without requiring execution according to a predetermined instruction sequence or centralized processor-managed scheduling order.

In one embodiment, the one or more producer-consumer buffers comprise circular buffer structures configured to permit concurrent write operations by a producer operation and read operations by a consumer operation such that execution timing between the producer operation and the consumer operation is decoupled.

In one embodiment, the plurality of execution readiness conditions are evaluated independently of a sequential program counter or instruction-order dependency such that the selected operation becomes eligible for execution based on buffer-state information associated with the one or more producer-consumer buffers.

In one embodiment, the method further includes generating one or more tokenized dependency indicators responsive to production of intermediate data within the one or more producer-consumer buffers and updating the one or more resource counters using the one or more tokenized dependency indicators to trigger reevaluation of at least one execution readiness condition associated with the selected operation.

In one embodiment, dispatching the selected operation to the hardware execution resource includes enqueueing an operation descriptor into a hardware-managed work queue associated with the hardware execution resource responsive to satisfaction of the plurality of execution readiness conditions.

In one embodiment, the one or more resource counters comprise an input-availability counter corresponding to an amount of valid data stored within a producer-consumer buffer and an output-capacity counter corresponding to an amount of available storage capacity within a destination buffer associated with the selected operation.

In one embodiment, the scheduling circuitry repeatedly reevaluates the plurality of execution readiness conditions responsive to successive dataflow trigger events generated during asynchronous execution of multiple operations of the neural network graph.

In one embodiment, the one or more dataflow trigger events comprise at least one of a direct memory access (DMA) completion event, a buffer write event, a buffer consumption event, an operation completion event, or a dependency-state update event associated with the neural network graph.

In one embodiment, the hardware execution resource comprises one or more heterogeneous compute resources selected from the group comprising a matrix multiplication engine, a vector processing engine, an arithmetic processing engine, a convolution engine, a pooling engine, and a data movement engine.

In one embodiment, initiating execution of the selected operation includes initiating execution prior to completion of an upstream operation associated with the selected operation such that execution of the selected operation begins responsive to availability of a threshold portion of intermediate data generated by the upstream operation.

In one embodiment, the one or more resource counters are stored within a shared memory structure accessible by a plurality of hardware scheduling components configured to coordinate execution of operations of the neural network graph.

In one embodiment, the scheduling circuitry dispatches multiple operations concurrently based on independent satisfaction of corresponding execution readiness conditions associated with the multiple operations.

In one embodiment, the plurality of execution readiness conditions comprise a first readiness condition corresponding to availability of a threshold quantity of input data within a producer-consumer buffer, a second readiness condition corresponding to availability of output buffer capacity, and a third readiness condition corresponding to availability of the hardware execution resource associated with the selected operation.

In one embodiment, the scheduling circuitry performs hardware-based dependency evaluation without intervention from a centralized processor during runtime execution of the neural network graph.

In one embodiment, dispatching the selected operation includes transmitting an execution dispatch signal from a token and operation management circuit to a hardware controller associated with the hardware execution resource.

In one embodiment, the scheduling circuitry schedules execution of operations at a granularity corresponding to execution tiles or partial-data units propagated through the neural network graph.

In another embodiment, a system for scheduling execution of operations within a neural network graph includes one or more hardware execution resources configured to execute a plurality of operations associated with the neural network graph, one or more memory structures configured to store a plurality of execution readiness conditions associated with the plurality of operations, one or more producer-consumer buffers, and one or more resource counters associated with availability of data and buffer capacity, and scheduling circuitry configured to receive one or more dataflow trigger events generated responsive to at least one of completion of a data transfer, production of intermediate data, consumption of buffered data, or update of a dependency state associated with an operation of the neural network graph. The scheduling circuitry may further update the one or more resource counters responsive to the one or more dataflow trigger events, evaluate the plurality of execution readiness conditions using the one or more updated resource counters to determine whether a selected operation of the plurality of operations is eligible for execution, determine that the selected operation is eligible for execution based on determining that a threshold amount of input data is available within a producer-consumer buffer associated with the selected operation and determining that sufficient output buffer capacity exists for storing output data generated by the selected operation, and dispatch the selected operation to a selected hardware execution resource responsive to determining that the selected operation is eligible for execution. The scheduling circuitry may initiate execution of the selected operation without requiring execution according to a predetermined instruction sequence or centralized processor-managed scheduling order, wherein execution readiness of the selected operation is determined based on states of the one or more producer-consumer buffers and the one or more resource counters rather than sequential program flow.

In one embodiment, the scheduling circuitry determines execution readiness of the selected operation based on a quantity of valid data stored within a producer-consumer buffer associated with the selected operation and an amount of available storage capacity within an output buffer associated with the selected operation.

In one embodiment, the scheduling circuitry reevaluates the plurality of execution readiness conditions responsive to successive dataflow trigger events occurring during asynchronous execution of operations of the neural network graph.

In one embodiment, the scheduling circuitry initiates execution of the selected operation prior to completion of generation of an entire output tensor by an upstream operation associated with the selected operation.

In one embodiment, a dataflow processing unit (DPU) includes a token and operation manager configured to maintain dependency information associated with a plurality of operations of a neural network graph and to generate operation dispatch information based on one or more dataflow trigger events. The dataflow processing unit may further include a buffer access cluster configured to manage producer-consumer buffering associated with execution of the plurality of operations, wherein the buffer access cluster is configured to coordinate movement of data between compute resources and memory resources. The dataflow processing unit may further include a memory subsystem comprising a static random-access memory (SRAM) controller and a local SRAM configured to store operation configuration data, buffer configuration data, queue state data, or token state data associated with execution of the plurality of operations, a plurality of heterogeneous compute resources comprising one or more analog compute engines (ACEs), one or more single instruction multiple data (SIMD) engines, or one or more direct memory access (DMA) engines, and an interconnect coupled to the token and operation manager, the buffer access cluster, the memory subsystem, and the plurality of heterogeneous compute resources. The token and operation manager may dynamically schedule execution of operations of the neural network graph based on availability of input data within one or more buffers, availability of one or more compute resources of the plurality of heterogeneous compute resources, and dependency satisfaction information associated with one or more preceding operations of the neural network graph, wherein the dataflow processing unit is configured to execute at least a subset of the plurality of operations asynchronously and in a streaming manner using the producer-consumer buffering.

In one embodiment, the token and operation manager maintains one or more resource counters corresponding to at least one of buffer availability, compute resource availability, or operation completion status, wherein the token and operation manager determines readiness of an operation for execution based on evaluation of the one or more resource counters against one or more execution conditions.

In one embodiment, the buffer access cluster includes a scatter-gather engine configured to perform non-contiguous memory accesses associated with streamed tensor data and a circular buffer controller configured to maintain a read pointer and a write pointer associated with a producer-consumer buffer, wherein the producer-consumer buffer decouples execution timing of a producer operation from execution timing of a consumer operation to enable asynchronous streaming execution of the plurality of operations.

In one embodiment, the plurality of heterogeneous compute resources comprise an analog compute engine configured to perform matrix computation operations associated with neural network execution, a SIMD engine 108 configured to perform vector arithmetic operations, and a DMA engine configured to perform data transfer operations between the local SRAM and one or more external memory resources, wherein the token and operation manager dispatches different operations of the neural network graph to different compute resources based on operation type and resource availability.

In one embodiment, the local SRAM stores one or more work queues corresponding to pending operations of the neural network graph, wherein the token and operation manager retrieves operation descriptors from the one or more work queues to initiate execution of the pending operations without processor-directed instruction sequencing.

In one embodiment, the interconnect comprises a local network-on-chip (NoC) configured to provide concurrent communication paths between the plurality of heterogeneous compute resources, the buffer access cluster, and the memory subsystem, wherein the local network-on-chip supports simultaneous data movement and computation associated with different operations of the neural network graph.

In one embodiment, the buffer access cluster allocates a plurality of tiled buffers within the local SRAM, wherein each tiled buffer corresponds to a subset of tensor data associated with an operation of the neural network graph, and wherein the plurality of heterogeneous compute resources process the subset of tensor data incrementally before an entirety of the tensor data is received within the local SRAM.

In one embodiment, the token and operation manager generates one or more execution tokens in response to completion of a producer operation, wherein the one or more execution tokens trigger initiation of a consumer operation upon satisfaction of one or more dependency conditions associated with the consumer operation.

In one embodiment, the plurality of heterogeneous compute resources execute multiple operations of the neural network graph in parallel, wherein a first compute resource of the plurality of heterogeneous compute resources executes a first operation associated with a first tensor tile and a second compute resource of the plurality of heterogeneous compute resources executes a second operation associated with a second tensor tile concurrently with execution of the first operation.

In one embodiment, the memory subsystem maintains one or more line buffers associated with convolution operations of the neural network graph, wherein the one or more line buffers store less than an entirety of an input feature map required for execution of a convolution kernel such that execution of the convolution kernel is performed using a sliding window of tensor data maintained within the one or more line buffers.

In one embodiment, the token and operation manager determines whether an output buffer associated with an operation contains sufficient available capacity prior to dispatching the operation for execution such that buffer overflow conditions are prevented during streaming execution of the neural network graph.

In one embodiment, the plurality of heterogeneous compute resources comprise a plurality of analog compute engines arranged as independently dispatchable compute tiles, wherein the token and operation manager selectively dispatches different operations of the neural network graph to different compute tiles based on operation readiness and data locality associated with the local SRAM.

In one embodiment, the buffer access cluster performs one or more in-stream data manipulation operations during movement of tensor data between the memory subsystem and the plurality of heterogeneous compute resources, wherein the one or more in-stream data manipulation operations comprise at least one of tensor reshaping, tensor concatenation, tensor tiling, tensor swizzling, or tensor format conversion.

In one embodiment, the token and operation manager evaluates execution readiness conditions using hardware logic circuitry without intervention from a host processor during runtime execution of the neural network graph.

In one embodiment, the memory subsystem stores token lists and dependency tracking structures corresponding to execution relationships between operations of the neural network graph, wherein the token and operation manager updates the token lists and dependency tracking structures responsive to completion of execution events associated with the operations.

In one embodiment, the interconnect supports propagation of intermediate tensor data directly between the plurality of heterogeneous compute resources through one or more producer-consumer buffers without requiring intermediate storage of the intermediate tensor data within an external memory resource.

In another embodiment, a method for operating a dataflow processing unit (DPU) includes maintaining, by a token and operation manager of the dataflow processing unit, dependency information associated with a plurality of operations of a neural network graph and storing, within a memory subsystem comprising a static random-access memory (SRAM) controller and a local SRAM, operation configuration data, buffer configuration data, queue state data, or token state data associated with execution of the plurality of operations. The method may further include managing, by a buffer access cluster of the dataflow processing unit, movement of tensor data between the local SRAM and a plurality of heterogeneous compute resources using one or more producer-consumer buffers, evaluating, by the token and operation manager, one or more execution readiness conditions associated with the plurality of operations based on availability of input data within the one or more producer-consumer buffers, availability of one or more compute resources of the plurality of heterogeneous compute resources, and dependency satisfaction information associated with one or more preceding operations of the neural network graph, dispatching, by the token and operation manager, a selected operation of the plurality of operations to a selected heterogeneous compute resource responsive to determining that the one or more execution readiness conditions are satisfied, executing, by the selected heterogeneous compute resource, the selected operation concurrently with movement of additional tensor data associated with another operation of the plurality of operations, and propagating output data generated by the selected operation through the one or more producer-consumer buffers to one or more downstream operations of the neural network graph. The plurality of heterogeneous compute resources may comprise one or more analog compute engines (ACEs), one or more single instruction multiple data (SIMD) engines, or one or more direct memory access (DMA) engines, wherein the plurality of operations of the neural network graph are executed asynchronously and in a streaming manner under dataflow-based control without centralized processor-managed instruction sequencing.

In one embodiment, the method further includes generating, by the token and operation manager, one or more execution tokens responsive to completion of execution of an upstream operation of the neural network graph and updating one or more dependency counters stored within the local SRAM based on the one or more execution tokens to determine readiness of a downstream operation for execution.

In one embodiment, managing movement of tensor data between the local SRAM and the plurality of heterogeneous compute resources includes performing scatter operations to retrieve non-contiguous tensor data from memory locations within the local SRAM and performing gather operations to assemble the non-contiguous tensor data into execution tiles associated with operations of the neural network graph.

In one embodiment, the plurality of heterogeneous compute resources concurrently execute different operations of the neural network graph on different execution tiles such that a first heterogeneous compute resource executes a first operation associated with a first execution tile and a second heterogeneous compute resource executes a second operation associated with a second execution tile before completion of execution of the first operation associated with the first execution tile.

### BRIEF DESCRIPTION OF THE FIGURES

FIG. 1A illustrates a schematic of a dataflow processing unit (DPU) architecture including compute resources, a buffer access cluster, a token and operation manager, and a memory subsystem in accordance with one or more embodiments of the present application;

FIG. 1B illustrates an example embodiment of a dataflow processing unit with an integrated tile architecture configured to support heterogeneous compute execution and shared-memory coordination in accordance with one or more embodiments of the present application;

FIG. 1C illustrates an example embodiment of a dataflow processing unit having an integrated tile architecture configured to support heterogeneous compute execution using a shared bus-fabric arrangement and shared-memory coordination in accordance with one or more embodiments of the present application;

FIG. 1D illustrates an example embodiment of a dataflow processing unit having an integrated analog compute engine tile and integrated processing cores architecture configured to support heterogeneous compute execution and tiled neural network execution in accordance with one or more embodiments of the present application.

FIGS. 2A-B illustrate an example schematic of a data-driven scheduling and operation dispatch framework including dependency tracking, resource counter evaluation, operation queuing, and hardware controller dispatch in accordance with one or more embodiments of the present application;

FIG. 2C illustrates an example embodiment of a system-on-chip subsystem architecture including heterogeneous subsystem interfaces, memory resources, peripheral resources, and common dataflow processing unit components configured to support execution of neural network operations in accordance with one or more embodiments of the present application;

FIG. 2D illustrates an example embodiment of a system-on-chip subsystem architecture including network-on-chip communication resources, DMA resources, protocol bridge resources, and common dataflow processing unit components configured to support tiled and streaming neural network execution in accordance with one or more embodiments of the present application.

FIG. 2E illustrates an example embodiment of a scalable system-on-chip architecture including a chip-level network-on-chip infrastructure, die-to-die communication interfaces, and one or more analog compute engine tiles configured to support distributed execution of neural network operations in accordance with one or more embodiments of the present application;

FIG. 3 illustrates an example schematic of data movement paths and execution pathways within a dataflow processing unit including interactions between a host system, buffer access cluster, compute resources, token and operation manager, and memory subsystem in accordance with one or more embodiments of the present application;

FIG. 4 illustrates an example schematic of an analog compute engine (ACE) tile including analog compute engines, analog support circuits, control components, and memory and interconnect structures in accordance with one or more embodiments of the present application;

FIG. 5 illustrates an example schematic of a buffer access cluster architecture including address generation logic, data movement engines, and interconnect interfaces for supporting scatter, gather, and in-stream compute operations in accordance with one or more embodiments of the present application;

FIG. 6 illustrates an example schematic of memory subsystem structures including producer–consumer buffers, buffer state indicators, and memory controllers for supporting asynchronous data exchange between operations in accordance with one or more embodiments of the present application;

FIG. 7 illustrates an example schematic of an integrated tile including analog compute engines and digital compute clusters interconnected through a shared memory and interconnect fabric in accordance with one or more embodiments of the present application;

FIG. 8A illustrates an example schematic of tile-based data partitioning and execution tile generation for enabling partial-data execution of operations in accordance with one or more embodiments of the present application;

FIG. 8B illustrates an example embodiment of a buffered neural network execution architecture including intermediate producer–consumer buffers and heterogeneous hardware accelerators configured to support asynchronous execution of neural network operations in accordance with one or more embodiments of the present application;

FIG. 8C illustrates an example embodiment of a producer–consumer execution architecture including a shared intermediate buffer and scheduling logic configured to support asynchronous execution and event-driven coordination of neural network operations in accordance with one or more embodiments of the present application;

FIG. 9A illustrates an example schematic of tile dependency relationships and tile-level dataflow between upstream and downstream operations in accordance with one or more embodiments of the present application;

FIG. 9B illustrates an example embodiment of a neural network execution graph mapped across heterogeneous hardware execution resources configured to support overlapping execution of neural network operations within a dataflow processing architecture in accordance with one or more embodiments of the present application;

FIG. 10 illustrates an example schematic of partial-data execution and overlapping operation execution using subsets of execution tiles in accordance with one or more embodiments of the present application;

FIGS. 11A-B illustrates an example schematic of asynchronous dataflow between operations using producer–consumer buffers and tokenized dependency indicators in accordance with one or more embodiments of the present application;

FIGS. 12A-B illustrates an example method for performing partial-data execution of a neural network graph using execution tiles in accordance with one or more embodiments of the present application;

FIGS. 13A-B illustrates an example method for implementing asynchronous buffering and producer–consumer data exchange between operations in accordance with one or more embodiments of the present application;

FIGS. 14A-B illustrates an example method for performing data-driven scheduling and operation dispatch based on dependency tracking and resource counters in accordance with one or more embodiments of the present application;

FIGS. 15A-B illustrates an example method for partitioning input data into execution tiles and initiating partial-data execution of operations in accordance with one or more embodiments of the present application;

FIGS. 16A-B illustrate an example method for coordinating asynchronous producer–consumer buffer execution between operations in accordance with one or more embodiments of the present application;

FIGS. 17A-B illustrate an example method for performing token-driven scheduling and dispatch of operations based on dataflow trigger events in accordance with one or more embodiments of the present application;

FIGS. 18A-B illustrate an example method for executing operations using heterogeneous compute resources and outputting results in a streaming and overlapping execution pipeline in accordance with one or more embodiments of the present application;

FIG. 19 illustrates an example embodiment of a tile-based neural network execution model configured to perform execution of neural network operations using subsets of input data corresponding to execution tiles in accordance with one or more embodiments of the present application;

FIG. 20 illustrates an example embodiment of a parallel execution model configured to enable concurrent execution of neural network graph operations using heterogeneous hardware resources in accordance with one or more embodiments of the present application; and

FIG. 21 illustrates an example embodiment of a buffer allocation and line-buffer execution architecture configured to support tiled execution and memory-efficient convolution processing in accordance with one or more embodiments of the present application.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### System Overview

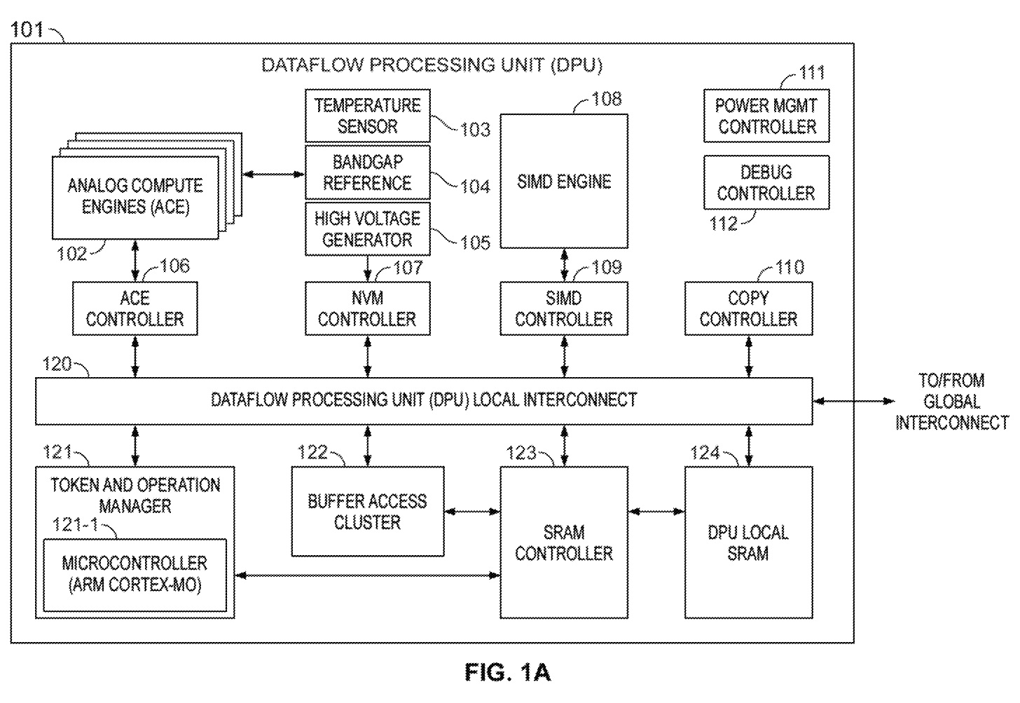

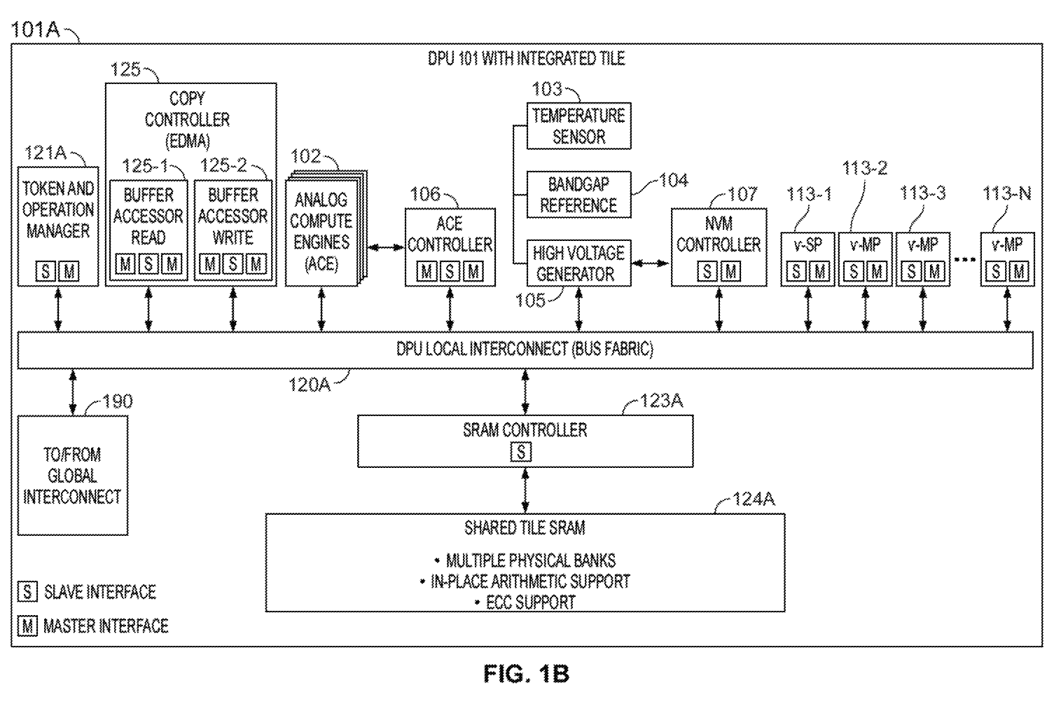

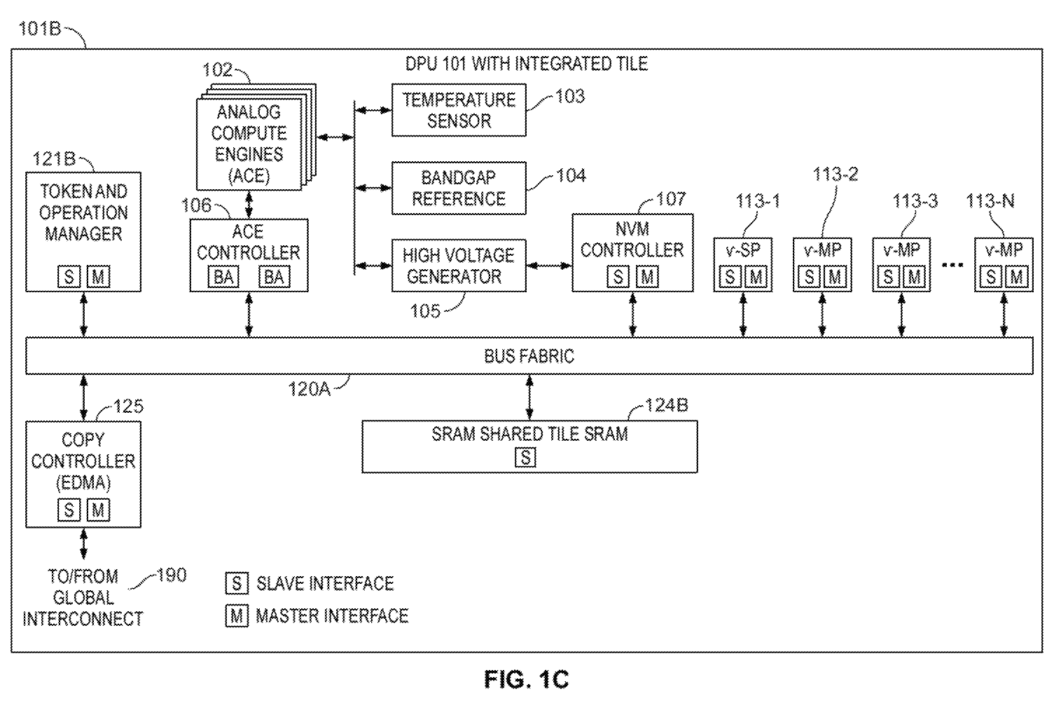

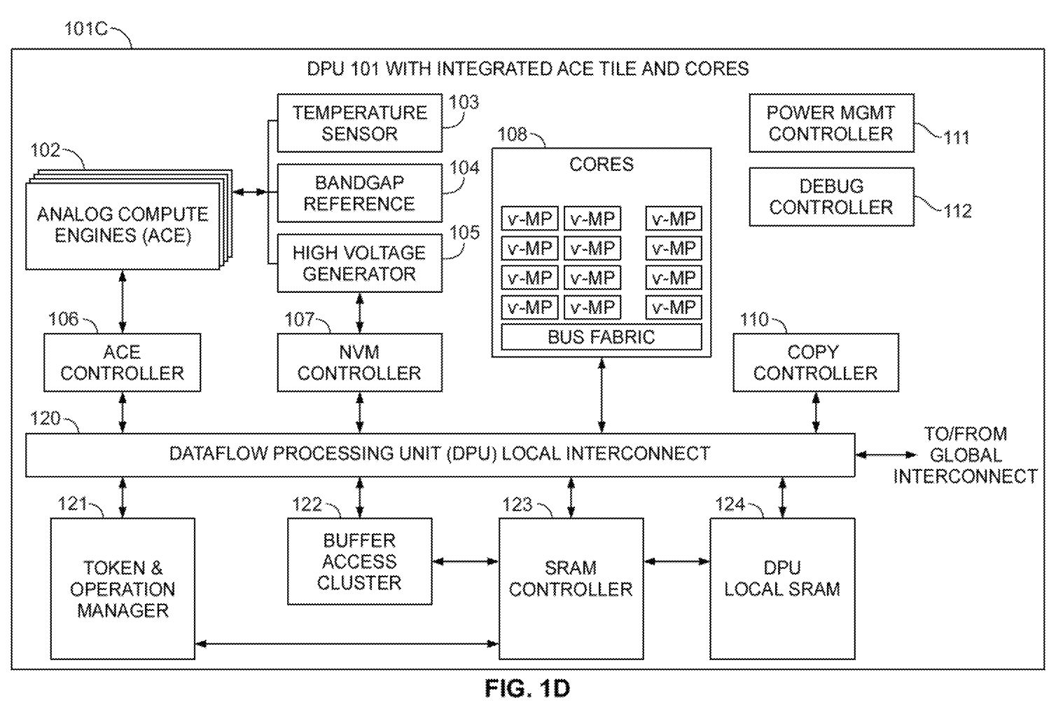

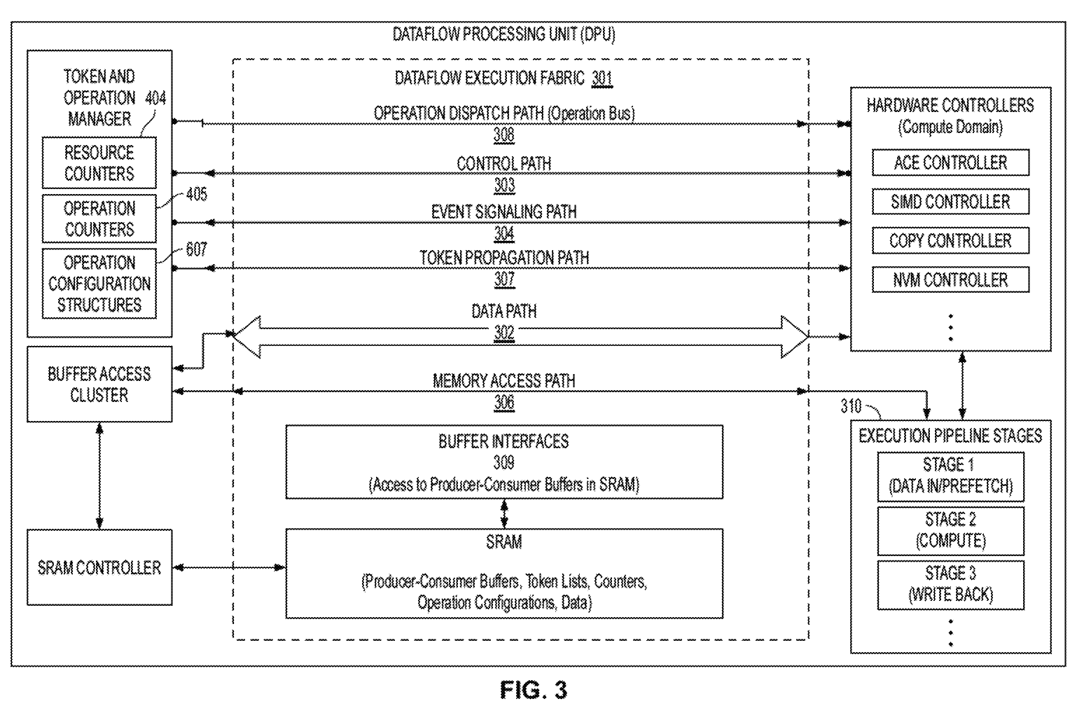

FIG. 1A illustrates an example embodiment of a Dataflow Processing Unit (DPU) 101 that may be configured to execute neural network graphs using a dataflow-based execution model. The Dataflow Processing Unit 101 may form part of a Dataflow Execution Fabric 301 (FIG. 3) in which computation is orchestrated based on data availability and dependency satisfaction rather than a predetermined instruction sequence.

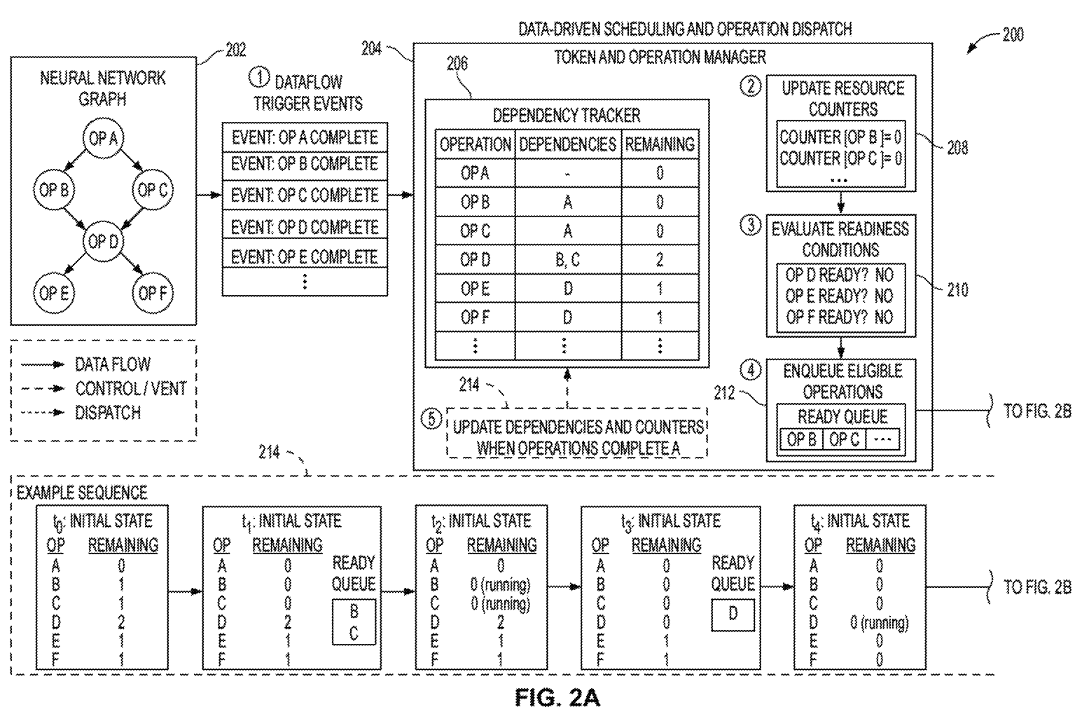

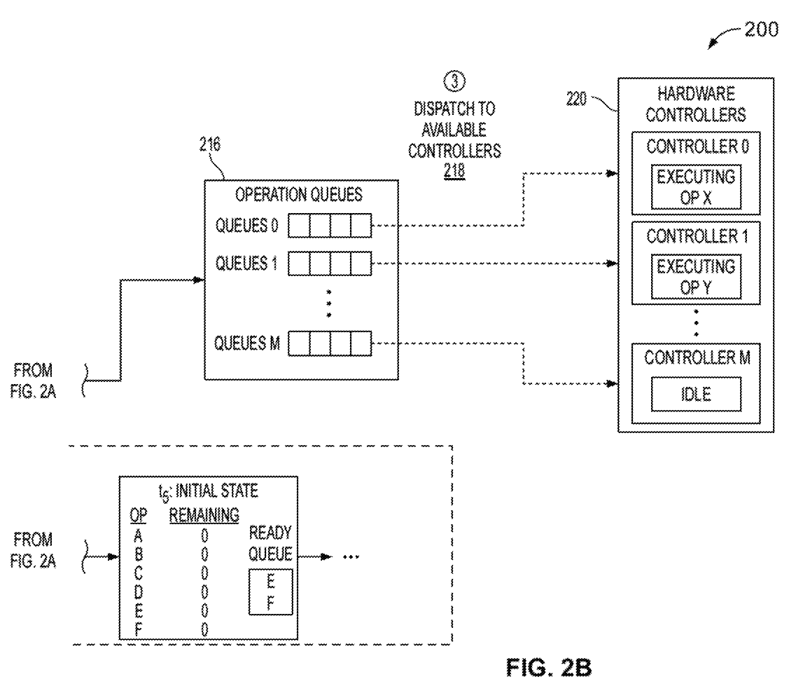

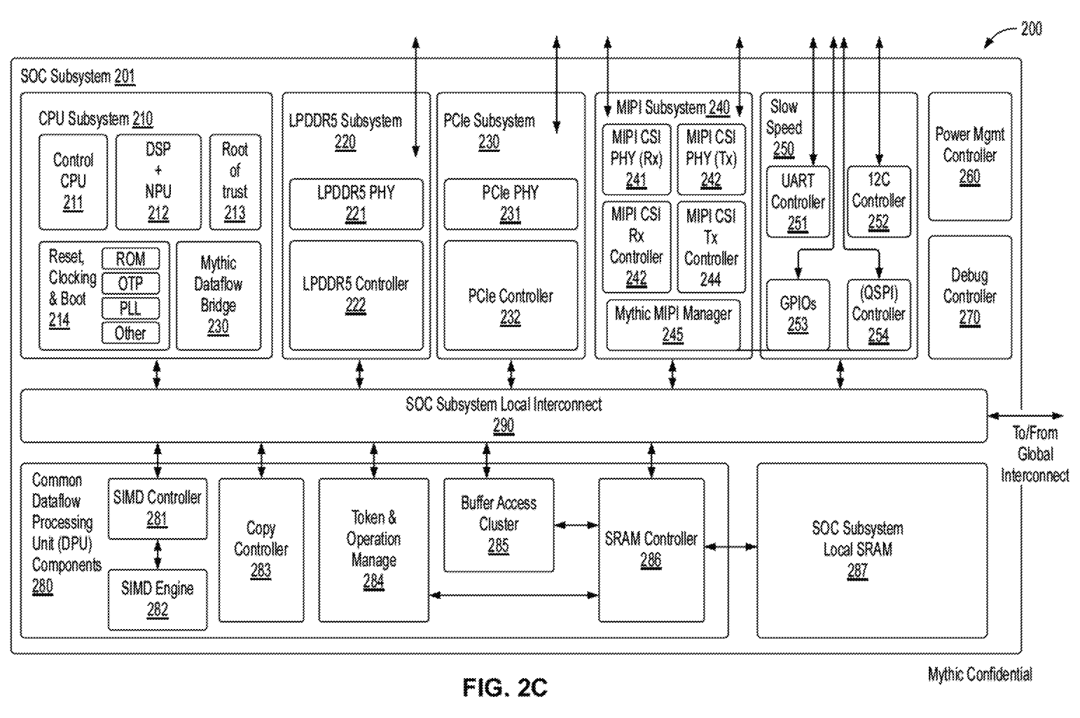

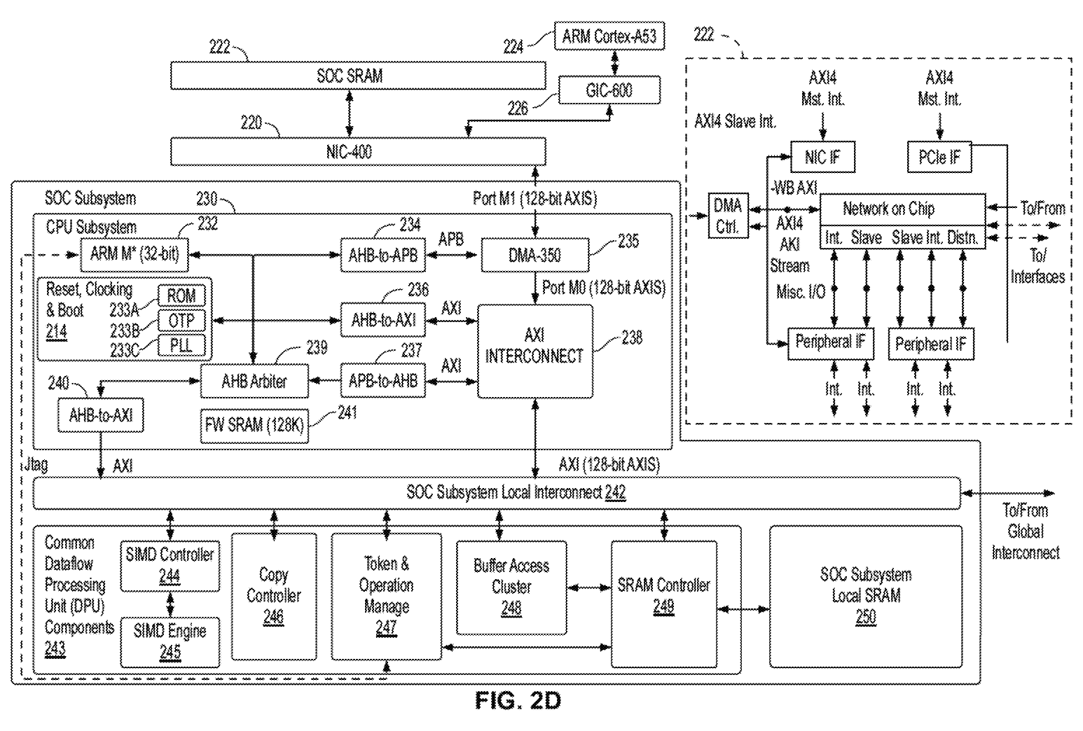

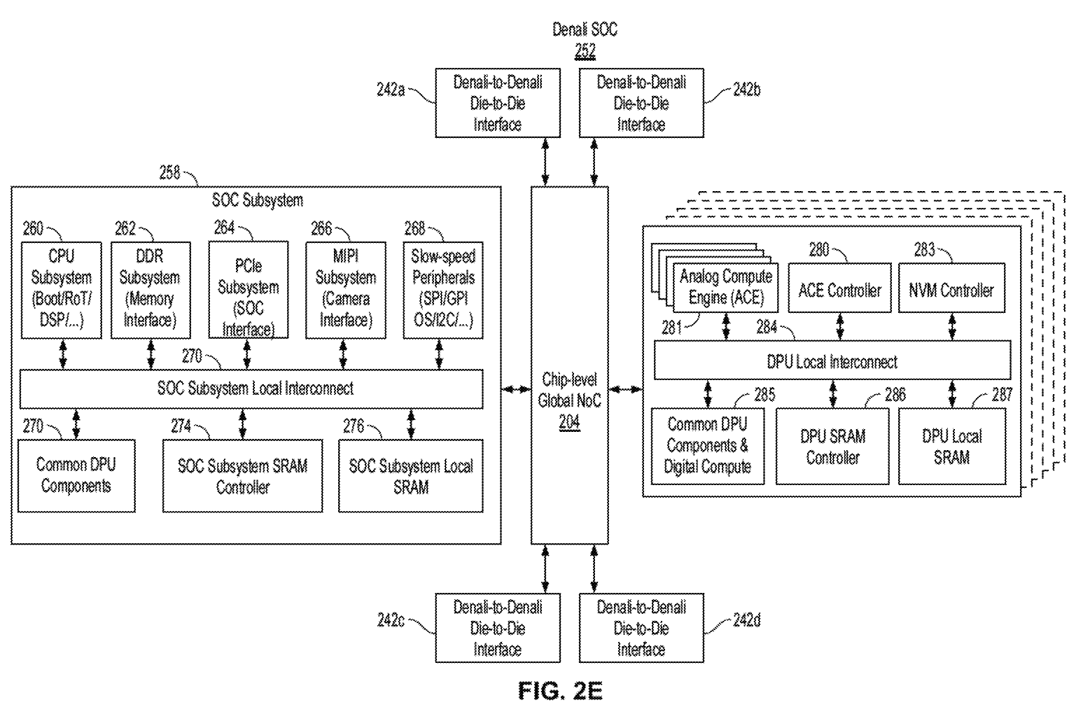

In some embodiments, the Dataflow Processing Unit 101 may include a Token and Operation Manager (TOM) 102, a Buffer Access Cluster (BAC), a Static Random Access Memory (SRAM), an SRAM Controller, one or more compute controllers including an Analog Compute Engine (ACE) Controller 106 and a SIMD Controller, a Copy Controller 110, and a Local Interconnect 109. The Dataflow Processing Unit 101 may further include a Network-on-Chip (NoC) Interface 110 to communicate with external components via a Global Interconnect 204 (FIGS. 2A-2B). Operation dispatch within the Dataflow Processing Unit 101 may be performed over an Operation Bus, while control signaling and data movement may be carried over a Control Path Interface and a Data Path Interface, respectively.

FIGS. 2A-2B illustrates an example embodiment of a System-on-Chip (SoC) 201 that may include a plurality of Dataflow Processing Units 203 arranged in a scalable architecture. The System-on-Chip 201 may include a Host Interface Subsystem 202 coupled to the Dataflow Processing Units 203 via the Global Interconnect 204. The Host Interface Subsystem 202 may communicate with external systems through one or more Peripheral Interfaces 206 and may optionally receive data from a Sensor Interface 207. The System-on-Chip 201 may further include a Runtime Software Stack 208 configured to provide configuration data and execution parameters to the Dataflow Processing Units 203. In some embodiments, the System-on-Chip 201 may interface with an External Memory System 209, an Input Data Source 210, and an Output Data Destination 211.

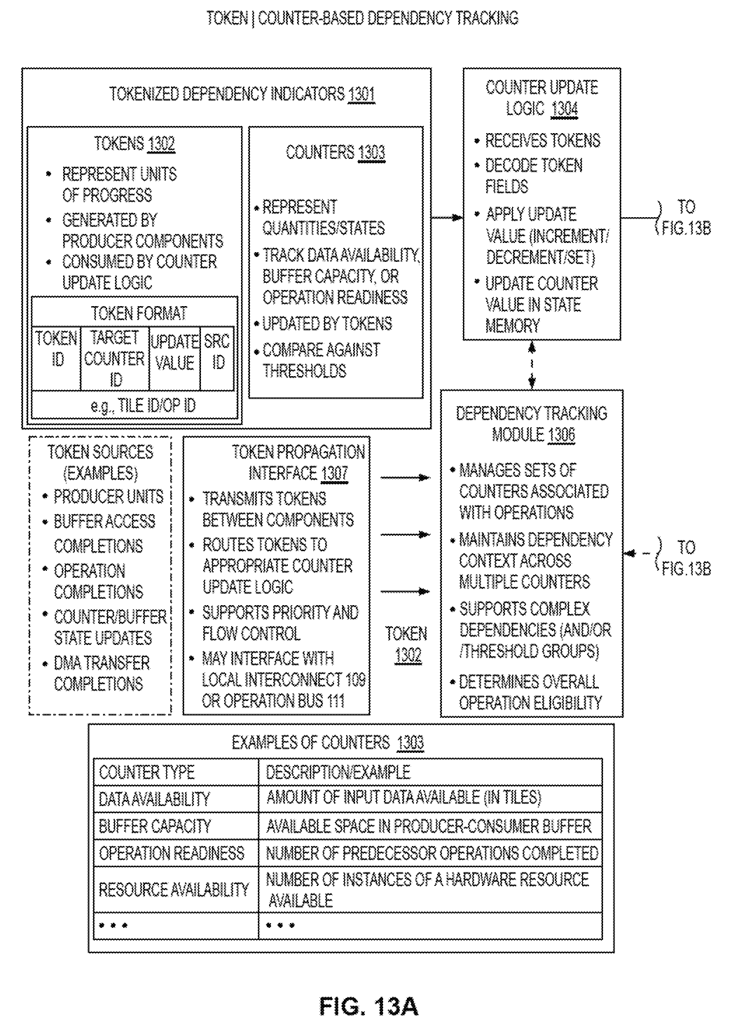

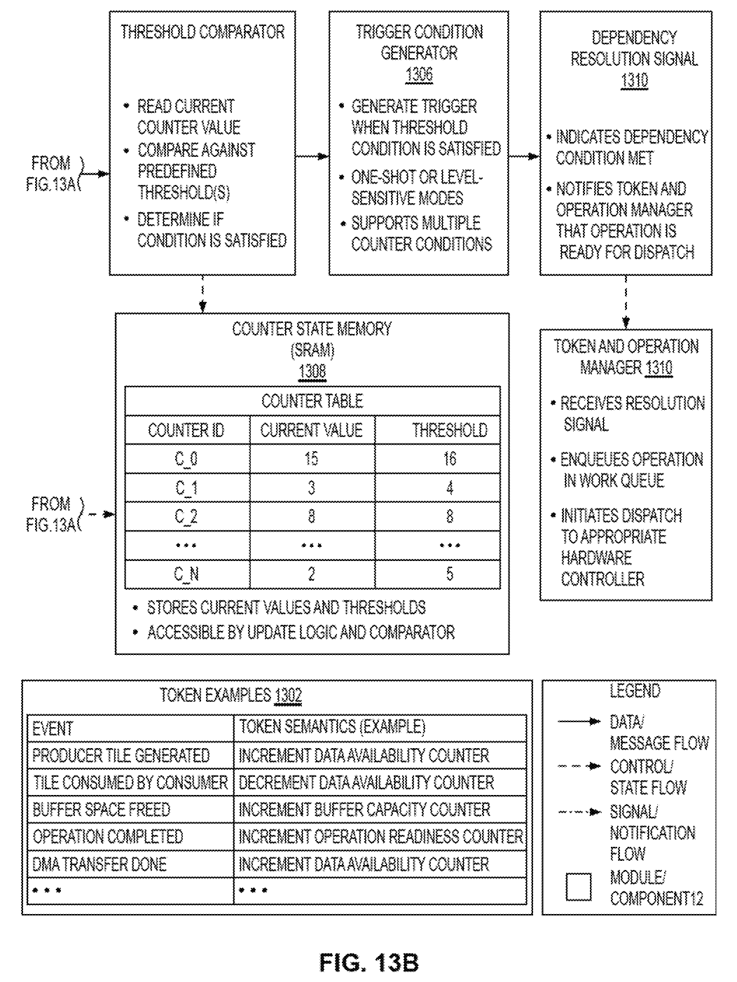

FIG. 3 illustrates internal dataflow and control paths within the Dataflow Processing Unit 101. In some embodiments, the Dataflow Execution Fabric 301 may include a Data Path 302 for transferring data between compute resources and memory, a Control Path 303 for propagating control information, and an Event Signaling Path 304 for communicating execution-related events. The Dataflow Execution Fabric 301 may further include a Token Propagation Path 307 for communicating Tokenized Dependency Indicators 1301 (FIGS. 13A-B), and an Operation Dispatch Path 308 for scheduling execution of operations on compute resources. Data movement between components may occur via a Memory Access Path 306, and execution may be organized into one or more Execution Pipeline Stages 310.

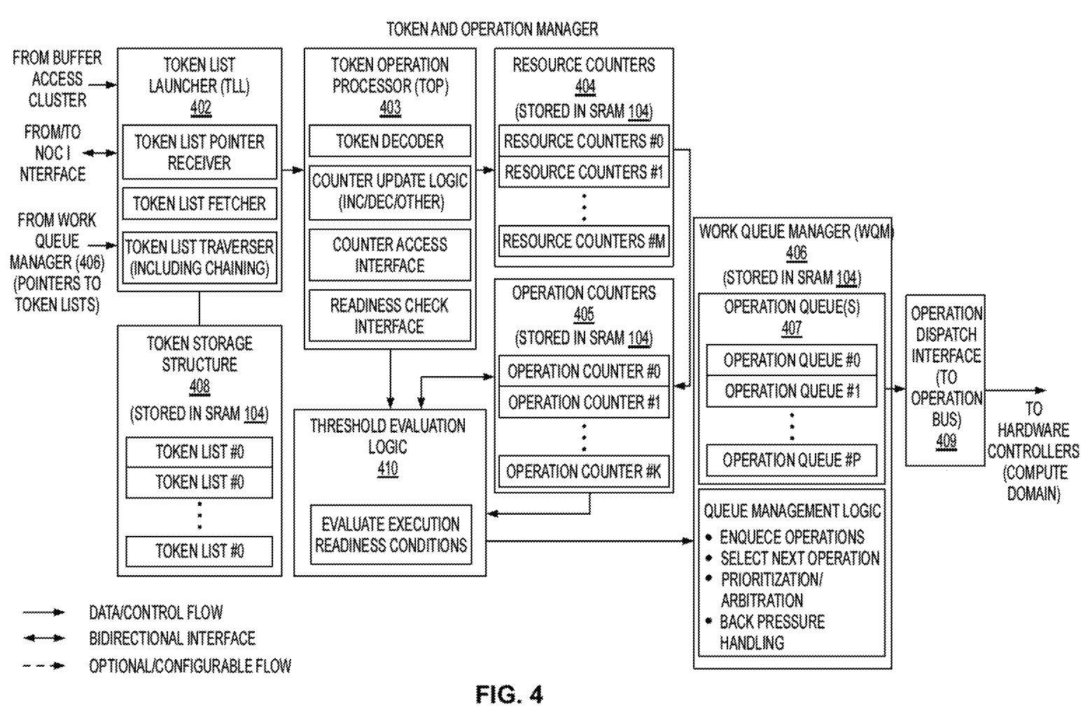

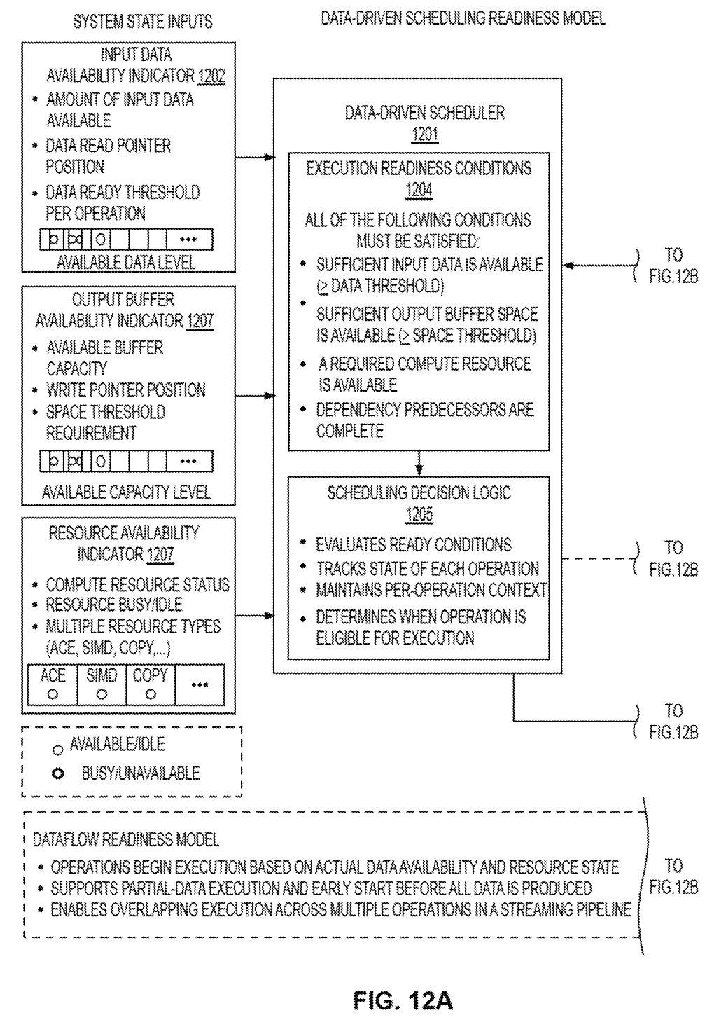

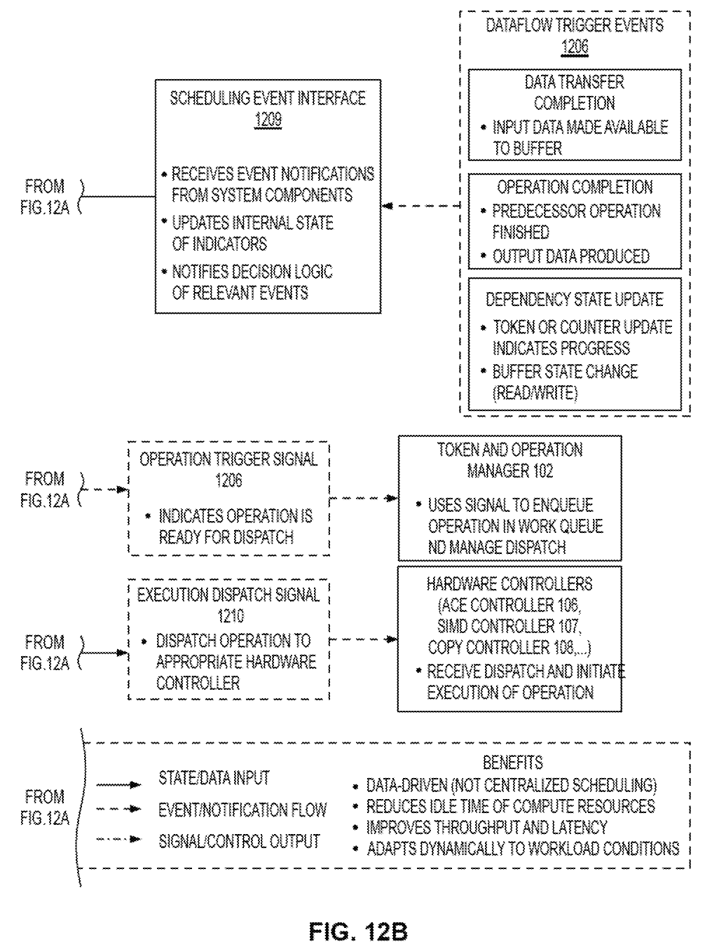

FIG. 4 illustrates an example embodiment of the Token and Operation Manager 102. In some embodiments, the Token and Operation Manager 102 may include a Token List Launcher (TLL) 402, a Token Operation Processor (TOP) 403, one or more Resource Counters 404, one or more Operation Counters 405, and a Work Queue Manager (WQM) 406. The Token List Launcher 402 may retrieve token lists from a Token Storage Structure 408 stored in SRAM. The Token Operation Processor 403 may update counters and evaluate threshold conditions using a Threshold Evaluation Logic 410. When one or more Execution Readiness Conditions 1204 (FIGS. 12A-B) are satisfied, the Work Queue Manager 406 may enqueue operations into an Operation Queue 407 and issue operations through an Operation Dispatch Interface 409 to appropriate compute controllers.

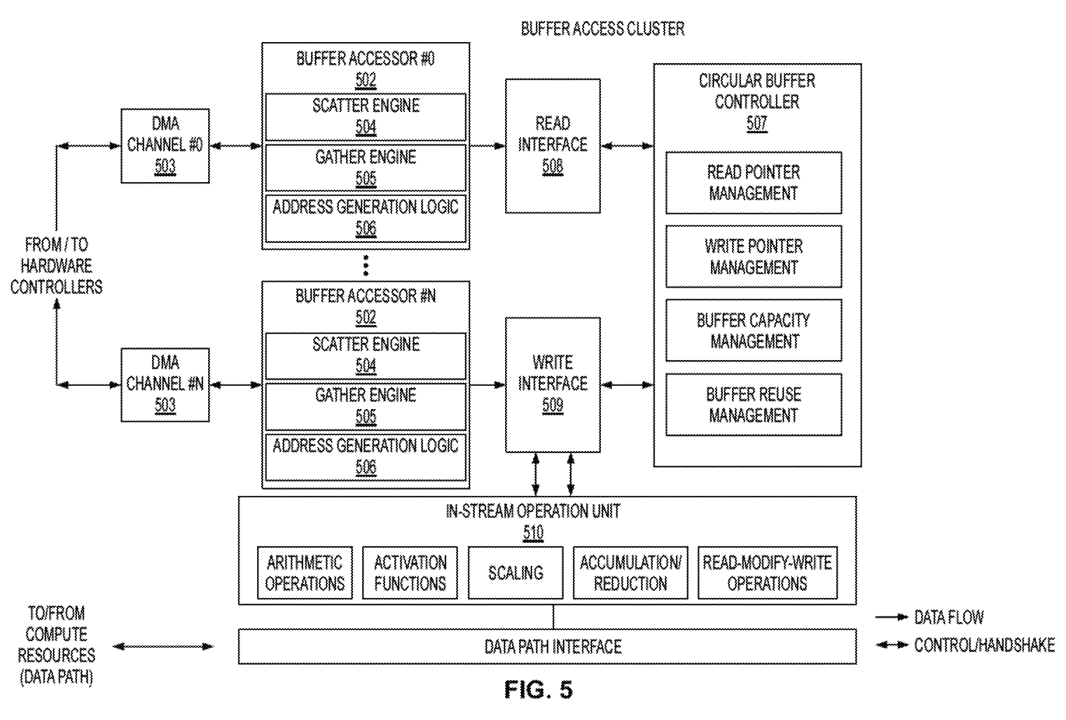

FIG. 5 illustrates an example embodiment of the Buffer Access Cluster. In some embodiments, the Buffer Access Cluster may include one or more Buffer Accessors 502, each associated with a DMA Channel 503. The Buffer Accessors 502 may include a Gather Engine 505, a Scatter Engine 504, and an Address Generation Logic 506 configured to access non-contiguous memory regions. The Buffer Access Cluster may further include a Circular Buffer Controller 507 configured to manage buffer reuse, a Read Interface 508, a Write Interface 509, and an In-Stream Operation Unit 510 configured to perform transformations on data during transfer.

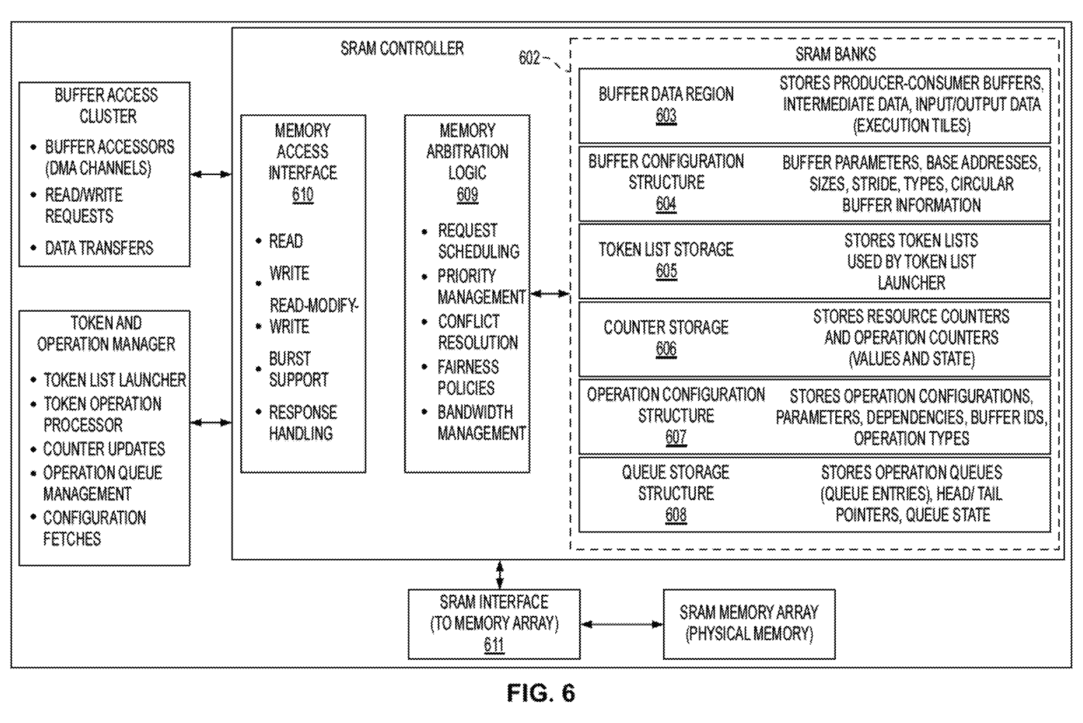

FIG. 6 illustrates an example embodiment of the SRAM Controller and associated memory-resident control structures. In some embodiments, the SRAM Controller may manage access to one or more SRAM Banks 602 containing a Buffer Data Region 603 and control structures including a Buffer Configuration Structure 604, a Token List Storage 605, a Counter Storage 606, an Operation Configuration Structure 607, and a Queue Storage Structure 608. The SRAM Controller may include a Memory Arbitration Logic 609 configured to coordinate access among multiple hardware components and a Memory Access Interface 610 configured to service requests from the Buffer Access Cluster and the Token and Operation Manager 102.

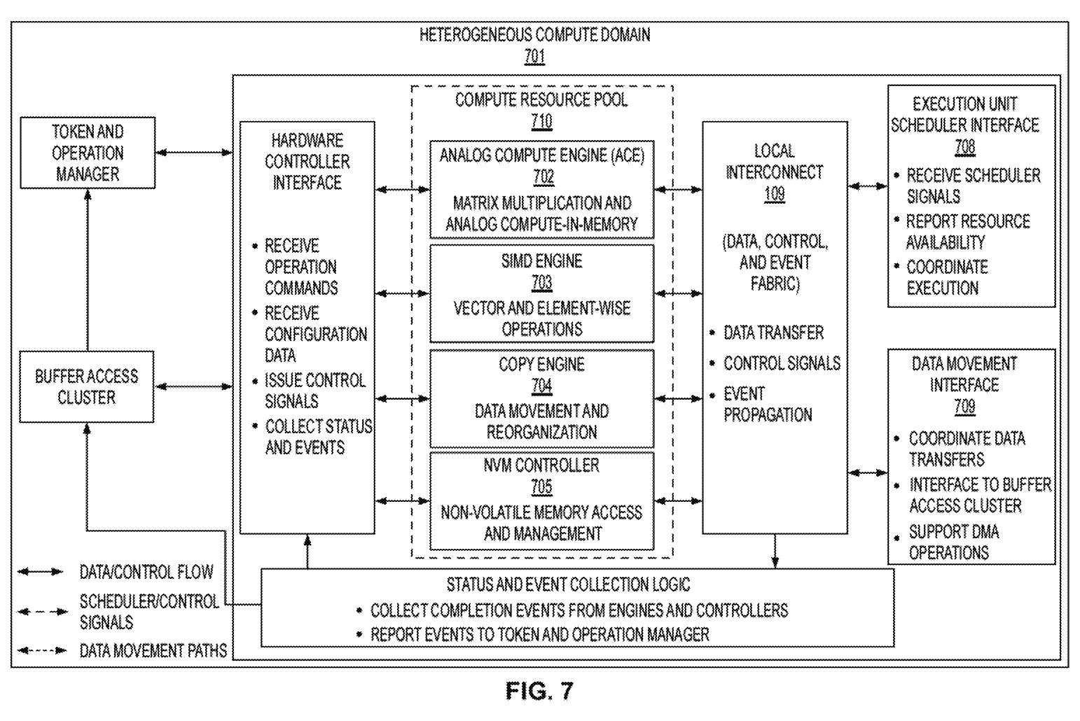

FIG. 7 illustrates an example embodiment of a Heterogeneous Compute Domain 701 within the Dataflow Processing Unit 101. In some embodiments, the Heterogeneous Compute Domain 701 may include an Analog Compute Engine (ACE) 702, a SIMD Engine 703, a Copy Engine 704, and an NVM Controller 705, each coupled via a Hardware Controller Interface 706 and the Local Interconnect 109. The Heterogeneous Compute Domain 701 may further include an Execution Unit Scheduler Interface 708 and a Data Movement Interface 709, enabling coordination of compute operations and data transfers. In some embodiments, compute resources may be organized as a Compute Resource Pool 710.

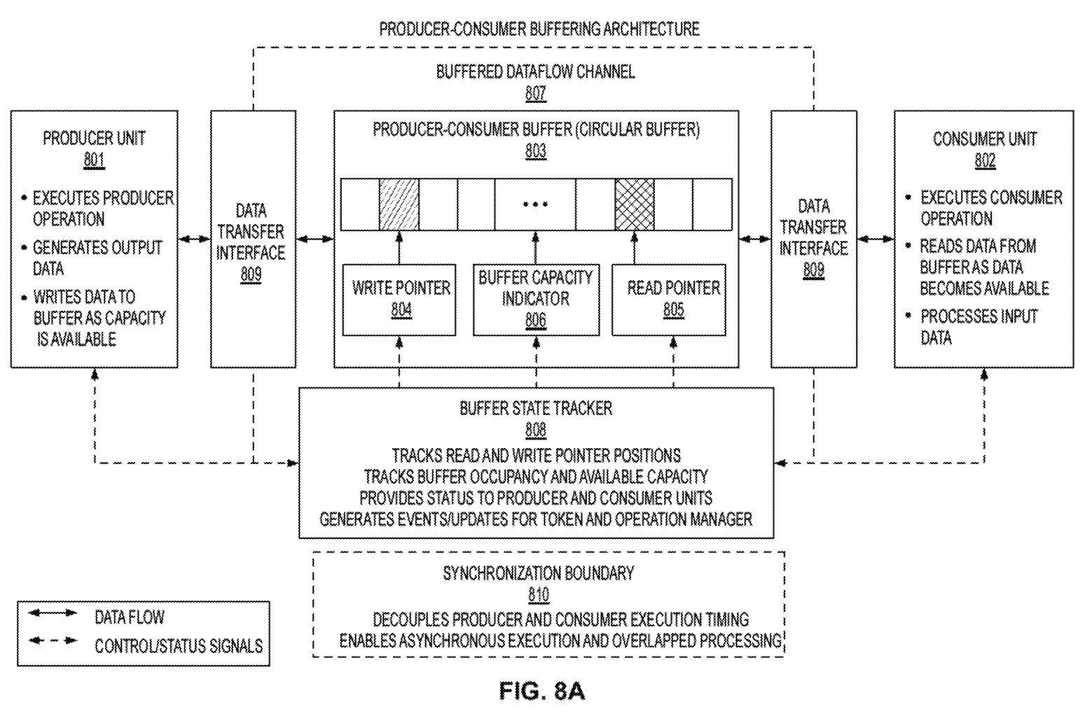

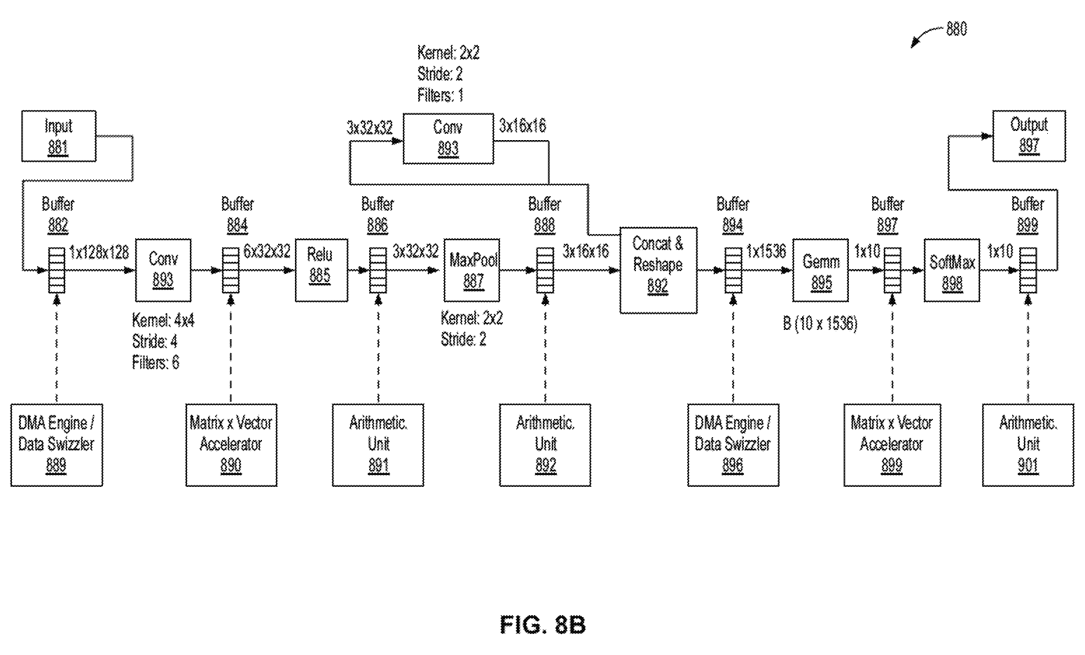

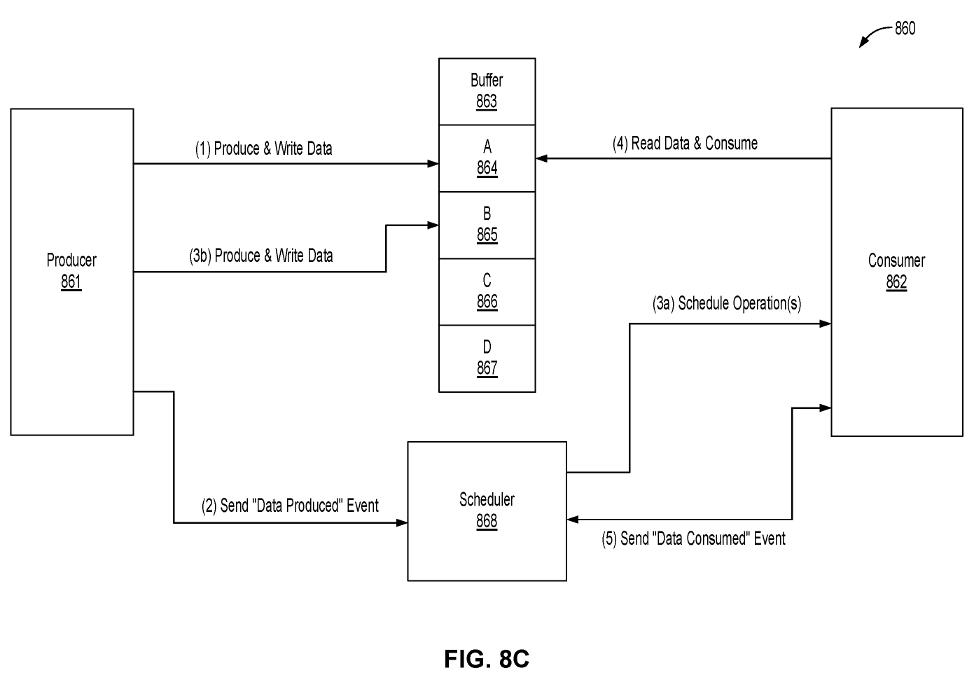

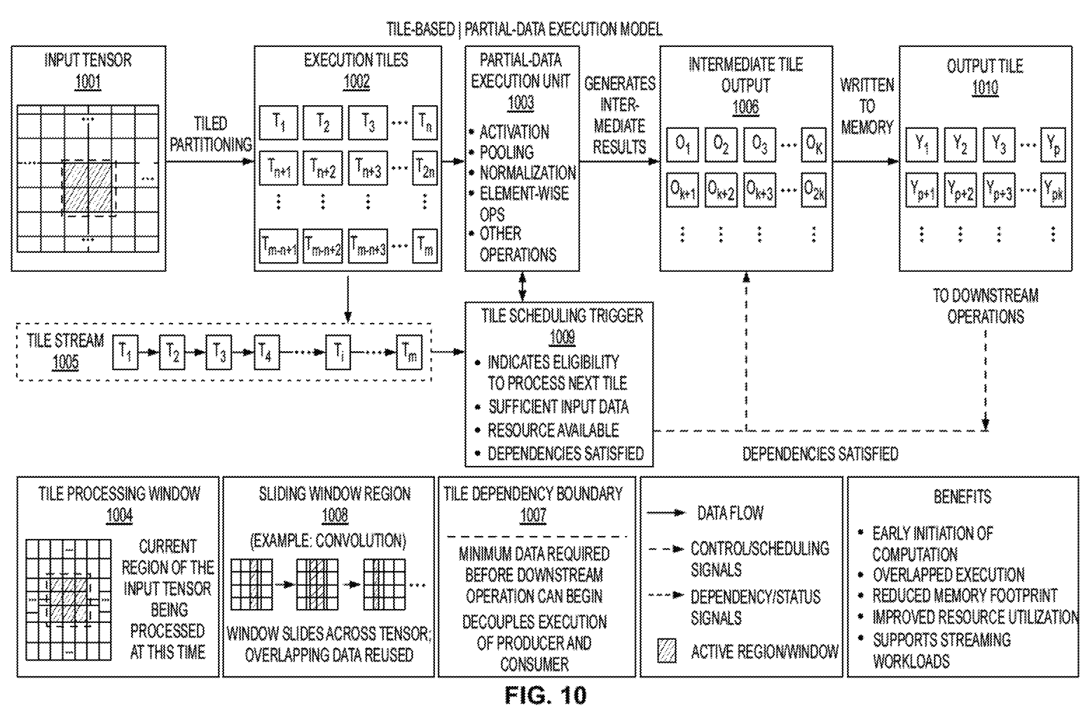

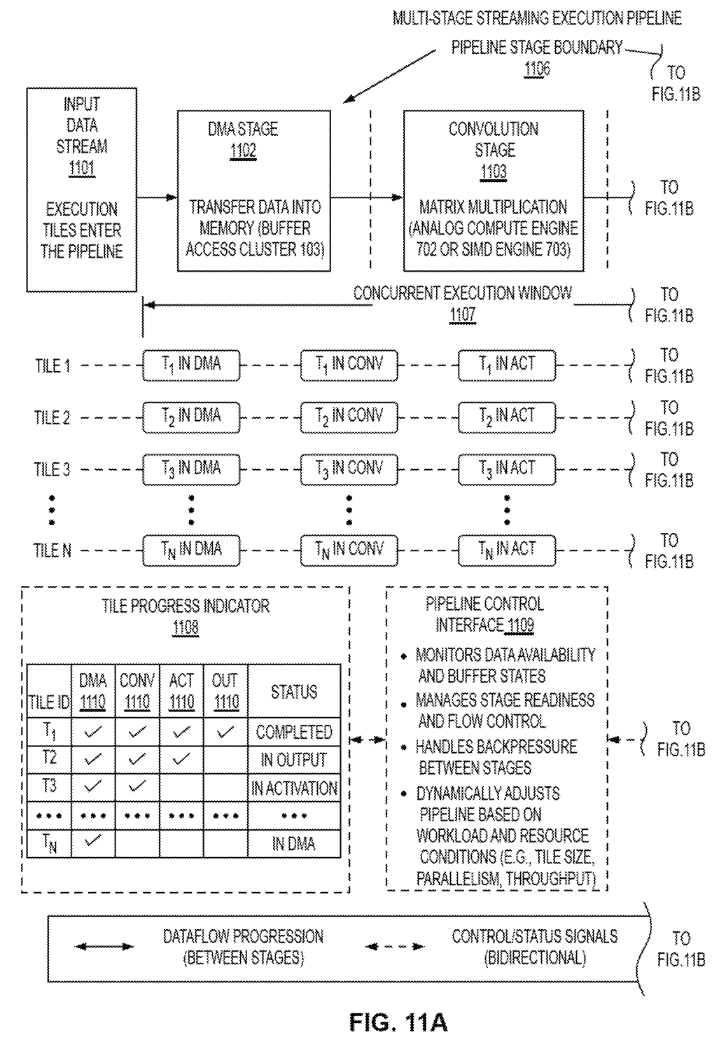

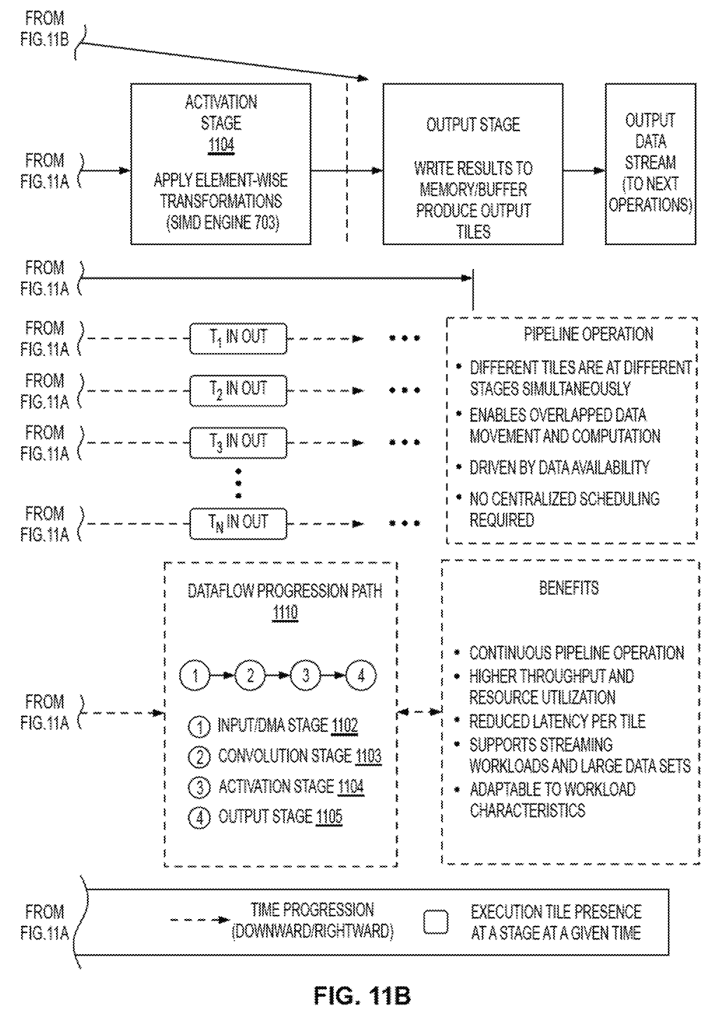

In some embodiments, the Dataflow Processing Unit 101 may execute a neural network graph by decomposing operations into Execution Tiles 1002 (FIG. 10) and mapping the operations to hardware resources within the Heterogeneous Compute Domain 701. Data associated with the operations may be stored in Producer–Consumer Buffers 803 (FIG. 8A) within the SRAM and accessed through the Buffer Access Cluster. Execution of operations may be triggered by the Token and Operation Manager 102 based on satisfaction of Execution Readiness Conditions 1204, enabling a Streaming Execution Pipeline 1101–1110 (FIGS. 11A-B) in which multiple operations execute concurrently on different subsets of data.

In some embodiments, the architecture described herein may enable asynchronous, data-driven execution of neural network graphs, reduced memory footprint through reuse of buffer structures, and improved utilization of compute resources through overlapping data movement and computation. The modular arrangement of the Dataflow Processing Unit 101, as illustrated in FIGS. 1–7, may further enable scalability across multiple processing units and integration into a variety of system configurations.

### Technical Definitions

For purposes of describing embodiments of the present application, the following terms may be used. The definitions provided herein are intended to facilitate understanding of the described embodiments and are not intended to limit the scope of the present application. In some embodiments, the same or similar concepts may be referred to using different terminology.

In some embodiments, a Dataflow Execution Fabric may refer to a collection of interconnected hardware components configured to execute a computational graph based on data dependencies rather than a predetermined instruction sequence. The Dataflow Execution Fabric may include compute units, memory subsystems, data movement engines, and control logic that collectively enable execution of operations in response to data availability.

In some embodiments, the Dataflow Execution Fabric may be implemented within a dataflow processing unit, system-on-chip, or distributed computing system.

In some embodiments, a Partial-Data Execution Unit may refer to a compute resource configured to initiate execution of an operation based on availability of a subset of required input data rather than a complete input data structure. The subset of required input data may correspond to a tile, slice, chunk, or other partition of a larger data structure.

In some embodiments, the Partial-Data Execution Unit may support progressive consumption of input data and progressive generation of output data.

In some embodiments, an Execution Tile may refer to a partition of data associated with a computational graph node, where the partition represents a unit of data that may be independently processed. The Execution Tile may correspond to a spatial region, channel grouping, matrix block, or other subdivision of an input or output tensor.

In some embodiments, Execution Tiles may be processed in a sequence or pipeline, enabling overlapping execution across multiple nodes of the computational graph.

In some embodiments, a Producer–Consumer Buffer may refer to a memory structure configured to temporarily store intermediate data produced by a first operation and consumed by a second operation. The Producer–Consumer Buffer may decouple execution timing between the first operation and the second operation.

In some embodiments, the Producer–Consumer Buffer may be implemented as a circular buffer, line buffer, queue, or other memory structure that supports concurrent read and write operations.

In some embodiments, a Buffered Dataflow Channel may refer to a logical or physical communication pathway between two or more operations, where data is transferred via one or more Producer–Consumer Buffers. The Buffered Dataflow Channel may enable asynchronous data transfer and may support partial data availability.

In some embodiments, a Data-Driven Scheduler may refer to control logic configured to trigger execution of operations based on availability of input data and/or availability of output buffer capacity. The Data-Driven Scheduler may evaluate one or more readiness conditions associated with a given operation.

In some embodiments, the Data-Driven Scheduler may operate without reliance on a fixed instruction sequence and may enable execution of operations in a non-sequential order based on satisfaction of data-related conditions.

In some embodiments, an Execution Readiness Condition may refer to a condition that determines whether an operation is eligible for execution. The Execution Readiness Condition may include one or more of: availability of a threshold amount of input data, availability of output buffer capacity, availability of compute resources, and satisfaction of dependency constraints.

In some embodiments, a Dataflow Trigger Event may refer to an event generated in response to a change in system state that may affect execution readiness. The Dataflow Trigger Event may correspond to completion of a data transfer, production of an output tile, consumption of buffered data, or update to a control structure.

In some embodiments, the Dataflow Trigger Event may be used to initiate evaluation of one or more Execution Readiness Conditions.

In some embodiments, a Tokenized Dependency Indicator may refer to a representation of progress associated with production or consumption of data. The Tokenized Dependency Indicator may be implemented using tokens, counters, or other data structures that track data availability or resource utilization.

In some embodiments, Tokenized Dependency Indicators may be updated in response to Dataflow Trigger Events and may be used by the Data-Driven Scheduler to determine Execution Readiness Conditions.

In some embodiments, an Operation Dispatch Structure may refer to a data structure configured to store operations that are ready for execution. The Operation Dispatch Structure may be associated with one or more hardware resources and may support ordered or unordered scheduling of operations.

In some embodiments, the Operation Dispatch Structure may include queue-based structures, linked-list structures, or other scheduling mechanisms.

In some embodiments, a Memory-Orchestrated Data Movement Engine may refer to a hardware component configured to perform data transfers between memory regions and compute resources, including support for non-contiguous memory access patterns.

In some embodiments, the Memory-Orchestrated Data Movement Engine may support scatter operations, gather operations, circular buffer management, and in-stream data transformations.

In some embodiments, a Buffer Accessor may refer to a hardware or logical component configured to manage read and write operations to a memory structure, including address generation, access sequencing, and data transformation.

In some embodiments, the Buffer Accessor may abstract underlying memory layouts and present a logical view of data to compute resources.

In some embodiments, an In-Stream Operation may refer to a computation performed on data as the data is being transferred between memory and a compute resource. The In-Stream Operation may include arithmetic transformations, activation functions, scaling operations, or other data manipulations.

In some embodiments, a Dataflow Processing Unit (DPU) may refer to a hardware subsystem configured to execute computational graphs using a Dataflow Execution Fabric. The Dataflow Processing Unit may include one or more compute units, memory subsystems, data movement engines, and control logic.

In some embodiments, the Dataflow Processing Unit may orchestrate execution of operations based on Dataflow Trigger Events and Execution Readiness Conditions.

In some embodiments, a Heterogeneous Compute Domain may refer to a collection of compute resources of different types configured to execute different classes of operations. The Heterogeneous Compute Domain may include analog compute engines, digital vector processors, scalar processors, and other compute resources.

In some embodiments, operations within a computational graph may be mapped to different compute resources within the Heterogeneous Compute Domain.

In some embodiments, a Streaming Execution Pipeline may refer to a sequence of operations executed in an overlapping manner, where multiple operations process different portions of data concurrently. The Streaming Execution Pipeline may be enabled by Partial-Data Execution Units, Producer–Consumer Buffers, and Data-Driven Scheduling.

In some embodiments, a Global Dataflow Interconnect may refer to a communication infrastructure that connects multiple Dataflow Processing Units or subsystems, enabling transfer of data and control information between them.

In some embodiments, the terms defined herein may be used interchangeably with other terms that describe similar functionality. For example: a Producer–Consumer Buffer may be referred to as a queue, buffer, or memory staging region, a Tokenized Dependency Indicator may be referred to as a token, counter, or progress indicator, and a Data-Driven Scheduler may be referred to as control logic, scheduling logic, or dispatch logic. Such variations in terminology are intended to provide flexibility in describing embodiments and are not intended to limit the scope of the present application.

### 1A. Dataflow Processing Unit

FIG. 1A illustrates an example embodiment of a Dataflow Processing Unit (DPU) 101 configured to execute a computational graph using a dataflow-based execution model. The Dataflow Processing Unit 101 may be implemented as part of a System-on-Chip, an accelerator device, a chiplet-based architecture, or a distributed processing system. In some embodiments, the Dataflow Processing Unit 101 may operate as a component of a Dataflow Execution Fabric 301 (FIG. 3) that orchestrates execution of operations based on data availability and dependency satisfaction.

In some embodiments, the Dataflow Processing Unit 101 may include a Token and Operation Manager (TOM) 102, a Buffer Access Cluster (BAC), a Static Random Access Memory (SRAM), an SRAM Controller, an Analog Compute Engine (ACE) Controller 106, a SIMD Controller, a Copy Controller 110, and a Local Interconnect 109. The Dataflow Processing Unit 101 may further include a Network-on-Chip (NoC) Interface 110, an Operation Bus, a Control Path Interface, and a Data Path Interface.

### Token and Operation Manager

In some embodiments, the Token and Operation Manager 102 may provide control flow functionality for scheduling execution of operations within the Dataflow Processing Unit 101. The Token and Operation Manager 102 may process Tokenized Dependency Indicators 1301 (FIGS. 13A-B) that represent progress of data production, data consumption, or resource availability. The Token and Operation Manager 102 may update counters stored in SRAM and evaluate Execution Readiness Conditions 1204 (FIGS. 12A-B) associated with operations.

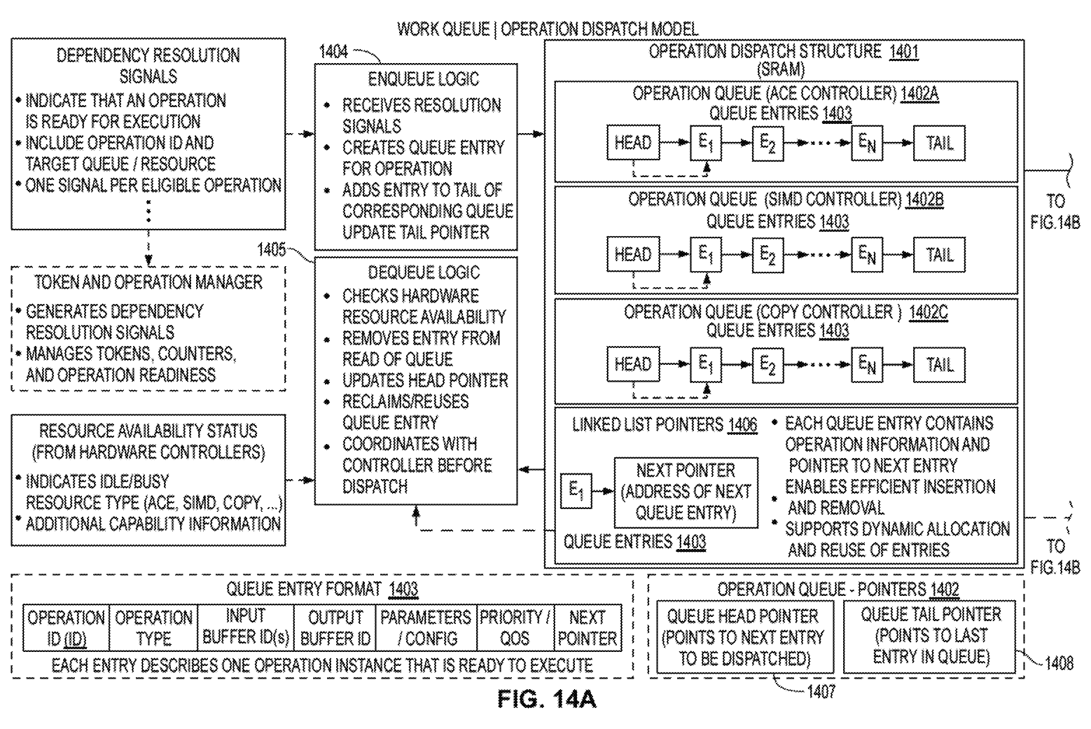

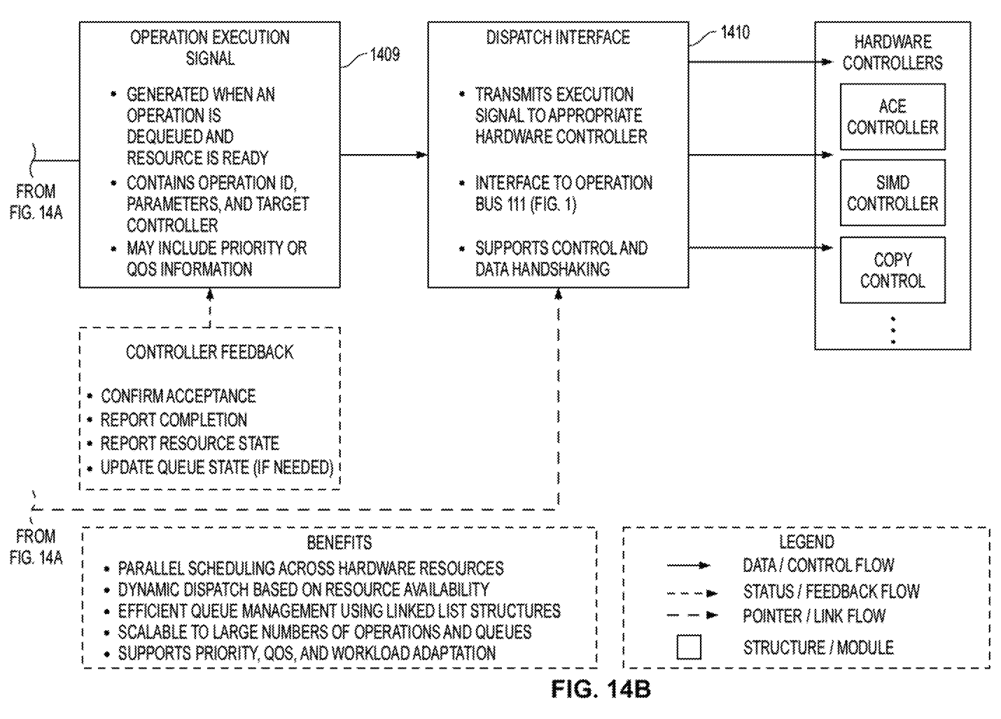

In some embodiments, the Token and Operation Manager 102 may enqueue operations into one or more Operation Dispatch Structures 1401 (FIGS. 14A-B) when one or more Execution Readiness Conditions are satisfied. The Token and Operation Manager 102 may issue operations to one or more hardware controllers via the Operation Bus. Execution ordering may be determined based on data readiness rather than a predetermined instruction sequence.

### Buffer Access Cluster

In some embodiments, the Buffer Access Cluster may provide data movement functionality between memory and compute resources. The Buffer Access Cluster may include one or more Buffer Accessors 502 (FIG. 5), each configured to perform read and write operations to SRAM. The Buffer Access Cluster may support scatter operations, gather operations, circular buffer management, and in-stream data transformations.

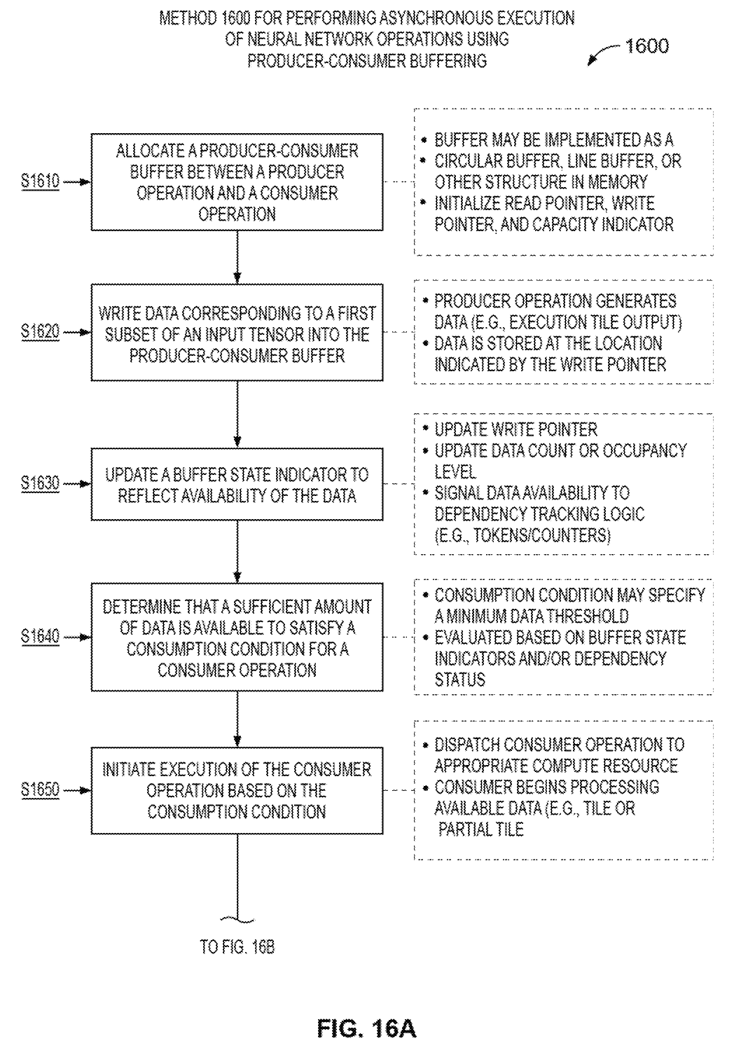

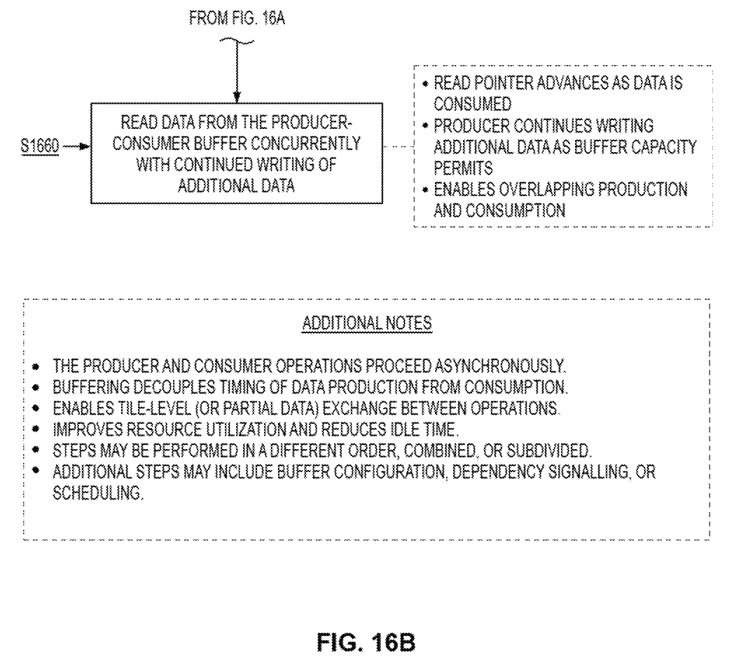

In some embodiments, the Buffer Access Cluster may generate memory addresses using Address Generation Logic 506 (FIG. 5), enabling access to non-contiguous memory regions. The Buffer Access Cluster may further support In-Stream Operations 1602 (FIGS. 16A-B), including arithmetic transformations performed during data transfer. The Buffer Access Cluster may interface with the SRAM Controller through the Data Path Interface.

### SRAM and SRAM Controller

In some embodiments, the SRAM may store data associated with execution of operations, including input data, intermediate data, output data, and control structures. Control structures may include Token Storage Structures 408 (FIG. 4), Counter Storage 606 (FIG. 6), Operation Configuration Structures 607 (FIG. 6), and Queue Storage Structures 608 (FIG. 6).

In some embodiments, the SRAM Controller may manage access to the SRAM. The SRAM Controller may include Memory Arbitration Logic 609 (FIG. 6) configured to coordinate access among the Token and Operation Manager 102, the Buffer Access Cluster, and one or more hardware controllers. The SRAM Controller may provide a Memory Access Interface 610 (FIG. 6) that supports read, write, and read-modify-write operations.

### Compute Controller

In some embodiments, the Dataflow Processing Unit 101 may include one or more compute controllers configured to execute operations mapped from a computational graph.

The Analog Compute Engine Controller 106 may manage execution of matrix multiplication operations using an Analog Compute Engine 702 (FIG. 7). The Analog Compute Engine Controller 106 may retrieve input data from SRAM via the Buffer Access Cluster and may store output data back to SRAM.

The SIMD Controller may manage execution of vector-based operations, including activation functions, normalization operations, and element-wise arithmetic operations. The SIMD Controller may operate on data stored in SRAM and may access memory through the Buffer Access Cluster.

The Copy Controller 110 may manage data transfer operations between memory regions or between subsystems within the Dataflow Processing Unit 101. The Copy Controller 110 may support bulk data movement and may assist in preparation of data for subsequent operations.

### Interconnect and Interfaces

In some embodiments, the Local Interconnect 109 may provide communication between components within the Dataflow Processing Unit 101. The Local Interconnect 109 may support data transfer, control signaling, and event propagation between the Token and Operation Manager 102, the Buffer Access Cluster, the SRAM Controller, and the compute controllers.

The Operation Bus may be used by the Token and Operation Manager 102 to issue operation commands to hardware controllers. The Operation Bus may carry operation configuration information retrieved from Operation Configuration Structures 607.

The Control Path Interface may carry control signals, including scheduling signals, token updates, and readiness signals. The Data Path Interface may carry data associated with execution of operations, including input data, intermediate data, and output data.

The Network-on-Chip Interface 110 may enable communication between the Dataflow Processing Unit 101 and external components, including other Dataflow Processing Units, host subsystems, or peripheral devices. In some embodiments, the Network-on-Chip Interface 110 may connect to a Global Interconnect 204 (FIGS. 2A-2B).

In some embodiments, the Dataflow Processing Unit 101 may execute a computational graph by mapping operations to hardware controllers and storing associated data in SRAM. Data movement between memory and compute resources may be performed by the Buffer Access Cluster. Execution of operations may be controlled by the Token and Operation Manager 102, which may evaluate Execution Readiness Conditions based on Tokenized Dependency Indicators and counter values.

In some embodiments, execution may occur in a Streaming Execution Pipeline 1101–1110 (FIGS. 11A-B), in which multiple operations execute concurrently on different Execution Tiles 1002 (FIG. 10). Producer–Consumer Buffers 803 (FIG. 8A) stored in SRAM may enable asynchronous data transfer between operations. The architecture may enable overlapping execution of data movement and computation, thereby improving utilization of compute resources and reducing latency.

In some embodiments, the Dataflow Processing Unit 101 may operate without reliance on a centralized processor for scheduling. Instead, scheduling decisions may be performed by hardware based on data availability and resource conditions, enabling fine-grained synchronization and efficient execution of computational graphs.

In some embodiments, additional hardware components may be included within the Dataflow Processing Unit 101, including digital signal processors, scalar processors, or specialized accelerators. The arrangement illustrated in FIG. 1A is provided as an example and may be modified based on implementation requirements. The Dataflow Processing Unit 101 may be scaled to include multiple instances interconnected via the Network-on-Chip Interface 110.

### 1B. DPU for Heterogenous Compute

FIG. 1B illustrates an example embodiment of a Dataflow Processing Unit (DPU) 101 with an integrated tile architecture 101A configured to support heterogeneous compute execution and shared-memory coordination within a neural network processing environment. In some embodiments, the DPU 101 with integrated tile architecture 101A may include an Analog Compute Engine (ACE) , a Temperature Sensor 103, a Bandgap Reference 104, a High Voltage Generator 105, an ACE Controller 106, an NVM Controller 107, one or more vector-processing cores 113-1 through 113-N, a DPU Local Interconnect 120A, a Token and Operation Manager 121A, an SRAM Controller 123A, a Shared Tile SRAM 124A, and a Copy Controller 110 110.

In some embodiments, the Analog Compute Engine 102 may perform matrix multiplication operations, neural network inference operations, tensor-processing operations, or analog compute operations associated with neural network execution. The Analog Compute Engine may communicate with the ACE Controller 106 via one or more control interfaces and may communicate with the DPU Local Interconnect 120A for exchange of data and execution signals.

In some embodiments, the Temperature Sensor 103 may monitor operating conditions associated with analog compute circuitry, memory circuitry, or power-management circuitry. The Bandgap Reference 104 may generate one or more reference voltages for analog operation, and the High Voltage Generator 105 may generate programming voltages associated with nonvolatile memory operations and analog compute configuration operations.

In some embodiments, the ACE Controller 106 may coordinate execution of operations associated with the Analog Compute Engine. The ACE Controller 106 may include one or more Buffer Accessor Read Interfaces 106-1 and one or more Buffer Accessor Write Interfaces 106-2 configured to coordinate movement of data between compute resources and memory resources.

In some embodiments, the NVM Controller 107 may manage access to nonvolatile memory resources associated with analog compute operations, weight storage operations, configuration storage operations, or parameter programming operations. The NVM Controller 107 may communicate with the High Voltage Generator 105 and the DPU Local Interconnect 120A.

In some embodiments, the vector-processing cores 113-1 through 113-N may include scalar-processing resources, vector-processing resources, SIMD-processing resources, or programmable compute resources configured to execute operations associated with neural network graphs. The vector-processing cores 113-1 through 113-N may communicate with the DPU Local Interconnect 120A through corresponding master and slave interfaces.

In some embodiments, the Token and Operation Manager 121A may coordinate scheduling and execution readiness of operations within the DPU 101. The Token and Operation Manager 121A may manage token propagation, operation dispatch, dependency evaluation, or counter-based execution tracking operations.

In some embodiments, the Copy Controller 110 110 may coordinate movement of data between memory resources and compute resources. The Copy Controller 110 110 may include one or more Buffer Accessor Read Interfaces 125-1 and one or more Buffer Accessor Write Interfaces 125-2 configured to support asynchronous data movement operations.

In some embodiments, the DPU Local Interconnect 120A may correspond to a bus fabric, network-on-chip structure, crossbar structure, or other interconnect structure configured to enable communication between hardware components within the DPU 101. The DPU Local Interconnect 120A may further communicate with a Global Interconnect 190 configured to support communication with external devices, additional processing units, memory devices, chiplets, or system-level interconnect resources.

In some embodiments, the SRAM Controller 123A may coordinate access to the Shared Tile SRAM 124A. The Shared Tile SRAM 124A may include multiple physical memory banks, error correction support, in-place arithmetic support, or other memory-management features configured to support tiled execution and producer–consumer buffering operations.

In some embodiments, the DPU 101 with integrated tile architecture 101A may support concurrent execution of heterogeneous compute operations, asynchronous producer–consumer execution, tile-based scheduling, token-driven dependency tracking, and streaming neural network execution.

### 1C. DPU Execution Using Shared Bus-Fabric

FIG. 1C illustrates an example embodiment of a Dataflow Processing Unit (DPU) 101 having an integrated tile architecture 101B configured to support heterogeneous compute execution, shared-memory coordination, and distributed processing operations using a shared bus-fabric arrangement. In some embodiments, the DPU 101 having integrated tile architecture 101B may include one or more Analog Compute Engines (ACEs), a Temperature Sensor 103, a Bandgap Reference 104, a High Voltage Generator 105, an ACE Controller 106, an NVM Controller 107, one or more vector-processing cores 113-1 through 113-N, a Bus Fabric 120B, a Token and Operation Manager 121B, a Shared Tile SRAM 124B, and a Copy Controller 110 110.

In some embodiments, the Analog Compute Engines may perform matrix multiplication operations, tensor-processing operations, convolution operations, inference operations, or analog compute operations associated with execution of a neural network graph. The Analog Compute Engines may communicate with the ACE Controller 106, which may coordinate execution, scheduling, buffer management, or data transfer operations associated with the Analog Compute Engines.

In some embodiments, the ACE Controller 106 may include one or more buffer-access interfaces configured to coordinate movement of data between compute resources and memory resources. The ACE Controller 106 may further communicate with the Bus Fabric 120B to exchange execution information, control information, and data associated with neural network operations.

In some embodiments, the Temperature Sensor 103 may monitor operating conditions associated with analog compute circuitry, memory circuitry, or power circuitry. The Bandgap Reference 104 may generate one or more reference voltages for analog operations, and the High Voltage Generator 105 may generate programming voltages associated with nonvolatile memory operations or analog compute configuration operations.

In some embodiments, the NVM Controller 107 may coordinate access to nonvolatile memory structures associated with analog compute operations, weight storage operations, parameter programming operations, or configuration storage operations. The NVM Controller 107 may communicate with the High Voltage Generator 105 and the Bus Fabric 120B.

In some embodiments, the vector-processing cores 113-1 through 113-N may include programmable vector-processing resources, SIMD-processing resources, scalar-processing resources, or other digital compute resources configured to execute operations associated with a neural network graph. The vector-processing cores 113-1 through 113-N may communicate with the Bus Fabric 120B through corresponding master and slave interfaces.

In some embodiments, the Token and Operation Manager 121B may coordinate execution scheduling, dependency evaluation, token propagation, operation readiness evaluation, or counter-based execution tracking operations. The Token and Operation Manager 121B may communicate with the Bus Fabric 120B to coordinate execution among heterogeneous compute resources.

In some embodiments, the Copy Controller 110 110 may coordinate asynchronous data movement operations between memory resources, compute resources, and external interfaces. The Copy Controller 110 110 may communicate with a Global Interconnect 190 configured to support communication with external memory systems, additional processing units, chiplets, or system-level interconnect resources.

In some embodiments, the Bus Fabric 120B may correspond to a network-on-chip structure, crossbar structure, shared communication bus, or other interconnect structure configured to enable communication among compute resources, controllers, memory resources, and external interfaces within the DPU 101.

In some embodiments, the Shared Tile SRAM 124B may provide memory storage for producer–consumer buffers, execution tiles, operation queues, token lists, counter values, configuration structures, intermediate tensor data, or other memory-resident control structures. The Shared Tile SRAM 124B may support tiled execution, asynchronous producer–consumer execution, and overlapping execution of neural network operations.

In some embodiments, the DPU 101 having integrated tile architecture 101B may support concurrent execution of heterogeneous compute operations, token-driven scheduling, tile-based execution, partial-data execution, and streaming neural network execution using shared-memory coordination across multiple compute resources.

### 1D. DPU With Integrated Analog Compute Engine

FIG. 1D illustrates an example embodiment of a Dataflow Processing Unit (DPU) 101 having an integrated Analog Compute Engine (ACE) tile and integrated processing cores architecture 101C configured to support heterogeneous compute execution, tiled neural network execution, and coordinated memory-management operations. In some embodiments, the DPU 101 having integrated ACE tile and integrated processing cores architecture 101C may include one or more Analog Compute Engines (ACEs), a Temperature Sensor 103, a Bandgap Reference 104, a High Voltage Generator 105, an ACE Controller 106, an NVM Controller 107, one or more processing Cores, a Copy Controller 110 110, a Power Management Controller 111, a Debug Controller 112, a Dataflow Processing Unit (DPU) Local Interconnect 120, a Token and Operation Manager 121, a Buffer Access Cluster 122, an SRAM Controller 123, and a DPU Local SRAM 124.

In some embodiments, the Analog Compute Engines may perform matrix multiplication operations, tensor-processing operations, neural network inference operations, or analog compute operations associated with execution of a neural network graph. The Analog Compute Engines may communicate with the ACE Controller 106 to coordinate execution scheduling, operation dispatch, data transfer operations, or configuration operations.

In some embodiments, the Temperature Sensor 103 may monitor thermal conditions associated with analog compute circuitry, memory circuitry, or power-management circuitry. The Bandgap Reference 104 may generate one or more reference voltages associated with analog compute operations, and the High Voltage Generator 105 may generate programming voltages associated with nonvolatile memory operations or analog compute configuration operations.

In some embodiments, the NVM Controller 107 may manage nonvolatile memory resources associated with analog compute operations, weight storage operations, parameter programming operations, or configuration storage operations. The NVM Controller 107 may communicate with the High Voltage Generator 105 and the DPU Local Interconnect 120.

In some embodiments, the processing Cores may include one or more vector-processing cores, SIMD-processing cores, scalar-processing cores, programmable compute resources, or neural network acceleration resources. The processing Cores may include an internal bus fabric configured to coordinate communication among multiple vector-processing units. The processing Cores may communicate with the DPU Local Interconnect 120 for exchange of data, execution information, and control information.

In some embodiments, the Copy Controller 110 110 may coordinate asynchronous data movement operations between memory resources, compute resources, or external interfaces. The Power Management Controller 111 may manage power-delivery operations, voltage-management operations, clock-management operations, or low-power operating modes associated with the DPU 101. The Debug Controller 112 may support debugging operations, execution tracing operations, performance-monitoring operations, or diagnostic operations associated with execution of neural network graphs.

In some embodiments, the DPU Local Interconnect 120 may correspond to a network-on-chip structure, shared communication bus, crossbar structure, or other interconnect structure configured to enable communication among compute resources, memory resources, controllers, and external interfaces. The DPU Local Interconnect 120 may communicate with a Global Interconnect configured to support communication with external systems, chiplets, memory devices, additional processing units, or system-level interconnect resources.

In some embodiments, the Token and Operation Manager 121 may coordinate token propagation, dependency evaluation, operation readiness determination, execution scheduling, or counter-based execution tracking operations associated with neural network execution.

In some embodiments, the Buffer Access Cluster 122 may coordinate movement of data between memory resources and compute resources. The Buffer Access Cluster 122 may support gather operations, scatter operations, direct memory access operations, circular-buffer management operations, or producer–consumer buffering operations associated with streaming execution.

In some embodiments, the SRAM Controller 123 may coordinate access to the DPU Local SRAM 124. The DPU Local SRAM 124 may store producer–consumer buffers, operation queues, execution tiles, token lists, counter values, intermediate tensor data, configuration structures, or other memory-resident control structures associated with tiled execution of neural network operations.

In some embodiments, the DPU 101 having integrated ACE tile and integrated processing cores architecture 101C may support asynchronous producer–consumer execution, tile-based execution, token-driven scheduling, partial-data execution, streaming execution pipelines, and concurrent execution of heterogeneous compute operations.

### 2A-2B. System-On-Chip | Multi-DPU Architecture

FIGS. 2A-2B illustrates an example embodiment of a System-on-Chip (SoC) 201 configured to support execution of computational graphs using one or more Dataflow Processing Units 203. The System-on-Chip 201 may integrate compute, memory, interconnect, and interface subsystems to enable deployment of machine learning workloads in a scalable and flexible manner.

In some embodiments, the System-on-Chip 201 may include a Host Interface Subsystem 202, a plurality of Dataflow Processing Units 203, a Global Interconnect 204, one or more Chiplet Interfaces 205, one or more Peripheral Interfaces 206, one or more Sensor Interfaces 207, a Runtime Software Stack 208, an External Memory System 209, an Input Data Source 210, and an Output Data Destination 211.

### Host Interface Subsystem

In some embodiments, the Host Interface Subsystem 202 may provide connectivity between the System-on-Chip 201 and an external host system. The Host Interface Subsystem 202 may support communication protocols including Peripheral Component Interconnect Express (PCIe), Universal Chiplet Interconnect Express (UCIe), Universal Serial Bus (USB), or other high-speed communication standards.

The Host Interface Subsystem 202 may receive configuration data, operation parameters, and input data from the external host system. The Host Interface Subsystem 202 may further transmit output data and status information to the external host system. In some embodiments, the Host Interface Subsystem 202 may include processing elements configured to manage initialization, control, and coordination of the System-on-Chip 201.

### Dataflow Processing Unit Array

In some embodiments, the System-on-Chip 201 may include a plurality of Dataflow Processing Units 203 arranged as a Dataflow Processing Unit Array. Each Dataflow Processing Unit 203 may correspond to an instance of the Dataflow Processing Unit 101 (FIG. 1A) and may include components configured to execute portions of a computational graph.

The Runtime Software Stack 208 may partition a computational graph into multiple segments and assign each segment to one or more Dataflow Processing Units 203. In some embodiments, operations may be distributed across Dataflow Processing Units 203 to enable parallel execution and improved throughput.

Each Dataflow Processing Unit 203 may operate independently or in coordination with other Dataflow Processing Units 203 based on data dependencies and execution requirements.

### Global Interconnect

In some embodiments, the Global Interconnect 204 may provide communication between the Host Interface Subsystem 202 and the Dataflow Processing Units 203. The Global Interconnect 204 may further enable communication among the Dataflow Processing Units 203.

The Global Interconnect 204 may support transfer of data, control information, and Tokenized Dependency Indicators 1301 (FIGS. 13A-B) between components. The Global Interconnect 204 may be implemented using a network-on-chip architecture, crossbar interconnect, or other communication fabric.

### Chiplet Interface

In some embodiments, the Chiplet Interface 205 may enable communication between the System-on-Chip 201 and additional integrated circuits or chiplets. The Chiplet Interface 205 may support scaling of the system by allowing multiple System-on-Chip instances to be interconnected.

The Chiplet Interface 205 may provide high-bandwidth, low-latency communication channels for transferring data between chips. In some embodiments, multiple Dataflow Processing Units 203 may be distributed across multiple chips and may communicate through the Chiplet Interface 205.

### Peripheral and Sensor Interface

In some embodiments, the Peripheral Interface 206 may provide connectivity to external devices, including storage devices, network interfaces, and other system components. The Peripheral Interface 206 may support data transfer and control signaling between the System-on-Chip 201 and peripheral devices.

The Sensor Interface 207 may provide direct connectivity to sensors, including image sensors or other data acquisition devices. The Sensor Interface 207 may enable real-time processing of sensor data by transferring data directly to the Dataflow Processing Units 203.

### Runtime Software Stack

In some embodiments, the Runtime Software Stack 208 may provide a software abstraction layer for configuring and managing execution of computational graphs on the System-on-Chip 201. The Runtime Software Stack 208 may include components for compiling, scheduling, and managing execution of operations.

The Runtime Software Stack 208 may generate configuration data, including buffer configurations, token lists, counter thresholds, and operation configurations. The Runtime Software Stack 208 may transmit the configuration data to the Dataflow Processing Units 203 through the Host Interface Subsystem 202.

In some embodiments, the Runtime Software Stack 208 may monitor execution and may adjust configuration parameters to optimize performance.

### External Memory System

In some embodiments, the External Memory System 209 may provide additional storage capacity for data associated with execution of computational graphs. The External Memory System 209 may include dynamic random-access memory (DRAM), high-bandwidth memory (HBM), or other memory technologies.

The External Memory System 209 may store input data, output data, and model parameters that may not fit within on-chip memory. The Dataflow Processing Units 203 may access the External Memory System 209 through the Global Interconnect 204 or through dedicated memory interfaces.

### Input Data Source and Output Data Destination

In some embodiments, the Input Data Source 210 may provide input data to the System-on-Chip 201. The Input Data Source 210 may include sensors, storage devices, or external systems that supply data for processing.

The Output Data Destination 211 may receive output data generated by the System-on-Chip 201. The Output Data Destination 211 may include display devices, storage systems, or downstream processing systems.

In some embodiments, operation of the System-on-Chip 201 may begin with receipt of configuration data and input data through the Host Interface Subsystem 202 or the Sensor Interface 207. The Runtime Software Stack 208 may configure the Dataflow Processing Units 203 based on the computational graph to be executed.

The Dataflow Processing Units 203 may execute operations using data-driven scheduling, buffered dataflow channels, and tile-based execution as described in FIGS. 8–11. Data may be transferred between Dataflow Processing Units 203 and memory systems using the Global Interconnect 204.

Execution may proceed concurrently across multiple Dataflow Processing Units 203, enabling parallel processing of different portions of the computational graph. Data dependencies may be managed using token and counter mechanisms, enabling coordination across the Dataflow Processing Units 203.

In some embodiments, the architecture illustrated in FIGS. 2A-2B may support scalability by allowing additional Dataflow Processing Units 203 to be integrated within a single System-on-Chip 201 or across multiple chips interconnected through the Chiplet Interface 205.

The architecture may support flexible deployment scenarios, including host-connected configurations and direct sensor processing configurations. The modular design of the System-on-Chip 201 may allow adaptation to different performance, power, and application requirements.

### 2C. System-on-Chip for Dataflow Processing Unit

FIG. 2C illustrates an example embodiment of a system-on-chip (SoC) subsystem architecture 200 configured to support operation of a Dataflow Processing Unit (DPU) and associated heterogeneous compute resources. In some embodiments, the SoC subsystem architecture 200 may include an SoC Subsystem 201 having a plurality of subsystem components coupled through an SoC Subsystem Local Interconnect 290.

In some embodiments, the SoC Subsystem 201 may include a CPU Subsystem 210. The CPU Subsystem 210 may include a Control CPU 211, a DSP and NPU subsystem 212, a Root of Trust module 213, a Reset, Clocking, and Boot module 214, and a Mythic Dataflow Bridge 215. The Reset, Clocking, and Boot module 214 may further include one or more ROM resources, OTP resources, PLL resources, or additional initialization circuitry.

In some embodiments, the Control CPU 211 may coordinate configuration operations, initialization operations, scheduling operations, or management operations associated with the SoC subsystem architecture 200. The DSP and NPU subsystem 212 may perform digital signal processing operations, tensor-processing operations, or neural network acceleration operations. The Root of Trust module 213 may support security operations, authentication operations, secure boot operations, or cryptographic operations.

In some embodiments, the SoC Subsystem 201 may further include an LPDDR5 Subsystem 220 configured to support external memory communication. The LPDDR5 Subsystem 220 may include an LPDDR5 PHY 221 and an LPDDR5 Controller 222. The LPDDR5 PHY 221 may implement physical-layer signaling operations associated with LPDDR5 memory devices, and the LPDDR5 Controller 222 may coordinate memory-access operations, refresh operations, scheduling operations, or memory-management operations.

In some embodiments, the SoC Subsystem 201 may include a PCIe Subsystem 230 configured to support peripheral communication and high-speed data transfer operations. The PCIe Subsystem 230 may include a PCIe PHY 231 and a PCIe Controller 232. The PCIe PHY 231 may implement physical-layer signaling operations associated with PCIe communication, and the PCIe Controller 232 may coordinate packet-processing operations, transaction scheduling operations, or external interface operations.

In some embodiments, the SoC Subsystem 201 may include a MIPI Subsystem 240 configured to support camera interfaces or multimedia interfaces. The MIPI Subsystem 240 may include a MIPI CSI PHY (Rx) 241, a MIPI CSI PHY (Tx) 242, a MIPI CSI Rx Controller 243, a MIPI CSI Tx Controller 244, and a Mythic MIPI Manager 245. The MIPI CSI PHY (Rx) 241 and MIPI CSI PHY (Tx) 242 may implement physical-layer communication associated with image sensor interfaces or multimedia interfaces. The MIPI CSI Rx Controller 243 and MIPI CSI Tx Controller 244 may coordinate reception and transmission of image-stream data, and the Mythic MIPI Manager 245 may coordinate management operations associated with MIPI communication resources.

In some embodiments, the SoC Subsystem 201 may further include one or more slow-speed peripheral resources 250. The slow-speed peripheral resources 250 may include a UART Controller 251, an I2C Controller 252, GPIO resources 253, and a QSPI Controller 254. Such peripheral resources may support debugging operations, configuration operations, low-speed communication operations, peripheral-management operations, or external device interfacing operations.

In some embodiments, the SoC Subsystem 201 may further include a Power Management Controller 260 and a Debug Controller 270. The Power Management Controller 260 may coordinate voltage-management operations, clock-management operations, thermal-management operations, or low-power operating modes associated with the SoC subsystem architecture 200. The Debug Controller 270 may support execution tracing operations, diagnostic operations, debugging operations, or performance-monitoring operations.

In some embodiments, the SoC Subsystem Local Interconnect 290 may correspond to a network-on-chip structure, communication bus, shared interconnect fabric, or crossbar interconnect configured to enable communication among subsystem components and external interfaces. The SoC Subsystem Local Interconnect 290 may further communicate with a Global Interconnect configured to support communication with external systems, chiplets, memory devices, or additional processing resources.

In some embodiments, the SoC subsystem architecture 200 may further include Common Dataflow Processing Unit (DPU) Components 280. The Common DPU Components 280 may include a SIMD Controller 281, a SIMD Engine 282, a Copy Controller 110 283, a Token and Operation Manager 284, a Buffer Access Cluster 285, an SRAM Controller 286, and an SoC Subsystem Local SRAM 287.

In some embodiments, the SIMD Controller 281 and SIMD Engine 282 may perform vector-processing operations, SIMD execution operations, tensor-processing operations, or arithmetic operations associated with neural network execution. The Copy Controller 110 283 may coordinate asynchronous data movement operations between memory resources and compute resources.

In some embodiments, the Token and Operation Manager 284 may coordinate token propagation operations, dependency evaluation operations, operation readiness determination operations, execution scheduling operations, or counter-based execution tracking operations associated with execution of neural network graphs.

In some embodiments, the Buffer Access Cluster 285 may coordinate movement of data between memory resources and compute resources. The Buffer Access Cluster 285 may support gather operations, scatter operations, direct memory access operations, producer–consumer buffering operations, circular-buffer management operations, or streaming dataflow operations.

In some embodiments, the SRAM Controller 286 may coordinate access to the SoC Subsystem Local SRAM 287. The SoC Subsystem Local SRAM 287 may store execution tiles, intermediate tensor data, operation queues, producer–consumer buffers, token lists, counter values, configuration structures, or other memory-resident control structures associated with tiled neural network execution.

In some embodiments, the SoC subsystem architecture 200 may support tile-based execution, producer–consumer buffering, asynchronous execution, token-driven scheduling, streaming execution pipelines, heterogeneous compute execution, and partial-data execution associated with execution of neural network graphs.

### 2D. SoC Subsystem for Operating a DPU

FIG. 2D illustrates an example embodiment of an SoC subsystem architecture 230 configured to support operation of a dataflow processing unit using a hierarchical interconnect and heterogeneous communication interfaces. In some embodiments, the SoC subsystem architecture 230 may include a network-on-chip structure, memory resources, DMA resources, protocol bridges, and dataflow processing resources configured to support streaming execution of neural network operations.

In some embodiments, the SoC subsystem architecture 230 may communicate with an NIC-400 interconnect resource 220. The NIC-400 interconnect resource 220 may communicate with an SoC SRAM resource 222, an ARM Cortex-A53 processor 224, and a GIC-600 interrupt controller 226. The NIC-400 interconnect resource 220 may further communicate with one or more subsystem components through one or more AXI interfaces, including one or more AXI streaming interfaces.

In some embodiments, the SoC subsystem architecture 230 may further include a Network-on-Chip Architecture 228 configured to support communication among DMA resources, peripheral interfaces, PCIe interfaces, memory interfaces, or miscellaneous I/O interfaces. The Network-on-Chip Architecture 228 may include one or more AXI master interfaces, AXI slave interfaces, streaming interfaces, distributed interconnect resources, or peripheral communication interfaces.

In some embodiments, the SoC subsystem architecture 230 may include a CPU Subsystem 232. The CPU Subsystem 232 may include an ARM M-class processor 231, a Reset, Clocking, and Boot resource 233, an AHB-to-APB bridge 234, a DMA-350 controller 235, an AHB-to-AXI bridge 236, an AXI-to-AHB bridge 237, an AXI Interconnect 238, an AHB Arbiter 239, an additional AHB-to-AXI bridge 240, and a firmware SRAM resource 241.

In some embodiments, the Reset, Clocking, and Boot resource 233 may include ROM resources 233a, OTP resources 233b, PLL resources 233c, or additional initialization circuitry. The Reset, Clocking, and Boot resource 233 may coordinate initialization operations, clock-distribution operations, secure boot operations, reset operations, or firmware-loading operations associated with the SoC subsystem architecture 230.

In some embodiments, the DMA-350 controller 235 may coordinate asynchronous data movement operations between memory resources, external interfaces, and compute resources. The DMA-350 controller 235 may further support AXI streaming transfers, tile-based data movement operations, producer–consumer buffering operations, or direct memory access operations associated with neural network execution.

In some embodiments, the AHB-to-APB bridge 234, AHB-to-AXI bridge 236, AXI-to-AHB bridge 237, and AHB-to-AXI bridge 240 may support protocol conversion operations between communication fabrics associated with subsystem components. The AXI Interconnect 238 may coordinate routing of memory transactions, streaming transactions, or dataflow communication transactions between subsystem resources.

In some embodiments, the firmware SRAM resource 241 may store boot firmware, configuration data, scheduling information, token state information, operation descriptors, or execution-management data associated with operation of the SoC subsystem architecture 230.

In some embodiments, the SoC subsystem architecture 230 may further include an SoC Subsystem Local Interconnect 242 configured to enable communication among dataflow processing resources, memory resources, DMA resources, or subsystem interfaces. The SoC Subsystem Local Interconnect 242 may correspond to an AXI interconnect fabric, network-on-chip structure, shared communication bus, or distributed communication fabric.

In some embodiments, the SoC subsystem architecture 230 may further include Common Dataflow Processing Unit (DPU) Components 243. The Common DPU Components 243 may include a SIMD Controller 244, a SIMD Engine 245, a Copy Controller 110 246, a Token and Operation Manager 247, a Buffer Access Cluster 248, and an SRAM Controller 249.

In some embodiments, the SIMD Controller 244 and SIMD Engine 245 may perform vector-processing operations, arithmetic operations, tensor-processing operations, or neural network execution operations. The Copy Controller 110 246 may coordinate movement of execution tiles, tensor data, or intermediate data between memory resources and compute resources.

In some embodiments, the Token and Operation Manager 247 may coordinate token propagation operations, dependency tracking operations, counter-based execution management operations, or operation scheduling operations associated with execution of neural network graphs. The Token and Operation Manager 247 may determine execution readiness conditions based on availability of data, buffer capacity, or compute resources.

In some embodiments, the Buffer Access Cluster 248 may coordinate producer–consumer buffering operations, gather operations, scatter operations, streaming dataflow operations, or tile-based memory-access operations. The Buffer Access Cluster 248 may communicate with the SRAM Controller 249 to access memory-resident execution data structures.

In some embodiments, the SRAM Controller 249 may coordinate access to an SoC Subsystem Local SRAM resource 250. The SoC Subsystem Local SRAM resource 250 may store execution tiles, intermediate tensor data, operation queues, token lists, dependency counters, buffer descriptors, or configuration structures associated with tiled neural network execution.

In some embodiments, the SoC subsystem architecture 230 may support asynchronous execution of neural network operations, streaming execution pipelines, tile-based execution, token-driven scheduling, partial-data execution, and concurrent execution of heterogeneous compute operations.

### 2E. SoC Subsystem with Multi-ACE Architecture

FIG. 2E illustrates an example embodiment of a scalable chip-level architecture configured to support communication between an SoC subsystem architecture and one or more Analog Compute Engine (ACE) tiles through a chip-level global network-on-chip (NoC) infrastructure. In some embodiments, the architecture may correspond to a Denali SoC architecture 252 configured to support distributed execution of neural network operations across heterogeneous compute resources.

In some embodiments, the Denali SoC architecture 252 may include a Chip-level Global NoC 204 configured to coordinate communication among subsystem resources, ACE tiles, memory resources, peripheral interfaces, or die-to-die communication interfaces. The Chip-level Global NoC 204 may correspond to a distributed network-on-chip architecture, interposer interconnect, mesh interconnect, packet-switched communication fabric, or hierarchical communication infrastructure configured to support high-bandwidth communication among chip resources.

In some embodiments, the Chip-level Global NoC 204 may communicate with one or more Denali-to-Denali Die-to-Die Interfaces 242a-242d. The Denali-to-Denali Die-to-Die Interfaces 242a-242d may support communication between multiple chips, chiplets, accelerator devices, processing tiles, or distributed compute systems. The die-to-die interfaces may further support scalable deployment of neural network acceleration resources across multiple integrated circuits.

In some embodiments, the Denali SoC architecture 252 may include an SoC Subsystem 258. The SoC Subsystem 258 may include a CPU Subsystem 260, a DDR Subsystem 262, a PCIe Subsystem 264, a MIPI Subsystem 266, and one or more Slow-speed Peripheral resources 268.

In some embodiments, the CPU Subsystem 260 may support boot operations, Root-of-Trust operations, digital signal processing operations, neural network processing operations, control operations, or execution-management operations associated with the Denali SoC architecture 252.

In some embodiments, the DDR Subsystem 262 may support communication with external memory resources, including DDR memory devices or high-bandwidth memory resources. The DDR Subsystem 262 may coordinate memory-access scheduling operations, refresh operations, memory-allocation operations, or data-transfer operations associated with neural network execution.

In some embodiments, the PCIe Subsystem 264 may support communication with external devices, accelerator resources, storage devices, networking devices, or host systems. The PCIe Subsystem 264 may further support high-speed streaming data transfers associated with neural network workloads.

In some embodiments, the MIPI Subsystem 266 may support communication with image sensors, camera interfaces, multimedia devices, or external streaming interfaces. The Slow-speed Peripheral resources 268 may support communication with GPIO interfaces, SPI interfaces, I2C interfaces, UART interfaces, or additional peripheral-management resources.

In some embodiments, the SoC Subsystem 258 may further include an SoC Subsystem Local Interconnect 270 configured to enable communication among subsystem resources, memory resources, compute resources, or control resources. The SoC Subsystem Local Interconnect 270 may correspond to a network-on-chip structure, communication bus, or shared interconnect fabric.

In some embodiments, the SoC Subsystem 258 may further include Common DPU Components 272, an SoC Subsystem SRAM Controller 274, and an SoC Subsystem Local SRAM 276. The Common DPU Components 272 may support scheduling operations, token-propagation operations, dependency tracking operations, vector-processing operations, or asynchronous execution operations associated with neural network graph execution.

In some embodiments, the SoC Subsystem SRAM Controller 274 may coordinate access to the SoC Subsystem Local SRAM 276. The SoC Subsystem Local SRAM 276 may store execution tiles, tensor data, operation descriptors, queue structures, token lists, counter values, producer–consumer buffers, or memory-resident execution structures associated with execution of neural network operations.

In some embodiments, the Denali SoC architecture 252 may further include one or more ACE Tiles 280 coupled to the Chip-level Global NoC 204. Each ACE Tile 280 may include one or more Analog Compute Engines (ACE) 281, an ACE Controller 282, an NVM Controller 283, a DPU Local Interconnect 284, Common DPU Components and Digital Compute Components 285, a DPU SRAM Controller 286, and a DPU Local SRAM 287.

In some embodiments, the Analog Compute Engines 281 may perform analog matrix multiplication operations, tensor-processing operations, convolution operations, vector-processing operations, or neural network inference operations. The ACE Controller 282 may coordinate scheduling operations, operation dispatch operations, synchronization operations, or execution-control operations associated with operation of the Analog Compute Engines 281.

In some embodiments, the NVM Controller 283 may coordinate access to non-volatile memory resources associated with storage of weights, neural network parameters, configuration structures, or execution data associated with neural network execution.

In some embodiments, the DPU Local Interconnect 284 may enable communication among compute resources, memory resources, scheduling resources, or execution-management resources within the ACE Tile 280. The DPU Local Interconnect 284 may correspond to an on-tile communication fabric configured to support low-latency communication between local compute resources.

In some embodiments, the Common DPU Components and Digital Compute Components 285 may support token-based scheduling operations, dependency tracking operations, SIMD operations, tile-based execution operations, asynchronous execution operations, or producer–consumer buffering operations associated with execution of neural network graphs.

In some embodiments, the DPU SRAM Controller 286 may coordinate access to the DPU Local SRAM 287. The DPU Local SRAM 287 may store execution tiles, intermediate tensor data, token lists, operation queues, dependency counters, or memory-resident control structures associated with tiled neural network execution.

In some embodiments, the Denali SoC architecture 252 may support distributed execution of neural network operations across multiple ACE Tiles 280, enabling scalable execution of neural network graphs using heterogeneous compute resources, distributed memory resources, and asynchronous dataflow scheduling mechanisms.

### 3. DPU Internal Dataflow and Control Paths

FIG. 3 illustrates an example embodiment of internal dataflow and control paths within the Dataflow Processing Unit 101. The arrangement shown in FIG. 3 may define how data, control information, and dependency signals propagate through a Dataflow Execution Fabric 301 to enable execution of operations based on data availability and resource conditions.

In some embodiments, the Dataflow Execution Fabric 301 may include a Data Path 302, a Control Path 303, an Event Signaling Path 304, a Memory Access Path 306, a Token Propagation Path 307, an Operation Dispatch Path 308, one or more Buffer Interfaces 309, and one or more Execution Pipeline Stages 310. The paths illustrated in FIG. 3 may be logical or physical pathways implemented using interconnects, buses, or communication fabrics within the Dataflow Processing Unit 101.

### Data Path

In some embodiments, the Data Path 302 may provide a mechanism for transferring data between memory and compute resources. The Data Path 302 may carry input data, intermediate data, and output data associated with execution of operations.

The Data Path 302 may connect the Buffer Access Cluster (FIG. 1A), the SRAM, and hardware controllers within the Heterogeneous Compute Domain 701 (FIG. 7). Data may flow through the Data Path 302 in the form of Execution Tiles 1002 (FIG. 10), enabling partial-data execution.

In some embodiments, the Data Path 302 may support concurrent data transfers, allowing multiple operations to access and process data simultaneously.

### Control Path

In some embodiments, the Control Path 303 may carry control information used to coordinate execution of operations. The Control Path 303 may include signals related to operation configuration, scheduling decisions, and resource availability.

The Control Path 303 may connect the Token and Operation Manager 102 (FIG. 1A) with hardware controllers, enabling transmission of operation commands and control signals. The Control Path 303 may also support communication of configuration data retrieved from Operation Configuration Structures 607 (FIG. 6).

### Event Signaling Path

In some embodiments, the Event Signaling Path 304 may carry event notifications generated during execution. Events may include completion of data transfers, completion of compute operations, or updates to buffer states.

The Event Signaling Path 304 may transmit Dataflow Trigger Events 1206 (FIGS. 12A-B) to the Token and Operation Manager 102. The Token and Operation Manager 102 may process the events to update dependency state and determine whether subsequent operations are eligible for execution.

### Memory Access Path

In some embodiments, the Memory Access Path 306 may provide communication between the Buffer Access Cluster and the SRAM Controller (FIG. 1A). The Memory Access Path 306 may support read, write, and read-modify-write operations to SRAM.

The Memory Access Path 306 may be used to transfer data between memory and compute resources, as well as to access control structures such as token lists, counters, and operation configurations.

### Token Propagation Path

In some embodiments, the Token Propagation Path 307 may carry Tokenized Dependency Indicators 1301 (FIGS. 13A-B) between components of the Dataflow Processing Unit 101. Tokens may be generated by hardware controllers or the Buffer Access Cluster in response to execution events.

The Token Propagation Path 307 may enable propagation of dependency updates across operations. Tokens transmitted along the Token Propagation Path 307 may be processed by the Token and Operation Manager 102 to update Resource Counters 404 and Operation Counters 405 (FIG. 4).

### Operation Dispatch Path

In some embodiments, the Operation Dispatch Path 308 may carry operation commands from the Token and Operation Manager 102 to hardware controllers. The Operation Dispatch Path 308 may be implemented using the Operation Bus (FIG. 1A).

Operation commands may include configuration data specifying input buffers, output buffers, operation parameters, and execution conditions. Hardware controllers may receive operation commands and execute operations accordingly.

### Buffer Interface

In some embodiments, the Buffer Interface 309 may provide access to Producer–Consumer Buffers 803 (FIG. 8A) stored in SRAM. The Buffer Interface 309 may enable data transfer between the Data Path 302 and buffer structures.

The Buffer Interface 309 may coordinate with the Circular Buffer Controller 507 (FIG. 5) to manage buffer state, including read and write pointers and buffer capacity.

### Execution Pipeline Stages

In some embodiments, execution within the Dataflow Processing Unit 101 may be organized into one or more Execution Pipeline Stages 310. Each Execution Pipeline Stage 310 may correspond to a stage in a Streaming Execution Pipeline 1101–1110 (FIGS. 11A-B).

Different Execution Pipeline Stages 310 may process different Execution Tiles 1002 concurrently. For example, one stage may perform data transfer, another stage may perform computation, and another stage may perform data writeback.

In some embodiments, the Data Path 302, Control Path 303, and Event Signaling Path 304 may operate in coordination to enable data-driven execution. The Data Path 302 may transfer data required for execution, while the Control Path 303 may configure operations and manage scheduling.

The Event Signaling Path 304 may provide feedback based on execution progress, enabling the Token and Operation Manager 102 to update dependency state. The Token Propagation Path 307 may distribute tokens that represent progress of operations.

The Operation Dispatch Path 308 may initiate execution of operations when readiness conditions are satisfied. The Memory Access Path 306 and Buffer Interface 309 may support data storage and retrieval required for execution.

In some embodiments, the arrangement of paths illustrated in FIG. 3 may enable asynchronous and concurrent execution of operations within the Dataflow Processing Unit 101. Data movement and computation may occur in parallel, and scheduling decisions may be based on real-time system state.

The separation of data, control, and event signaling paths may allow efficient coordination of components while minimizing interference between different types of communication.

In some embodiments, the paths illustrated in FIG. 3 may be implemented using dedicated interconnects, shared buses, or network-on-chip structures. The specific implementation may depend on design requirements, including performance, area, and power constraints.

The arrangement illustrated in FIG. 3 is provided as an example and may be modified based on implementation requirements. Additional paths or interfaces may be included to support specific features or optimizations.

### 4. Token and Operation Manager Architecture

FIG. 4 illustrates an example embodiment of a Token and Operation Manager 102 configured to provide data-driven scheduling and dependency management within the Dataflow Processing Unit 101. The Token and Operation Manager 102 may process Tokenized Dependency Indicators 1301 (FIGS. 13A-B), evaluate execution readiness conditions, and dispatch operations to hardware controllers when one or more conditions are satisfied.

In some embodiments, the Token and Operation Manager 102 may include a Token List Launcher 402, a Token Operation Processor 403, one or more Resource Counters 404, one or more Operation Counters 405, a Work Queue Manager 406, one or more Operation Queues 407, a Token Storage Structure 408, an Operation Dispatch Interface 409, and a Threshold Evaluation Logic 410. The components of FIG. 4 may be implemented as hardware logic, microcoded logic, memory-resident structures, or a combination thereof.

### Token List Launcher

In some embodiments, the Token List Launcher 402 may retrieve token lists from the Token Storage Structure 408 stored in SRAM (FIG. 1A). Each token list may include one or more tokens, where each token may represent an update to a dependency state associated with an operation or resource.

The Token List Launcher 402 may receive pointers to token lists from one or more sources, including the Buffer Access Cluster (FIG. 1A), the Work Queue Manager 406, or external interfaces such as the Network-on-Chip Interface 110. The Token List Launcher 402 may traverse one or more token lists and forward tokens to the Token Operation Processor 403 for processing.

In some embodiments, a token list may include a pointer to an additional token list, enabling chained token list processing. Such chaining may enable propagation of dependency updates across multiple operations or subsystems.

### Token Operation Processor

In some embodiments, the Token Operation Processor 403 may receive tokens from the Token List Launcher 402 and update one or more counters based on information contained in the tokens. Each token may identify a target counter, an update value, and a type of update.

The Token Operation Processor 403 may access the Resource Counters 404 and Operation Counters 405 stored in SRAM. The Token Operation Processor 403 may perform counter updates using increment, decrement, or other arithmetic operations. The Token Operation Processor 403 may further evaluate whether updated counter values satisfy one or more threshold conditions using the Threshold Evaluation Logic 410.

In some embodiments, evaluation of threshold conditions may determine whether sufficient input data is available, whether sufficient output buffer capacity is available, or whether one or more dependency conditions have been satisfied for an operation.

### Resource Counters

In some embodiments, the Resource Counters 404 may represent availability of resources associated with execution of operations. Resources may include data stored in Producer–Consumer Buffers 803 (FIG. 8A), available buffer capacity, or other measurable quantities.

Each Resource Counter 404 may be updated based on tokens generated by data movement operations or compute operations. For example, a Resource Counter 404 may be incremented when data is produced and written into a buffer and may be decremented when data is consumed from the buffer.

In some embodiments, Resource Counters 404 may be used to determine whether a threshold amount of input data is available for execution of an operation or whether sufficient output buffer capacity exists to store results of an operation.

### Operation Counters

In some embodiments, the Operation Counters 405 may aggregate dependency conditions associated with execution of operations. Each Operation Counter 405 may be associated with a particular operation or class of operations.

The Operation Counters 405 may receive updates based on values of one or more Resource Counters 404. When values of associated Resource Counters 404 satisfy predefined conditions, the Operation Counter 405 may indicate that an operation is eligible for execution.

In some embodiments, an Operation Counter 405 may include additional state information, including iteration state, execution count, or configuration parameters used to control repeated execution of operations.

### Threshold Evaluation Logic

In some embodiments, the Threshold Evaluation Logic 410 may compare values of Resource Counters 404 and Operation Counters 405 against predefined thresholds. The thresholds may be configured by software during initialization of the Dataflow Processing Unit 101.

The Threshold Evaluation Logic 410 may determine whether one or more Execution Readiness Conditions 1204 (FIGS. 12A-B) are satisfied. Such conditions may include availability of input data, availability of output buffer capacity, and satisfaction of dependency constraints.

### Work Queue Manager

In some embodiments, the Work Queue Manager 406 may manage scheduling of operations for execution on hardware controllers. When an Operation Counter 405 indicates that an operation is eligible for execution, the Token Operation Processor 403 may signal the Work Queue Manager 406 to enqueue the operation.

The Work Queue Manager 406 may maintain one or more Operation Queues 407, each associated with a specific hardware controller or compute resource. Each Operation Queue 407 may include one or more Queue Entries 1403 (FIGS. 14A-B) representing operations to be executed.

In some embodiments, the Work Queue Manager 406 may support ordered scheduling of operations and may ensure that operations are dispatched in a sequence that satisfies dependency constraints. The Work Queue Manager 406 may also support concurrent scheduling across multiple Operation Queues 407 to enable parallel execution of operations on different hardware controllers.

### Operation Dispatch Interface

In some embodiments, the Operation Dispatch Interface 409 may transmit operations from the Work Queue Manager 406 to hardware controllers via the Operation Bus (FIG. 1A). Each operation may include configuration data specifying input buffers, output buffers, operation parameters, and other execution information.

The Operation Dispatch Interface 409 may coordinate with hardware controllers to determine availability of execution resources. When a hardware controller indicates availability, the Operation Dispatch Interface 409 may dispatch the next operation from the corresponding Operation Queue 407.

### Operational Flow

In some embodiments, operation of the Token and Operation Manager 102 may proceed as follows. A token may be generated in response to a Dataflow Trigger Event 1206 (FIGS. 12A-B), such as completion of a data transfer or completion of a compute operation. The token may be stored in the Token Storage Structure 408 and processed by the Token List Launcher 402.

The Token Operation Processor 403 may update one or more Resource Counters 404 and Operation Counters 405 based on the token. The Threshold Evaluation Logic 410 may determine whether one or more Execution Readiness Conditions are satisfied. When an Execution Readiness Condition is satisfied, the Work Queue Manager 406 may enqueue the corresponding operation into an Operation Queue 407.

When a hardware controller becomes available, the Operation Dispatch Interface 409 may dispatch the operation to the hardware controller for execution. Execution of the operation may result in generation of additional tokens, thereby continuing the data-driven execution process.

In some embodiments, the components of the Token and Operation Manager 102 may be implemented using memory-resident data structures stored in SRAM, combined with hardware logic configured to process tokens and update counters. Such an arrangement may enable scalability by allowing the number of counters and token lists to scale with available memory rather than being limited by fixed hardware structures.

In some embodiments, the Token and Operation Manager 102 may operate without reliance on a centralized processor for scheduling. Instead, scheduling decisions may be performed using hardware evaluation of counter values and threshold conditions, enabling fine-grained synchronization and efficient utilization of compute resources.

### 5. Buffer Access Cluster | Smart DMA Architecture

FIG. 5 illustrates an example embodiment of a Buffer Access Cluster configured to perform memory access operations and data movement within the Dataflow Processing Unit 101. The Buffer Access Cluster may provide a hardware-managed interface between compute resources and memory, enabling efficient transfer of data associated with execution of a computational graph.

In some embodiments, the Buffer Access Cluster may include one or more Buffer Accessors 502, each associated with a corresponding DMA Channel 503. Each Buffer Accessor 502 may be configured to perform read and write operations to SRAM (FIG. 1A) and may operate independently to enable concurrent data transfers. The Buffer Access Cluster may further include a Scatter Engine 504, a Gather Engine 505, an Address Generation Logic 506, a Circular Buffer Controller 507, a Read Interface 508, a Write Interface 509, and an In-Stream Operation Unit 510.

### Buffer accessors and DMA channels

In some embodiments, each Buffer Accessor 502 may correspond to a hardware-managed data movement engine configured to execute memory access commands. Each Buffer Accessor 502 may be allocated to a DMA Channel 503, and each DMA Channel 503 may receive commands from one or more hardware controllers, including the Analog Compute Engine Controller 106, the SIMD Controller, or the Copy Controller 110.

Each Buffer Accessor 502 may process commands that specify a source memory region, a destination memory region, and parameters associated with the data transfer. The Buffer Accessor 502 may access data in SRAM through the SRAM Controller and may transfer data to or from compute resources via the Data Path Interface 113.

In some embodiments, multiple Buffer Accessors 502 may operate concurrently, enabling parallel data transfers that support overlapping execution of multiple operations within the Dataflow Processing Unit 101.

### Scatter and Gather Operation

In some embodiments, the Gather Engine 505 may retrieve data from non-contiguous memory regions and assemble the data into a structured format for consumption by compute resources. The Gather Engine 505 may generate source addresses using the Address Generation Logic 506 based on parameters such as stride, padding, dilation, or tiling configuration.

In some embodiments, the Scatter Engine 504 may distribute data produced by compute resources into non-contiguous memory regions. The Scatter Engine 504 may compute destination addresses using the Address Generation Logic 506 and may place output data into appropriate regions of SRAM.

The Scatter Engine 504 and the Gather Engine 505 may enable efficient processing of Execution Tiles 1002 (FIG. 10) by allowing compute resources to operate on subsets of data without requiring reorganization of entire data structures.

### Address Generation Logic

In some embodiments, the Address Generation Logic 506 may compute memory addresses for read and write operations performed by the Buffer Accessors 502. The Address Generation Logic 506 may support generation of addresses for contiguous and non-contiguous memory access patterns.

The Address Generation Logic 506 may incorporate parameters such as base address, offset, stride, tile dimensions, and boundary conditions. The Address Generation Logic 506 may further support generation of addresses for multi-dimensional data structures, including tensors used in neural network computations.

In some embodiments, the Address Generation Logic 506 may enable automatic handling of padding regions, overlapping regions, and boundary conditions associated with convolution or other operations.

### Circular Buffer Controller

In some embodiments, the Circular Buffer Controller 507 may manage memory structures used as Producer–Consumer Buffers 803 (FIG. 8A). The Circular Buffer Controller 507 may maintain buffer state information, including read pointers and write pointers, and may coordinate reuse of memory regions as data is produced and consumed.

The Circular Buffer Controller 507 may enable continuous streaming of data between producer units and consumer units by recycling buffer storage once data has been consumed. The Circular Buffer Controller 507 may further enforce constraints on buffer capacity and may prevent overwriting of data that has not yet been consumed.

In some embodiments, the Circular Buffer Controller 507 may support buffer configurations associated with line buffers, tile buffers, or other buffer structures used to store intermediate data.

### Read and Write Interfaces

In some embodiments, the Read Interface 508 may provide a mechanism for transferring data from SRAM to compute resources or other components within the Dataflow Processing Unit 101. The Write Interface 509 may provide a mechanism for transferring data from compute resources or other components into SRAM.

The Read Interface 508 and the Write Interface 509 may operate independently and may support concurrent read and write operations. The Read Interface 508 and the Write Interface 509 may further coordinate with the Circular Buffer Controller 507 to maintain consistency of buffer state.

### In-Stream Operation Unit

In some embodiments, the In-Stream Operation Unit 510 may perform data transformations on data as the data is transferred between memory and compute resources. The In-Stream Operation Unit 510 may perform operations including arithmetic transformations, activation functions, scaling operations, accumulation operations, or read-modify-write operations.

The In-Stream Operation Unit 510 may reduce the need for separate scheduling of certain operations by performing such operations during data transfer. The In-Stream Operation Unit 510 may further reduce memory traffic by avoiding intermediate storage of transformed data.

In some embodiments, the Buffer Access Cluster may interact with the Token and Operation Manager 102 to generate Dataflow Trigger Events 1206 (FIGS. 12A-B). For example, completion of a data transfer may result in generation of a token that updates one or more Resource Counters 404 (FIG. 4).

The Buffer Access Cluster may also receive commands from the Work Queue Manager 406 (FIG. 4) through hardware controllers. The Buffer Access Cluster may execute memory access commands specified in Operation Configuration Structures 607 (FIG. 6).

In some embodiments, the Buffer Access Cluster may coordinate with the SRAM Controller to ensure that memory access requests are serviced efficiently and without conflict.

In some embodiments, the Buffer Access Cluster may enable efficient movement of data associated with Execution Tiles 1002 by supporting scatter/gather operations, circular buffer reuse, and in-stream transformations. The Buffer Access Cluster may allow compute resources to operate on subsets of data without requiring full materialization of data structures.

In some embodiments, the Buffer Access Cluster may support overlapping execution of data movement and computation, enabling a Streaming Execution Pipeline 1101–1110 (FIGS. 11A-B). The Buffer Access Cluster may further reduce memory footprint by enabling reuse of buffer structures and minimizing storage of intermediate data.

In some embodiments, the Buffer Access Cluster may be implemented as a set of hardware engines with dedicated control logic and memory interfaces. In some embodiments, the number of Buffer Accessors 502 may be selected based on performance requirements and available resources.

In some embodiments, the Buffer Access Cluster may be configured through software during initialization of the Dataflow Processing Unit 101. Configuration parameters may include buffer sizes, tiling parameters, address generation parameters, and operation configurations.

The arrangement illustrated in FIG. 5 is provided as an example and may be modified based on implementation requirements. Additional features or components may be included to support specific use cases or performance goals.

### 6. SRAM Controller and Memory-Resident Control Structures

FIG. 6 illustrates an example embodiment of an SRAM Controller and associated memory-resident structures configured to support data storage, dependency tracking, and operation configuration within the Dataflow Processing Unit 101. The SRAM Controller may provide coordinated access to one or more SRAM Banks 602 that store both data and control information used during execution of a computational graph.

In some embodiments, the SRAM (FIG. 1A) may be logically partitioned into multiple regions, including a Buffer Data Region 603, a Buffer Configuration Structure 604, a Token List Storage 605, a Counter Storage 606, an Operation Configuration Structure 607, and a Queue Storage Structure 608. The SRAM Controller may include a Memory Arbitration Logic 609 and a Memory Access Interface 610 to manage access to these regions by multiple hardware components.

### SRAM Banks and Data Storage

In some embodiments, the SRAM Banks 602 may store data associated with execution of operations, including input data, intermediate data, and output data. The Buffer Data Region 603 may include one or more memory regions allocated for Producer–Consumer Buffers 803 (FIG. 8A), enabling storage of Execution Tiles 1002 (FIG. 10) and intermediate results.

The SRAM Banks 602 may be organized to support concurrent access by multiple hardware components, including the Buffer Access Cluster and the Token and Operation Manager 102. In some embodiments, the SRAM Banks 602 may be physically distributed or logically partitioned to improve throughput and reduce access contention.

### Buffer Configuration Structures

In some embodiments, the Buffer Configuration Structure 604 may store configuration data associated with buffers used during execution. The Buffer Configuration Structure 604 may include parameters such as buffer size, buffer type, base address, access stride, and circular buffer parameters.

The Buffer Access Cluster may reference the Buffer Configuration Structure 604 to determine how data is read from and written to the Buffer Data Region 603. The Buffer Configuration Structure 604 may support different buffer types, including line buffers, tile buffers, and circular buffers.

### Token List Storage

In some embodiments, the Token List Storage 605 may store token lists that are processed by the Token List Launcher 402 (FIG. 4). Each token list may include one or more tokens, where each token may specify an update to a counter or a propagation of a dependency state.

The Token List Storage 605 may be accessed by the Token and Operation Manager 102 to retrieve token lists during execution. In some embodiments, token lists may be dynamically updated during execution to reflect changes in dataflow or execution state.

### Counter Storage

In some embodiments, the Counter Storage 606 may store Resource Counters 404 and Operation Counters 405 (FIG. 4). The Counter Storage 606 may be accessed by the Token Operation Processor 403 to update counter values based on Tokenized Dependency Indicators 1301 (FIGS. 13A-B).

The Counter Storage 606 may store values representing data availability, buffer capacity, and operation readiness. In some embodiments, the Counter Storage 606 may support a large number of counters, enabling fine-grained tracking of dependencies across multiple operations.

### Operation Configuration

In some embodiments, the Operation Configuration Structure 607 may store configuration data associated with operations to be executed by hardware controllers. Each operation configuration may include parameters such as input buffer identifiers, output buffer identifiers, operation type, execution parameters, and dependency information.

The Token and Operation Manager 102 may retrieve operation configurations from the Operation Configuration Structure 607 when dispatching operations through the Operation Bus (FIG. 1A). The Operation Configuration Structure 607 may be populated during initialization based on compilation of a computational graph.

### Queue Storage Structures

In some embodiments, the Queue Storage Structure 608 may store Operation Queues 407 (FIG. 4) managed by the Work Queue Manager 406. The Queue Storage Structure 608 may include memory regions allocated for storing queue entries corresponding to operations that are ready for execution.

The Queue Storage Structure 608 may support different queue implementations, including linear queues and linked-list-based queues. In some embodiments, the Queue Storage Structure 608 may enable dynamic allocation of queue entries based on execution requirements.

### Memory Arbitration Logic

In some embodiments, the Memory Arbitration Logic 609 may coordinate access to the SRAM Banks 602 by multiple hardware components. The Memory Arbitration Logic 609 may receive memory access requests from the Buffer Access Cluster, the Token and Operation Manager 102, and hardware controllers.

The Memory Arbitration Logic 609 may schedule memory access requests to ensure efficient utilization of memory bandwidth and to prevent conflicts. In some embodiments, the Memory Arbitration Logic 609 may implement priority schemes or fairness policies to manage competing access requests.

### Memory Access Interface

In some embodiments, the Memory Access Interface 610 may provide a communication interface between the SRAM Controller and other components within the Dataflow Processing Unit 101. The Memory Access Interface 610 may support read, write, and read-modify-write operations.

The Buffer Access Cluster may use the Memory Access Interface 610 to transfer data between SRAM and compute resources. The Token and Operation Manager 102 may use the Memory Access Interface 610 to access control structures such as Token List Storage 605 and Counter Storage 606.

In some embodiments, the SRAM Controller and associated memory-resident structures may enable data-driven execution by providing shared storage for data and control information. The Buffer Data Region 603 may store data used in Producer–Consumer Buffers 803, enabling asynchronous data transfer between operations.

The Token List Storage 605 and Counter Storage 606 may support tracking of dependencies and execution readiness. Updates to counters may be triggered by Dataflow Trigger Events 1206 (FIGS. 12A-B), such as completion of data transfers or compute operations.

The Operation Configuration Structure 607 and Queue Storage Structure 608 may support scheduling and dispatch of operations, enabling the Token and Operation Manager 102 to coordinate execution across hardware controllers.

In some embodiments, the use of memory-resident control structures may enable scalability by allowing the number of tracked dependencies, operations, and buffers to scale with available memory capacity. The arrangement may reduce reliance on fixed hardware structures and may provide flexibility in configuring execution of computational graphs.

The SRAM Controller may support concurrent access by multiple components, enabling overlapping execution of data movement and computation. The architecture may support efficient reuse of buffer memory and may reduce memory footprint by storing only subsets of data required for execution.

In some embodiments, the SRAM Controller and SRAM Banks 602 may be implemented using on-chip memory technologies. The size and organization of SRAM Banks 602 may be selected based on performance requirements and available resources.

The memory-resident structures illustrated in FIG. 6 may be configured by software during initialization of the Dataflow Processing Unit 101. The configuration may be based on a mapping of a computational graph to hardware resources.

The arrangement illustrated in FIG. 6 is provided as an example and may be modified based on implementation requirements. Additional memory structures or control structures may be included to support specific use cases or performance goals.

### 7. Heterogenous Hardware Controller Arrangement

FIG. 7 illustrates an example embodiment of a Heterogeneous Compute Domain 701 within the Dataflow Processing Unit 101 configured to execute operations associated with a computational graph using multiple types of compute resources. The Heterogeneous Compute Domain 701 may include a plurality of hardware resources of differing computational characteristics that collectively enable efficient execution of diverse operation types.

In some embodiments, the Heterogeneous Compute Domain 701 may include an Analog Compute Engine 702, a SIMD Engine 703, a Copy Engine 704, and an NVM Controller 705. Each of the hardware resources may be coupled via a Hardware Controller Interface 706 and a Local Interconnect 109 (FIG. 1A). The Heterogeneous Compute Domain 701 may further include an Execution Unit Scheduler Interface 708 and a Data Movement Interface 709, enabling coordination with other components of the Dataflow Processing Unit 101. In some embodiments, the hardware resources may be logically organized as a Compute Resource Pool 710.

### Analog Compute Engine

In some embodiments, the Analog Compute Engine 702 may be configured to perform matrix multiplication operations associated with neural network inference. The Analog Compute Engine 702 may utilize analog compute-in-memory techniques to perform multiply-accumulate operations using data stored in non-volatile memory elements.

The Analog Compute Engine 702 may receive input data from SRAM (FIG. 1A) through the Buffer Access Cluster and may output results back to SRAM. The Analog Compute Engine 702 may be controlled by the Analog Compute Engine Controller 106 (FIG. 1A), which may receive operation configurations from the Token and Operation Manager 102 via the Operation Bus.

In some embodiments, the Analog Compute Engine 702 may be optimized for high-throughput, low-power execution of dense linear algebra operations.

### SIMD Engine

In some embodiments, the SIMD Engine 703 may be configured to perform vector-based operations on data stored in SRAM. The SIMD Engine 703 may execute operations including element-wise arithmetic, activation functions, normalization operations, and other non-matrix computations.

The SIMD Engine 703 may operate on vectors of data in parallel and may support a range of instruction types defined by an instruction set architecture. The SIMD Engine 703 may be controlled by the SIMD Controller (FIG. 1A), which may retrieve operation configurations and manage execution of operations.

In some embodiments, the SIMD Engine 703 may complement the Analog Compute Engine 702 by handling operations that are not efficiently executed using analog computation.

### Copy Engine

In some embodiments, the Copy Engine 704 may be configured to perform data movement operations between memory regions or between subsystems within the Dataflow Processing Unit 101. The Copy Engine 704 may support operations including memory-to-memory transfers, data reorganization, and data replication.

The Copy Engine 704 may be controlled by the Copy Controller 110 (FIG. 1A) and may utilize the Buffer Access Cluster to access SRAM. The Copy Engine 704 may assist in preparing data for execution by other hardware resources and may support efficient movement of Execution Tiles 1002 (FIG. 10).

### NVM Controller

In some embodiments, the NVM Controller 705 may manage access to non-volatile memory associated with the Analog Compute Engine 702. The NVM Controller 705 may support operations including programming, erasing, and reading memory cells used for analog computation.

The NVM Controller 705 may ensure proper operation of non-volatile memory elements and may coordinate with the Analog Compute Engine 702 to maintain data integrity and operational accuracy.

### Hardware Controller Interface and Interconnect

In some embodiments, the Hardware Controller Interface 706 may provide communication pathways between the Token and Operation Manager 102 and the hardware resources within the Heterogeneous Compute Domain 701. The Hardware Controller Interface 706 may receive operation commands and configuration data via the Operation Bus.

The Local Interconnect 109 may provide connectivity between the hardware resources and other components within the Dataflow Processing Unit 101. The Local Interconnect 109 may support data transfer, control signaling, and event propagation.

### Execution Unit Scheduler Interface

In some embodiments, the Execution Unit Scheduler Interface 708 may provide a mechanism for coordinating execution of operations across the hardware resources. The Execution Unit Scheduler Interface 708 may receive scheduling signals from the Token and Operation Manager 102 and may indicate availability of hardware resources.

The Execution Unit Scheduler Interface 708 may enable dynamic assignment of operations to hardware resources based on availability and capability, supporting parallel execution of multiple operations.

### Data Movement Interface

In some embodiments, the Data Movement Interface 709 may provide a mechanism for transferring data between hardware resources and memory. The Data Movement Interface 709 may coordinate with the Buffer Access Cluster to perform data transfers associated with execution of operations.

The Data Movement Interface 709 may enable efficient movement of data between the Analog Compute Engine 702, the SIMD Engine 703, the Copy Engine 704, and SRAM.

### Computer Resource Pool

In some embodiments, the hardware resources within the Heterogeneous Compute Domain 701 may be organized as a Compute Resource Pool 710. The Compute Resource Pool 710 may include multiple instances of each hardware resource type, enabling parallel execution of operations.

The Compute Resource Pool 710 may allow operations to be scheduled dynamically based on resource availability and execution requirements. The Token and Operation Manager 102 may dispatch operations to available resources within the Compute Resource Pool 710 using the Work Queue Manager 406 (FIG. 4).

In some embodiments, the Heterogeneous Compute Domain 701 may execute operations mapped from a neural network graph. The Token and Operation Manager 102 may determine execution readiness based on Tokenized Dependency Indicators 1301 (FIGS. 13A-B) and may dispatch operations to appropriate hardware resources.

The Buffer Access Cluster may provide data to the hardware resources and may store results in SRAM. The hardware resources may generate Dataflow Trigger Events 1206 (FIGS. 12A-B) upon completion of operations, which may result in updates to counters and scheduling of subsequent operations.

In some embodiments, operations may be executed in a Streaming Execution Pipeline 1101–1110 (FIGS. 11A-B), with different hardware resources processing different Execution Tiles 1002 concurrently.

In some embodiments, the use of a Heterogeneous Compute Domain 701 may enable efficient execution of diverse operation types within a computational graph. The Analog Compute Engine 702 may provide high-efficiency execution of matrix operations, while the SIMD Engine 703 may handle element-wise and control operations.

The Copy Engine 704 may facilitate data movement and preparation, and the NVM Controller 705 may manage non-volatile memory associated with analog computation. The combination of these resources may improve overall system performance and flexibility.

In some embodiments, the number and types of hardware resources within the Heterogeneous Compute Domain 701 may be selected based on performance requirements and target applications. Additional hardware resources may be included to support specialized operations.

The arrangement illustrated in FIG. 7 is provided as an example and may be modified based on implementation requirements. The Heterogeneous Compute Domain 701 may be scaled to include additional resources or integrated with other processing units through the Network-on-Chip Interface 110.

### 8A. Producer-Consumer Buffer Architecture

FIG. 8A illustrates an example embodiment of a Producer–Consumer Buffering Architecture configured to enable asynchronous data exchange between operations executed within the Dataflow Processing Unit 101. The architecture may include a Producer Unit 801, a Consumer Unit 802, and a Producer–Consumer Buffer 803 positioned between the Producer Unit 801 and the Consumer Unit 802.

In some embodiments, the Producer Unit 801 may generate data corresponding to execution of an operation, and the Consumer Unit 802 may consume the generated data as input for a subsequent operation. The Producer–Consumer Buffer 803 may temporarily store data produced by the Producer Unit 801 until the Consumer Unit 802 is ready to consume the data.

The Producer–Consumer Buffer 803 may be implemented as a circular buffer managed using a Write Pointer 804 and a Read Pointer 805. The Write Pointer 804 may indicate a location for storing newly produced data, and the Read Pointer 805 may indicate a location for retrieving data for consumption. A Buffer Capacity Indicator 806 may track available storage capacity within the Producer–Consumer Buffer 803.

In some embodiments, the Producer Unit 801 may write data into the Producer–Consumer Buffer 803 without waiting for the Consumer Unit 802 to consume previously written data, provided that sufficient buffer capacity exists. Similarly, the Consumer Unit 802 may read data from the Producer–Consumer Buffer 803 as soon as a sufficient amount of data is available, without waiting for completion of all data production.

The Producer–Consumer Buffer 803 may form part of a Buffered Dataflow Channel 807 that enables asynchronous data transfer between operations. A Buffer State Tracker 808 may maintain information related to data availability and buffer utilization. Data transfer between the Producer Unit 801 and the Consumer Unit 802 may occur via a Data Transfer Interface 809.

In some embodiments, the Producer–Consumer Buffer 803 may define a Synchronization Boundary 810 that decouples execution timing of the Producer Unit 801 and the Consumer Unit 802. The arrangement may enable overlapping execution of operations and may reduce idle time associated with strict synchronization.

### 8B. Asynchronous Execution of Neural Network Operations

FIG. 8B illustrates an example embodiment of a buffered neural network execution architecture 880 configured to support asynchronous execution of neural network operations using intermediate producer–consumer buffers positioned between execution stages. In some embodiments, the buffered neural network execution architecture 880 may support streaming execution, tile-based execution, partial-data execution, or overlapped execution of neural network operations.

In some embodiments, the buffered neural network execution architecture 880 may receive input data through an Input node 881. The Input node 881 may provide tensor data, activation data, image data, execution tiles, or streaming input data to downstream operations through one or more intermediate buffers.

In some embodiments, a first Buffer 882 may temporarily store input data generated by the Input node 881 prior to consumption by a Conv operation 883. The Buffer 882 may correspond to a producer–consumer buffer, circular buffer, tile buffer, execution queue, SRAM-resident buffer, or line buffer configured to decouple timing of data production from timing of data consumption.

In some embodiments, the Conv operation 883 may perform convolution operations on execution tiles received from the Buffer 882. The Conv operation 883 may utilize a kernel having dimensions of 4×4, a stride of 4, and a filter count of 6. The Conv operation 883 may produce output data corresponding to dimensions of 6×32×32.

In some embodiments, output data generated by the Conv operation 883 may be stored within a Buffer 884 prior to consumption by a Relu operation 885. The Buffer 884 may temporarily store intermediate tensor data while downstream compute resources become available.

In some embodiments, the Relu operation 885 may perform element-wise activation operations on data received from the Buffer 884. Output data generated by the Relu operation 885 may be stored within a Buffer 886 prior to consumption by downstream operations.

In some embodiments, the Buffer 886 may provide output data concurrently to a MaxPool operation 887 and a Conv operation 893. The MaxPool operation 887 may perform pooling operations using a kernel having dimensions of 2×2, a stride of 2, and a filter count of 1. The Conv operation 893 may similarly perform convolution operations using a kernel having dimensions of 2×2, a stride of 2, and a filter count of 1.

In some embodiments, the MaxPool operation 887 and the Conv operation 893 may execute concurrently based on availability of sufficient intermediate data within the Buffer 886. Such execution may support overlapping operation execution, asynchronous scheduling, or parallel consumption of intermediate tensor data.

In some embodiments, outputs generated by the MaxPool operation 887 and the Conv operation 893 may be stored within a Buffer 888 prior to processing by a Concat and Reshape operation 892. The Concat and Reshape operation 892 may combine output tensors from multiple operations and may transform tensor dimensions for downstream execution stages.

In some embodiments, output data generated by the Concat and Reshape operation 892 may be stored within a Buffer 894 prior to execution of a Gemm operation 895. The Gemm operation 895 may perform matrix multiplication operations using one or more matrix-processing accelerators. The Gemm operation 895 may receive input tensors having dimensions corresponding to 1×1536 and may generate output tensors corresponding to dimensions of 1×10.

In some embodiments, output data generated by the Gemm operation 895 may be stored within a Buffer 897 prior to execution of a SoftMax operation 898. The SoftMax operation 898 may perform normalization operations, probability generation operations, or classification operations associated with neural network inference.

In some embodiments, output data generated by the SoftMax operation 898 may be stored within a Buffer 899 prior to generation of final output data through an Output node 900.

In some embodiments, the buffered neural network execution architecture 880 may further include hardware acceleration resources configured to support execution of neural network operations. Such hardware acceleration resources may include a DMA Engine and Data Swizzler 889, a Matrix × Vector Accelerator 890, Arithmetic Units 891 and 892, a DMA Engine and Data Swizzler 896, a Matrix × Matrix Accelerator 899, and an Arithmetic Unit 901.

In some embodiments, the DMA Engine and Data Swizzler 889 and the DMA Engine and Data Swizzler 896 may coordinate movement of execution tiles, tensor data, or intermediate activation data between memory resources and compute resources. The Matrix × Vector Accelerator 890 may perform convolution-related matrix operations associated with the Conv operation 883. The Arithmetic Units 891 and 892 may perform activation operations, pooling operations, arithmetic transformations, or element-wise tensor operations.

In some embodiments, the Matrix × Matrix Accelerator 899 may perform matrix multiplication operations associated with the Gemm operation 895. The Arithmetic Unit 901 may perform normalization operations, SoftMax operations, probability calculations, or output post-processing operations.

In some embodiments, the buffered neural network execution architecture 880 may support asynchronous execution of operations by enabling intermediate tensor data to be produced and consumed independently across execution stages. The intermediate buffers may reduce synchronization overhead, improve hardware utilization, enable overlapping execution of operations, and support fine-grained tile-based scheduling.

In some embodiments, one or more buffers illustrated in the buffered neural network execution architecture 880 may be implemented using SRAM resources, line buffers, circular buffers, queue structures, or additional on-chip memory resources configured to support low-latency streaming execution.

### 8C. Asynchronous Execution of Operations Using Shared Buffer

FIG. 8C illustrates an example embodiment of a producer–consumer execution architecture 860 configured to support asynchronous execution of operations using a shared intermediate buffer and hardware scheduling coordination. In some embodiments, the producer–consumer execution architecture 860 may enable overlapping execution of producer operations and consumer operations through use of a memory-resident buffering structure.

In some embodiments, the producer–consumer execution architecture 860 may include a Producer resource 861, a Consumer resource 862, a Buffer 863, and a Scheduler 868. The Producer resource 861 and the Consumer resource 862 may correspond to hardware compute resources, accelerator resources, execution engines, tensor-processing resources, DMA resources, neural network execution resources, or additional hardware processing blocks configured to produce and consume intermediate data.

In some embodiments, the Buffer 863 may correspond to a producer–consumer buffer configured to temporarily store intermediate data generated by the Producer resource 861 prior to consumption by the Consumer resource 862. The Buffer 863 may be implemented as a circular buffer, queue structure, SRAM-resident buffer, line buffer, tile buffer, or additional memory structure configured to decouple timing of data production from timing of data consumption.

In some embodiments, the Buffer 863 may include multiple buffer regions, including a first buffer region 864, a second buffer region 865, a third buffer region 866, and a fourth buffer region 867. The multiple buffer regions may correspond to independently addressable storage regions configured to store execution tiles, tensor data, intermediate activation data, matrix fragments, or streaming data generated during neural network execution.

In some embodiments, the Producer resource 861 may perform a first operation corresponding to production and writing of data into the Buffer 863, as indicated by operation (1). The Producer resource 861 may generate execution tiles, tensor fragments, activation data, convolution results, or additional intermediate data and may store such data within one or more buffer regions of the Buffer 863.

In some embodiments, the Producer resource 861 may further generate a Data Produced Event corresponding to operation (2). The Data Produced Event may be transmitted to the Scheduler 868 to indicate availability of newly produced data within the Buffer 863.

In some embodiments, the Scheduler 868 may evaluate execution readiness conditions associated with the Consumer resource 862 based on receipt of the Data Produced Event, buffer occupancy information, dependency conditions, threshold conditions, or resource availability conditions.

In some embodiments, the Scheduler 868 may initiate scheduling of one or more operations associated with the Consumer resource 862, as indicated by operation (3a). Such scheduling operations may occur prior to completion of all data production by the Producer resource 861, thereby enabling partial-data execution and asynchronous execution.

In some embodiments, the Producer resource 861 may continue generating and writing additional data into the Buffer 863 during execution of the Consumer resource 862, as indicated by operation (3b). Such operation may enable overlapping execution of data production and data consumption.

In some embodiments, the Consumer resource 862 may perform a read and consume operation corresponding to operation (4). The Consumer resource 862 may retrieve execution tiles, tensor fragments, or intermediate activation data from one or more buffer regions of the Buffer 863 while additional data continues to be produced by the Producer resource 861.

In some embodiments, the Consumer resource 862 may generate a Data Consumed Event corresponding to operation (5). The Data Consumed Event may be transmitted to the Scheduler 868 to indicate that one or more buffer regions have become available for reuse by the Producer resource 861.

In some embodiments, the Scheduler 868 may coordinate reuse of one or more buffer regions 864-867 based on production progress, consumption progress, buffer utilization conditions, or dependency conditions. The Scheduler 868 may further support asynchronous scheduling, token-based scheduling, counter-based scheduling, event-driven scheduling, or tile-based execution scheduling.

In some embodiments, the producer–consumer execution architecture 860 may enable concurrent execution of producer operations and consumer operations without requiring strict synchronization between the Producer resource 861 and the Consumer resource 862. Such operation may improve hardware utilization, reduce execution latency, increase streaming throughput, and support fine-grained execution of neural network graphs.

In some embodiments, the Buffer 863 may be implemented using one or more SRAM resources, on-chip memory resources, distributed memory structures, or circular buffering mechanisms configured to support low-latency streaming execution of neural network operations.

### 9A. Neural Network Graph Mapped to DPU Hardware

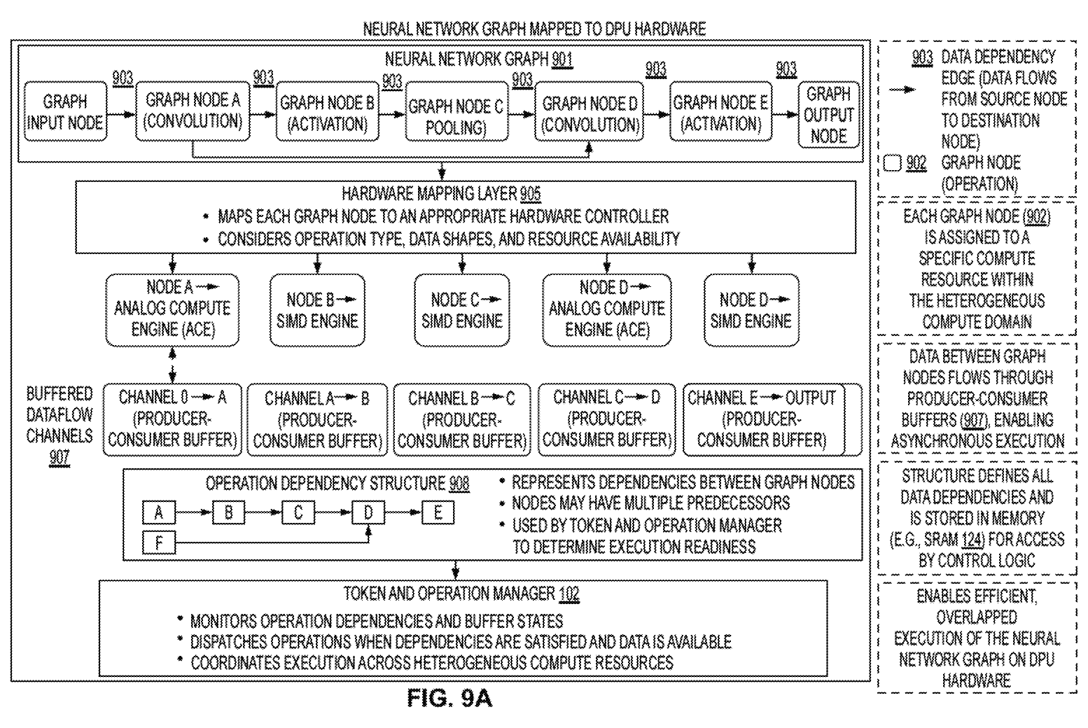

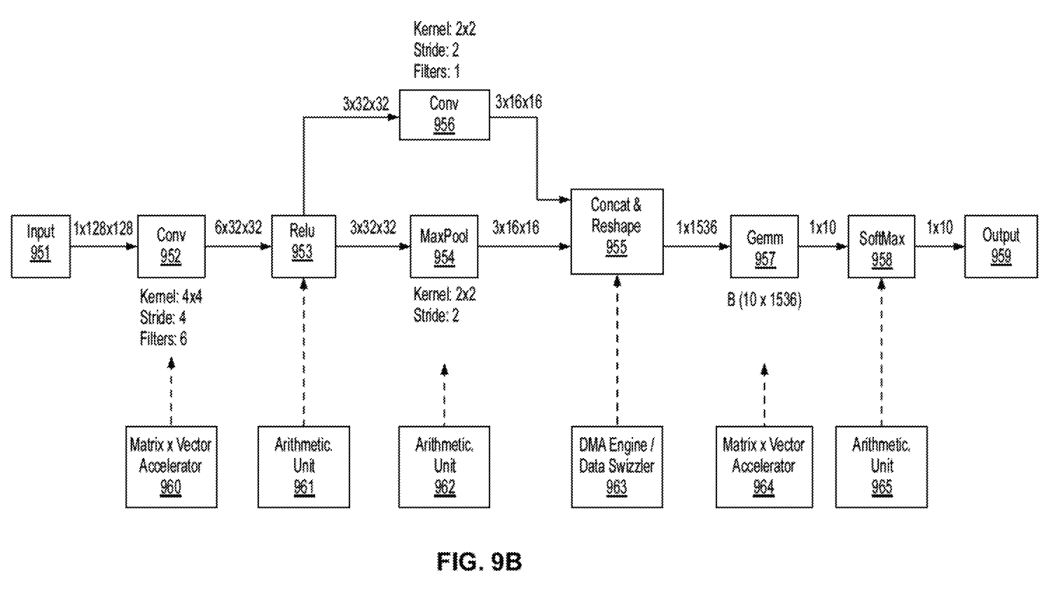

FIG. 9A illustrates an example embodiment of a Neural Network Graph 901 mapped to hardware resources within the Dataflow Processing Unit 101. The Neural Network Graph 901 may include a plurality of Graph Nodes 902 interconnected by Data Dependency Edges 903.

In some embodiments, each Graph Node 902 may correspond to an operation, such as a convolution operation, an activation function, or a pooling operation. Each Data Dependency Edge 903 may represent a flow of data between operations.

The Neural Network Graph 901 may be mapped to hardware using a Hardware Mapping Layer 905, which may assign operations to specific compute resources within the Heterogeneous Compute Domain 701 (FIG. 7). A Compute Resource Assignment 906 may associate each Graph Node 902 with a hardware controller, such as the Analog Compute Engine 702 or the SIMD Engine 703.

In some embodiments, data associated with the Data Dependency Edges 903 may be transferred through Buffered Dataflow Channels 907 implemented using Producer–Consumer Buffers 803 (FIG. 8A). An Operation Dependency Structure 908 may define dependencies between Graph Nodes 902 and may be used by the Token and Operation Manager 102 to determine execution readiness.

The Neural Network Graph 901 may include a Graph Input Node 909 and a Graph Output Node 910 that represent entry and exit points for data. Execution of the Neural Network Graph 901 may proceed based on satisfaction of dependencies and availability of data within the Dataflow Processing Unit 101.

### 9B. Neural Network Graph with Repeat Count for Subset Computations

FIG. 9B illustrates an example embodiment of a neural network execution graph 950 configured for execution across multiple heterogeneous hardware resources within a dataflow processing architecture. In some embodiments, the neural network execution graph 950 may include an Input node 951, a first convolution node 952, a Relu node 953, a MaxPool node 954, a Concat & Reshape node 955, a second convolution node 956, a Gemm node 957, a SoftMax node 958, and an Output node 959.

In some embodiments, the Input node 951 may provide input tensor data having dimensions of 1×128×128 to the first convolution node 952. The first convolution node 952 may perform a convolution operation using a kernel size of 4×4, a stride value of 4, and six filters to generate output activation data having dimensions of 6×32×32.

In some embodiments, execution of the first convolution node 952 may be performed using a Matrix × Vector Accelerator 960. The Matrix × Vector Accelerator 960 may correspond to a hardware matrix multiplication resource configured to accelerate convolution operations, tensor multiplication operations, or vectorized neural network operations.

In some embodiments, output activation data generated by the first convolution node 952 may be provided to the Relu node 953. The Relu node 953 may perform an activation operation configured to apply a rectified linear unit transformation to the activation data. In some embodiments, execution of the Relu node 953 may be performed using an Arithmetic Unit 961 configured to perform scalar arithmetic operations, element-wise activation operations, thresholding operations, or additional tensor transformation operations.

In some embodiments, the Relu node 953 may provide activation data to both the MaxPool node 954 and the second convolution node 956. Such operation may enable branching execution within the neural network execution graph 950.

In some embodiments, the MaxPool node 954 may perform a pooling operation using a kernel size of 2×2 and a stride value of 2 to generate pooled output data having dimensions of 3×16×16. Execution of the MaxPool node 954 may be performed using an Arithmetic Unit 962 configured to perform pooling operations, reduction operations, or tensor aggregation operations.

In some embodiments, the second convolution node 956 may concurrently perform a convolution operation using activation data generated by the Relu node 953. The second convolution node 956 may generate output activation data having dimensions of 3×16×16. In some embodiments, execution of the second convolution node 956 and execution of the MaxPool node 954 may occur concurrently based on availability of independent hardware resources and satisfaction of execution dependency conditions.

In some embodiments, output data generated by the MaxPool node 954 and the second convolution node 956 may be provided to the Concat & Reshape node 955. The Concat & Reshape node 955 may concatenate tensor data generated by multiple upstream operations and may further perform tensor reshaping operations to generate tensor data having dimensions of 1×1536.

In some embodiments, execution of the Concat & Reshape node 955 may be coordinated using a DMA Engine / Data Swizzler 963. The DMA Engine / Data Swizzler 963 may perform memory transfer operations, tensor layout transformation operations, tensor reordering operations, data swizzling operations, or buffer movement operations.

In some embodiments, the reshaped tensor data generated by the Concat & Reshape node 955 may be provided to the Gemm node 957. The Gemm node 957 may perform a generalized matrix multiplication operation using matrix B having dimensions of 10×1536 to generate output data having dimensions of 1×10.

In some embodiments, execution of the Gemm node 957 may be performed using a Matrix × Matrix Accelerator 964 configured to accelerate dense matrix multiplication operations, tensor multiplication operations, or neural network inference operations.

In some embodiments, output data generated by the Gemm node 957 may be provided to the SoftMax node 958. The SoftMax node 958 may perform a normalization operation configured to generate probability values associated with classification outputs. Execution of the SoftMax node 958 may be performed using an Arithmetic Unit 965 configured to perform normalization operations, exponentiation operations, accumulation operations, or additional arithmetic operations.

In some embodiments, output data generated by the SoftMax node 958 may be provided to the Output node 959. The Output node 959 may correspond to classification output data, inference output data, tensor output data, or additional neural network execution results.

In some embodiments, the neural network execution graph 950 may illustrate mapping of graph operations to heterogeneous hardware resources within a dataflow processing architecture. Such mapping may enable overlapping execution of independent graph operations, increased hardware utilization, reduced execution latency, improved throughput, and asynchronous execution of neural network workloads.

In some embodiments, execution scheduling associated with the neural network execution graph 950 may be performed using data-driven scheduling mechanisms, dependency tracking mechanisms, token-based execution mechanisms, counter-based scheduling mechanisms, or additional hardware scheduling mechanisms configured to initiate execution based on availability of required input data.

### 10. Tile-Based | Partial-Data Execution Model

FIG. 10 illustrates an example embodiment of a Tile-Based Execution Model in which operations are performed on subsets of data rather than entire data structures. An Input Tensor 1001 may be partitioned into a plurality of Execution Tiles 1002.

In some embodiments, a Partial-Data Execution Unit 1003 may process one or more Execution Tiles 1002 as soon as a sufficient subset of input data is available. A Tile Processing Window 1004 may define a region of the Input Tensor 1001 that is currently being processed.

Execution Tiles 1002 may be processed sequentially or in parallel, forming a Tile Stream 1005. As each Execution Tile 1002 is processed, Intermediate Tile Outputs 1006 may be generated and made available for subsequent operations.

A Tile Dependency Boundary 1007 may define the amount of data required before execution of a downstream operation may begin. In some embodiments, a Sliding Window Region 1008 may be used for operations such as convolution, where overlapping data regions are processed.

A Tile Scheduling Trigger 1009 may indicate when a Partial-Data Execution Unit 1003 is eligible to begin processing a new Execution Tile 1002. Output Tiles 1010 may be produced and stored in memory for use by downstream operations.

In some embodiments, the Tile-Based Execution Model may enable early initiation of computation, reduced memory usage, and improved utilization of compute resources.

### 11. Multi-State Streaming Execution Pipeline

FIGS. 11A-B illustrate an example embodiment of a Multi-Stage Streaming Execution Pipeline in which multiple operations are executed concurrently on different subsets of data. The pipeline may include an Input Data Stream 1101, a DMA Stage 1102, a Convolution Stage 1103, an Activation Stage 1104, and an Output Stage 1105.

In some embodiments, each stage of the pipeline may process a different Execution Tile 1002 (FIG. 10) at a given time. A Pipeline Stage Boundary 1106 may separate stages of the pipeline, and a Concurrent Execution Window 1107 may indicate overlapping execution across stages.

A Tile Progress Indicator 1108 may track progress of each Execution Tile 1002 through the pipeline. A Pipeline Control Interface 1109 may coordinate execution across stages based on data availability and resource conditions. A Dataflow Progression Path 1110 may represent movement of data through the pipeline.

In some embodiments, the DMA Stage 1102 may transfer data into memory, the Convolution Stage 1103 may perform matrix multiplication operations, the Activation Stage 1104 may apply element-wise transformations, and the Output Stage 1105 may store results.

The Multi-Stage Streaming Execution Pipeline may enable continuous operation of the Dataflow Processing Unit 101 by overlapping data movement and computation. Execution of operations may be driven by data availability and may proceed without reliance on a centralized scheduling mechanism.

In some embodiments, the pipeline may be dynamically adjusted based on workload characteristics, resource availability, or configuration parameters.

### 12A-B. Data-Driven Scheduling Readiness Model

FIGS. 12A-B illustrate an example embodiment of a Data-Driven Scheduling Readiness Model configured to determine when an operation is eligible for execution within the Dataflow Processing Unit 101. The model may be implemented by a Data-Driven Scheduler 1201, which may evaluate one or more Execution Readiness Conditions 1204 based on system state.

In some embodiments, the Data-Driven Scheduler 1201 may receive inputs including an Input Data Availability Indicator 1202, an Output Buffer Availability Indicator 1203, and a Resource Availability Indicator 1207. The Input Data Availability Indicator 1202 may represent the amount of data available for consumption by an operation, while the Output Buffer Availability Indicator 1203 may represent available capacity for storing results of the operation.

The Data-Driven Scheduler 1201 may include a Scheduling Decision Logic 1205 configured to evaluate whether one or more Execution Readiness Conditions 1204 are satisfied. The Execution Readiness Conditions 1204 may include conditions such as availability of a threshold quantity of input data, availability of sufficient output buffer space, and availability of a compute resource.

In some embodiments, the Scheduling Decision Logic 1205 may receive event notifications via a Scheduling Event Interface 1209. Such event notifications may correspond to Dataflow Trigger Events 1206, including completion of a data transfer, completion of an operation, or update to a dependency state.

When the Scheduling Decision Logic 1205 determines that an Execution Readiness Condition 1204 is satisfied, the Data-Driven Scheduler 1201 may generate an Operation Trigger Signal 1206 and an Execution Dispatch Signal 1210. The Execution Dispatch Signal 1210 may be transmitted to the Token and Operation Manager 102 to initiate scheduling of the operation.

In some embodiments, the Data-Driven Scheduling Readiness Model may enable execution of operations based on partial data availability, allowing operations to begin before all input data is produced. The model may further enable overlapping execution of multiple operations within a Streaming Execution Pipeline 1101–1110 (FIG. 11).

### 13A-B. Token | Counter-Based Dependency Tracking

FIGS. 13A-B illustrates an example embodiment of a Token and Counter-Based Dependency Tracking system configured to manage dependencies between operations within the Dataflow Processing Unit 101. The system may utilize Tokenized Dependency Indicators 1301, including Tokens 1302 and Counters 1303, to track progress of data production and consumption.

In some embodiments, a Token 1302 may represent a unit of progress associated with an operation, such as production of an Execution Tile 1002 (FIG. 10) or consumption of data from a Producer–Consumer Buffer 803 (FIG. 8A). A Token 1302 may include information identifying a target Counter 1303 and an update value.

The Counter 1303 may represent a quantity associated with a resource or dependency, including data availability, buffer capacity, or operation readiness. The Counter 1303 may be stored in a Counter State Memory 1308, which may be implemented within SRAM.

A Counter Update Logic 1304 may update values of Counters 1303 based on received Tokens 1302. Updates may include incrementing or decrementing counter values to reflect changes in system state. A Threshold Comparator 1305 may compare counter values against predefined thresholds to determine whether a dependency condition has been satisfied.

In some embodiments, a Dependency Tracking Module 1306 may coordinate updates to multiple Counters 1303 and may determine when an operation is eligible for execution. A Token Propagation Interface 1307 may transmit Tokens 1302 between components within the Dataflow Processing Unit 101, enabling propagation of dependency updates.

When a Counter 1303 satisfies a threshold condition, a Trigger Condition Generator 1309 may generate a Dependency Resolution Signal 1310. The Dependency Resolution Signal 1310 may be transmitted to the Token and Operation Manager 102 to initiate scheduling of an operation.

In some embodiments, the Token and Counter-Based Dependency Tracking system may enable fine-grained tracking of dependencies at a granularity corresponding to Execution Tiles 1002. The system may support concurrent execution of multiple operations by allowing independent tracking of dependencies for each operation.

### 14A-B. Work Queue | Operation Dispatch Model

FIGS. 14A-B illustrates an example embodiment of a Work Queue and Operation Dispatch Model configured to manage scheduling and execution of operations within the Dataflow Processing Unit 101. The model may include an Operation Dispatch Structure 1401 that stores operations eligible for execution.

In some embodiments, the Operation Dispatch Structure 1401 may include one or more Operation Queues 1402, each associated with a specific hardware resource or controller. Each Operation Queue 1402 may include one or more Queue Entries 1403 representing operations that are ready for execution.

An Enqueue Logic 1404 may add Queue Entries 1403 to an Operation Queue 1402 when an operation becomes eligible for execution. Eligibility may be determined based on Dependency Resolution Signals 1310 (FIGS. 13A-B) generated by the Token and Operation Manager 102.

A Dequeue Logic 1405 may remove Queue Entries 1403 from an Operation Queue 1402 when a corresponding hardware resource becomes available. The Dequeue Logic 1405 may coordinate with hardware controllers to ensure that operations are dispatched when resources are ready.

In some embodiments, the Operation Dispatch Structure 1401 may include a Linked List Pointer 1406 for linking Queue Entries 1403. A Queue Head Pointer 1407 may identify the next Queue Entry 1403 to be dispatched, and a Queue Tail Pointer 1408 may identify the most recently added Queue Entry 1403.

An Operation Execution Signal 1409 may be generated when an operation is dispatched to a hardware controller. The Operation Execution Signal 1409 may be transmitted via a Dispatch Interface 1410 to initiate execution of the operation.

In some embodiments, multiple Operation Queues 1402 may operate concurrently, enabling parallel scheduling of operations across multiple hardware resources. The Work Queue and Operation Dispatch Model may support dynamic scheduling, allowing operations to be dispatched based on resource availability and execution readiness.

In some embodiments, the Operation Dispatch Structure 1401 may be implemented using memory-resident data structures stored in SRAM, enabling scalability based on available memory capacity. The model may further support efficient reuse of queue structures and may enable aggregation of multiple operation instances.

### 15A-B. Method for Performing Tile-Based Execution of a NN Graph

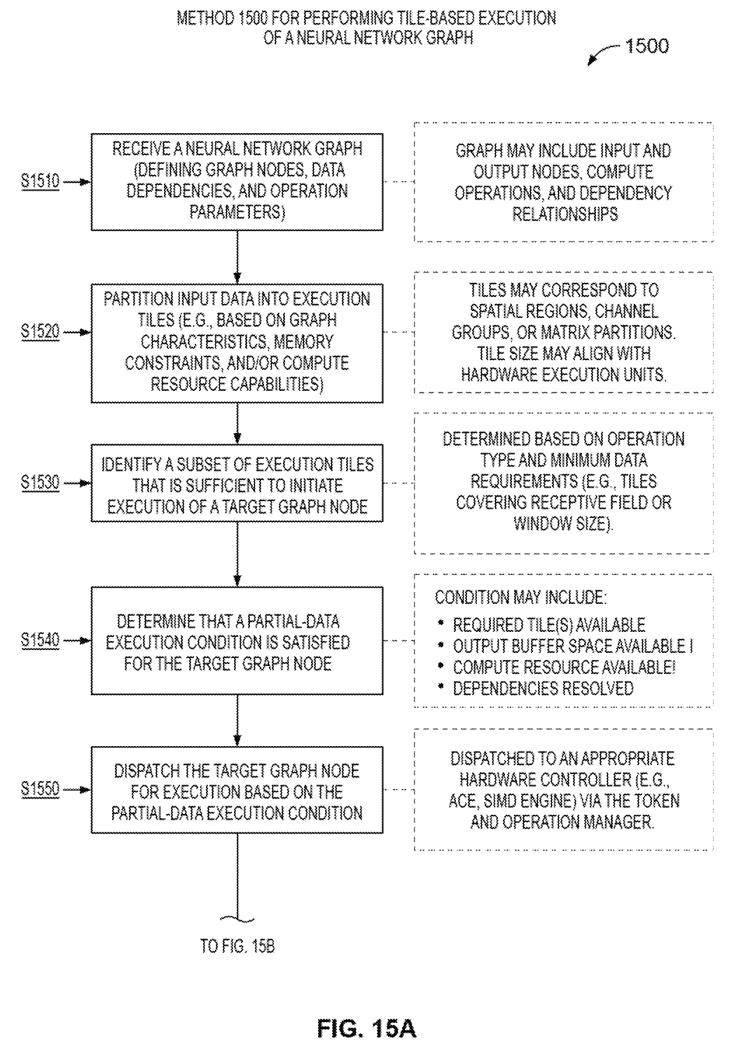

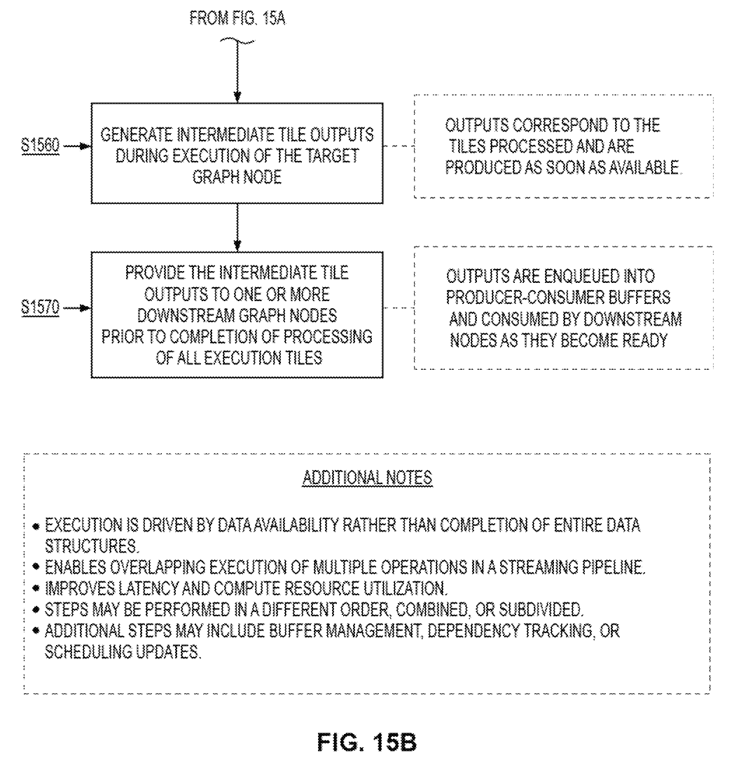

As shown in FIGS. 15A-B, the method 1500 for performing tile-based execution of a neural network graph using partial-data availability includes receiving a neural network graph S1510, partitioning input data into execution tiles S1520, identifying a subset of execution tiles sufficient to initiate execution of a target graph node S1530, determining that a partial-data execution condition is satisfied S1540, dispatching the target graph node for execution based on the partial-data execution condition S1550, generating intermediate tile outputs S1560, and providing the intermediate tile outputs to one or more downstream graph nodes prior to completion of processing of all execution tiles S1570.

In some embodiments, method 1500 may be performed by a dataflow processing unit, such as Dataflow Processing Unit 101, in which execution of operations is driven by data availability rather than completion of entire data structures. The method 1500 may enable fine-grained execution of neural network operations at a granularity corresponding to execution tiles, thereby improving latency and compute resource utilization.

In some embodiments, partitioning of input data into execution tiles may be performed during a compilation or configuration phase and may depend on characteristics of the neural network graph, memory constraints, and compute resource capabilities. Execution tiles may correspond to spatial regions, channel groupings, or matrix partitions, and may be sized to align with hardware execution units.

In some embodiments, partial-data execution may allow a downstream operation to begin processing based on availability of a subset of required input data, rather than waiting for completion of all upstream data production. Such operation may be particularly advantageous for convolution operations, sliding window operations, or other operations that operate on localized regions of data.

In some embodiments, generation and propagation of intermediate tile outputs may be coordinated using Producer–Consumer Buffers and dataflow scheduling mechanisms, enabling overlapping execution across multiple graph nodes. The method 1500 may thereby support a streaming execution pipeline in which multiple operations execute concurrently on different execution tiles.

In some embodiments, the steps of method 1500 may be performed in a different order, combined, or subdivided into additional steps. Additional steps may be included to support specific implementations, including buffer management, dependency tracking, or scheduling decisions.

### 15.1 Receiving NN Graph and Data Partitioning

S1510, which includes receiving a neural network graph and partitioning input data associated with one or more operations of the neural network graph into a plurality of execution tiles, may function to initialize a dataflow execution framework that enables partial-data execution and fine-grained scheduling of operations. In a preferred embodiment, receiving the neural network graph includes obtaining a graph representation comprising a plurality of operations, data dependencies between operations, and metadata defining tensor shapes, tiling constraints, and execution parameters. In such preferred embodiment, partitioning the input data includes decomposing one or more tensors into execution tiles based on tiling policies associated with the operations. However, in alternative embodiments, partitioning may be dynamically determined at runtime based on resource availability, data locality, or performance optimization criteria.

In some embodiments, receiving the neural network graph may include parsing a graph description stored in memory or provided by a host system. The graph description may include nodes representing operations and edges representing data dependencies. Each operation may include attributes such as operation type, input tensor dimensions, output tensor dimensions, stride parameters, kernel parameters, and scheduling hints. The graph description may be stored in a graph metadata structure within memory and accessed by a token and operation manager.

In some embodiments, partitioning the input data may include generating a tiling configuration for one or more tensors associated with the neural network graph. The tiling configuration may define tile dimensions, tile overlap regions, and tile traversal order. For example, partitioning may include dividing a multi-dimensional tensor into a set of spatial tiles, channel tiles, or hybrid tiles based on characteristics of the target operation, such as convolutional or matrix operations.

In some embodiments, partitioning the input data may include generating execution tiles corresponding to a tile processing window of an operation. The tile processing window may define a minimum subset of input data required to compute at least a portion of an output tensor. For convolutional operations, the tile processing window may include overlapping regions to account for kernel size and stride. For matrix operations, the tile processing window may correspond to sub-blocks of matrices.

In some embodiments, partitioning may include generating memory address mappings for each execution tile. The memory address mappings may identify locations of tile data in memory, including non-contiguous regions. Address mappings may be stored in metadata structures and may be used by a buffer access cluster to perform data movement operations, including scatter and gather operations.

In some embodiments, partitioning may include assigning identifiers to execution tiles and associating the identifiers with corresponding operations and dependencies. Tile identifiers may be used by scheduling logic to track availability and readiness of data at a tile granularity.

In some embodiments, partitioning may include generating dependency metadata at a tile level. Dependency metadata may define relationships between execution tiles of different operations. For example, a tile of a downstream operation may depend on one or more tiles of an upstream operation. The dependency metadata may be stored in a dependency tracking structure.

In some embodiments, partitioning may include storing execution tiles or references to execution tiles in memory structures such as input buffers or producer–consumer buffers. Data may be preloaded into memory or streamed from a host system. Partitioning may be performed prior to execution or incrementally as data becomes available.

In some embodiments, partitioning may include configuring buffer access parameters associated with execution tiles, including stride, offset, and access patterns. Such parameters may be used by data movement engines to efficiently retrieve and store tile data.

In some embodiments, partitioning the input data into the plurality of execution tiles may enable downstream steps to evaluate partial-data execution conditions, schedule operations based on availability of subsets of data, and perform execution in a streaming and asynchronous manner.

In some embodiments, receiving the neural network graph and partitioning the input data as described may represent a preparatory stage that transforms a static computation graph into a tile-based execution model suitable for data-driven scheduling and hardware-accelerated execution within a dataflow processing unit.

### 15.2 Identifying Tiles for Executing Operations

S1520, which includes identifying, for a target operation, a subset of execution tiles required to initiate execution of the target operation, may function to determine a minimum data sufficiency condition that enables partial execution of the target operation without requiring availability of a complete input tensor. In a preferred embodiment, identifying the subset of execution tiles includes determining a tile processing window associated with the target operation and selecting execution tiles that satisfy the tile processing window. In such preferred embodiment, the tile processing window corresponds to a minimum set of input elements required to compute at least one output tile of the target operation. However, in alternative embodiments, the subset of execution tiles may be determined based on adaptive policies, dynamic dependency resolution, or hardware-specific execution constraints.

In some embodiments, identifying the subset of execution tiles may include retrieving operation metadata associated with the target operation from a graph metadata structure. The operation metadata may include parameters such as kernel size, stride, padding, dilation, and channel grouping, which define how input data contributes to output data. Based on the operation metadata, the system may compute a tile dependency footprint that specifies which execution tiles are required to compute a corresponding output tile.

In some embodiments, identifying the subset of execution tiles may include evaluating spatial and/or channel dependencies between execution tiles. For convolutional operations, the subset of execution tiles may include a set of spatially adjacent tiles that collectively satisfy a convolutional receptive field. For matrix operations, the subset may include row and column tile segments required to perform a partial matrix multiplication. For element-wise operations, the subset may include a one-to-one mapping between input and output tiles.

In some embodiments, identifying the subset of execution tiles may include consulting a tile dependency graph that defines relationships between execution tiles across operations. The tile dependency graph may be generated during partitioning and may include mappings between upstream tile identifiers and downstream tile identifiers. The system may traverse the tile dependency graph to determine which upstream execution tiles are required for a given downstream computation.

In some embodiments, identifying the subset of execution tiles may include evaluating availability indicators associated with execution tiles. Availability indicators may be represented as resource counters, tokenized dependency indicators, or buffer state indicators. The system may determine whether a sufficient subset of execution tiles has been produced by one or more upstream operations.

In some embodiments, identifying the subset of execution tiles may include handling non-contiguous data layouts. The required execution tiles may reside in disjoint memory regions due to tiling, padding, or data layout transformations. The system may generate or retrieve address mappings that define how to assemble the subset of execution tiles using gather operations.

In some embodiments, identifying the subset of execution tiles may include supporting overlapping execution windows. For example, adjacent tile processing windows may share overlapping input regions. The system may reuse previously identified execution tiles to reduce redundant data movement and improve efficiency.

In some embodiments, identifying the subset of execution tiles may include selecting tiles according to a traversal strategy, such as row-major, column-major, or space-filling curves. The traversal strategy may be optimized for memory locality, cache utilization, or compute resource characteristics.

In some embodiments, identifying the subset of execution tiles may include generating a readiness descriptor for the target operation. The readiness descriptor may include identifiers of required execution tiles, memory addresses, buffer locations, and dependency status. The readiness descriptor may be stored in an operation queue or metadata structure for subsequent evaluation in scheduling.

In some embodiments, identifying the subset of execution tiles required to initiate execution of the target operation may enable fine-grained, data-driven execution in which operations can be triggered as soon as minimal data dependencies are satisfied, thereby reducing latency and improving utilization of compute resources.

In some embodiments, identifying the subset of execution tiles as described may represent a key enabler of partial-data execution by transforming operation-level dependencies into tile-level readiness conditions that can be evaluated dynamically during runtime.

### 15.3 Determining Execution Condition Satisfaction

S1530, which includes determining that a partial-data execution condition is satisfied based on availability of the subset of execution tiles, may function to evaluate whether sufficient data and system resources exist to initiate execution of the target operation without requiring full completion of upstream data production. In a preferred embodiment, determining that the partial-data execution condition is satisfied includes evaluating a multi-dimensional readiness condition that incorporates data availability, buffer state, and compute resource availability. In such preferred embodiment, execution may be triggered when a minimum subset of execution tiles required for a tile processing window is available and when execution resources are ready to accept the operation. However, in alternative embodiments, the partial-data execution condition may include additional constraints, such as ordering policies, priority policies, or power and thermal constraints.

In some embodiments, determining that the partial-data execution condition is satisfied may include evaluating one or more resource counters associated with execution tiles. Resource counters may track production of execution tiles by upstream operations and may be incremented in response to tokenized dependency indicators. The system may compare resource counter values against threshold values corresponding to tile readiness requirements for the target operation.

In some embodiments, determining that the partial-data execution condition is satisfied may include evaluating buffer state indicators associated with memory structures storing execution tiles. Buffer state indicators may include data availability counters, write pointers, read pointers, and buffer capacity indicators. The system may verify that required execution tiles are present in accessible buffer regions and that sufficient buffer capacity exists for storing output data generated by execution.

In some embodiments, determining that the partial-data execution condition is satisfied may include verifying completeness of a tile processing window. For example, for a convolutional operation, the system may confirm that all tiles within a receptive field region required to compute an output tile are available. For matrix operations, the system may confirm that a required subset of matrix rows and columns is available to perform a partial computation.

In some embodiments, determining that the partial-data execution condition is satisfied may include evaluating compute resource readiness. Compute resource readiness may include availability of one or more compute engines capable of executing the target operation, such as analog compute engines or SIMD engines. The system may query hardware controllers to determine whether execution pipelines are idle or capable of accepting new operation commands.

In some embodiments, determining that the partial-data execution condition is satisfied may include evaluating dependency constraints beyond immediate data availability. For example, ordering constraints between operations may require that certain operations complete before others can begin, even if required execution tiles are available. The system may enforce such constraints through dependency tracking structures.

In some embodiments, determining that the partial-data execution condition is satisfied may include evaluating dynamic scheduling policies. Scheduling policies may prioritize certain operations or execution tiles based on latency sensitivity, throughput optimization, or quality-of-service requirements. The system may incorporate such policies into readiness evaluation.

In some embodiments, determining that the partial-data execution condition is satisfied may include evaluating data locality considerations. For example, execution may be deferred if required execution tiles are located in memory regions that would incur high access latency, or execution may be prioritized for tiles located in low-latency memory.

In some embodiments, determining that the partial-data execution condition is satisfied may include generating a readiness signal or flag associated with the target operation. The readiness signal may indicate that execution may proceed and may be used to enqueue the target operation into an operation queue for dispatch.

In some embodiments, determining that the partial-data execution condition is satisfied may include supporting speculative execution. For example, execution may be initiated based on predicted availability of additional execution tiles, with mechanisms to handle correction or rollback if predictions are inaccurate.

In some embodiments, determining that the partial-data execution condition is satisfied as described may enable asynchronous and overlapping execution across operations, thereby improving pipeline utilization and reducing latency compared to execution models that require complete data availability prior to execution.

In some embodiments, determining that the partial-data execution condition is satisfied may represent a critical decision point within a data-driven execution model, enabling transition from data accumulation to active computation based on fine-grained readiness conditions.

### 15.4 Partial-Data Execution by Subset of Tiles

S1540, which includes determining that a partial-data execution condition is satisfied, may function to evaluate whether a target graph node is eligible to begin execution based on availability of less than a complete set of input data. In a preferred embodiment, the partial-data execution condition is satisfied when a subset of execution tiles corresponding to a tile processing window of the target graph node is available in memory and when sufficient output buffer capacity exists to store results of execution. However, in alternative embodiments, the partial-data execution condition may be defined based on one or more dynamic thresholds, dependency indicators, or resource availability metrics.

In some embodiments, determining that the partial-data execution condition is satisfied may include evaluating one or more resource counters associated with data availability and buffer capacity. The resource counters may be updated based on Tokenized Dependency Indicators generated in response to completion of data transfers or upstream operations. A threshold evaluation logic may compare values of the resource counters against predefined thresholds corresponding to minimum data requirements for execution of the target graph node.

In some embodiments, the partial-data execution condition may be defined as a multi-dimensional readiness condition that simultaneously considers input data availability, output buffer availability, and compute resource availability. For example, the condition may require that (i) a minimum number of execution tiles for each required input operand is available, (ii) a producer–consumer buffer associated with the target graph node has sufficient free capacity to receive output tiles, and (iii) a hardware controller capable of executing the target graph node is available.

In some embodiments, determining satisfaction of the partial-data execution condition may further include evaluating spatial and temporal alignment of execution tiles. For operations such as convolution, the subset of execution tiles may be required to align with a sliding window region that defines a valid computation boundary. The determination may therefore include verifying that all data elements within the sliding window region for at least one output tile are available.

In some embodiments, the partial-data execution condition may be evaluated continuously or in response to dataflow trigger events, such as completion of a memory access operation or consumption of buffered data. The evaluation may be performed by hardware logic within a token and operation manager without requiring intervention from a centralized processor.

In some embodiments, the partial-data execution condition may be dynamically adjusted during execution based on observed system behavior, including data arrival rates, buffer utilization, or compute resource contention. For example, the minimum number of execution tiles required for execution may be increased or decreased to optimize throughput or latency.

In some embodiments, determining that the partial-data execution condition is satisfied may enable initiation of execution prior to completion of upstream operations, thereby allowing overlapping execution across multiple graph nodes. The determination may represent a departure from conventional execution models that require full tensor availability prior to execution and may enable fine-grained, data-driven scheduling within the dataflow processing unit.

### 15.5 Dispatching Target Node for Execution

S1550, which includes dispatching the target graph node for execution based on the partial-data execution condition, may function to initiate execution of an operation using a subset of available input data without waiting for completion of all upstream data production. In a preferred embodiment, dispatching includes issuing an operation command from a token and operation manager to a hardware controller associated with the target graph node upon satisfaction of the partial-data execution condition. However, in alternative embodiments, dispatching may include inserting the operation into one or more execution queues, reserving hardware resources, or triggering execution through event-driven signaling mechanisms.

In some embodiments, dispatching the target graph node may include selecting a hardware resource from a heterogeneous compute domain based on operation type and resource availability. For example, a convolution operation may be dispatched to an analog compute engine controller, while an activation operation may be dispatched to a SIMD controller. The dispatch decision may be based on metadata associated with the target graph node stored in an operation configuration structure.

In some embodiments, dispatching may include constructing an operation command that identifies (i) input buffer locations corresponding to the subset of execution tiles, (ii) output buffer locations for storing generated output tiles, and (iii) operation parameters, such as kernel size, stride, or activation type. The operation command may be transmitted via an operation bus to the selected hardware controller.

In some embodiments, dispatching based on the partial-data execution condition may include issuing multiple dispatch events for a single graph node, where each dispatch event corresponds to a different subset of execution tiles. Such repeated dispatching may enable streaming execution in which the same operation is executed iteratively over successive subsets of data, rather than being executed once over an entire tensor.

In some embodiments, dispatching may further include reserving buffer regions within a producer–consumer buffer for storing output tiles. The reservation may be coordinated with buffer state tracking to ensure that sufficient capacity is available for output data and to prevent overwriting of unconsumed data.

In some embodiments, dispatching may be performed in a fully hardware-driven manner without intervention from a centralized processor. A token and operation manager may detect satisfaction of the partial-data execution condition, enqueue the operation into an operation queue associated with a hardware controller, and trigger dispatch when the hardware controller becomes available.

In some embodiments, dispatching the target graph node based on the partial-data execution condition may enable overlapping execution across multiple graph nodes and across multiple subsets of execution tiles. The dispatching mechanism may therefore support a streaming execution pipeline in which multiple operations execute concurrently on different portions of data, thereby improving throughput and reducing latency relative to conventional execution models.

### 15.6 Generating Intermediate Tile Outputs

S1560, which includes generating one or more intermediate tile outputs, may function to produce output data corresponding to execution of the target graph node on the subset of execution tiles without requiring completion of processing of all execution tiles associated with the target graph node. In a preferred embodiment, generating the one or more intermediate tile outputs includes computing output values corresponding to a portion of an output tensor using the subset of execution tiles as input. However, in alternative embodiments, intermediate tile outputs may include partially computed values, accumulated values, or transformed data that may require further processing.

In some embodiments, generation of the one or more intermediate tile outputs may be performed by a hardware controller, such as an analog compute engine controller or a SIMD controller, based on operation parameters specified in an operation configuration structure. The hardware controller may retrieve input data corresponding to the subset of execution tiles from memory via a buffer access cluster and may perform computation on the retrieved data to produce output values.

In some embodiments, the one or more intermediate tile outputs may correspond to a spatially localized region of the output tensor, such as an output tile that aligns with a tile processing window. For example, in a convolution operation, the intermediate tile outputs may correspond to convolution results computed for a subset of spatial positions defined by the subset of execution tiles.

In some embodiments, generation of the one or more intermediate tile outputs may include performing in-stream operations during data movement. For example, arithmetic transformations, activation functions, or accumulation operations may be applied to data as the data is transferred between memory and compute resources. Such in-stream operations may reduce the need for separate scheduling of additional operations and may reduce memory traffic.

In some embodiments, generation of the one or more intermediate tile outputs may include accumulation of partial results across multiple execution tiles. For example, when an operation involves multiple input channels or partial sums, intermediate results may be accumulated over multiple iterations to produce a final output tile. The accumulation may be performed within a compute resource or within a memory structure using read-modify-write operations.

In some embodiments, the one or more intermediate tile outputs may be written to a producer–consumer buffer in memory, where the buffer may be associated with one or more downstream graph nodes. Writing the intermediate tile outputs may include updating buffer state information, including write pointers and buffer capacity indicators.

In some embodiments, generation of the one or more intermediate tile outputs may be performed concurrently with continued processing of additional execution tiles for the target graph node. Such concurrent generation may enable a streaming execution pipeline in which multiple subsets of execution tiles are processed in an overlapped manner.

In some embodiments, generation of the one or more intermediate tile outputs may enable downstream graph nodes to begin execution prior to completion of processing of all execution tiles for the target graph node, thereby supporting fine-grained dataflow execution and improving overall system throughput.

### 15.7 Enabling Intermediate Tile Output Availability

S1570, which includes making the one or more intermediate tile outputs available to one or more downstream graph nodes prior to completion of processing of all execution tiles, may function to enable early consumption of output data by downstream operations in a neural network graph. In a preferred embodiment, making the one or more intermediate tile outputs available includes writing the intermediate tile outputs to a producer–consumer buffer and updating buffer state information to indicate availability of the intermediate tile outputs for consumption. However, in alternative embodiments, availability may be indicated through token generation, counter updates, or direct signaling to downstream hardware controllers.

In some embodiments, making the one or more intermediate tile outputs available may include writing the intermediate tile outputs into a designated region of a producer–consumer buffer associated with one or more downstream graph nodes. The write operation may update a write pointer and may increment a buffer availability indicator, thereby reflecting that additional data is available for consumption.

In some embodiments, making the one or more intermediate tile outputs available may further include generating one or more Tokenized Dependency Indicators corresponding to production of the intermediate tile outputs. The tokens may be propagated to a token and operation manager, which may update resource counters associated with downstream graph nodes. The updated resource counters may be used to evaluate execution readiness conditions for the downstream graph nodes.

In some embodiments, availability of the intermediate tile outputs may be defined at a granularity corresponding to execution tiles, such that each generated output tile may independently trigger readiness evaluation for downstream operations. This fine-grained availability model may enable downstream graph nodes to begin execution upon receipt of a sufficient subset of required input data, rather than waiting for completion of all output tiles from the upstream graph node.

In some embodiments, making the one or more intermediate tile outputs available may include associating metadata with each output tile, where the metadata may indicate spatial position, channel index, or dependency relationships. The metadata may be used by downstream operations to correctly assemble input data and to determine when sufficient data is available for execution.

In some embodiments, making the one or more intermediate tile outputs available may be performed concurrently with continued generation of additional output tiles for the target graph node. Such concurrent availability may enable overlapping execution across multiple graph nodes, thereby forming a streaming execution pipeline in which data continuously flows through successive stages of computation.

In some embodiments, making the one or more intermediate tile outputs available prior to completion of processing of all execution tiles may represent a departure from conventional execution models that require full tensor completion before downstream processing begins. The approach may enable reduced latency, improved throughput, and increased utilization of compute resources by allowing downstream graph nodes to execute in a data-driven and asynchronous manner.

### 16. Method for Performing Asynchronous Execution of NN Operations

As shown in FIGS. 16A-B, the method 1600 for performing asynchronous execution of neural network operations using producer–consumer buffering includes allocating a producer–consumer buffer S1610, writing data corresponding to a first subset of an input tensor into the producer–consumer buffer S1620, updating a buffer state indicator to reflect availability of the data S1630, determining that a sufficient amount of data is available to satisfy a consumption condition for a consumer operation S1640, initiating execution of the consumer operation based on the consumption condition S1650, and reading data from the producer–consumer buffer concurrently with continued writing of additional data S1660.

In some embodiments, method 1600 may be performed by a dataflow processing unit, such as Dataflow Processing Unit 101, in which execution of operations is decoupled through use of memory-resident buffers. The method 1600 may enable asynchronous execution between producer operations and consumer operations, such that production and consumption of data may proceed independently and concurrently.

In some embodiments, the producer–consumer buffer may serve as a decoupling mechanism that separates timing of data production from timing of data consumption. Such decoupling may allow a producer operation to continue generating data without stalling for a consumer operation, and may allow the consumer operation to begin execution as soon as sufficient data becomes available.

In some embodiments, the producer–consumer buffer may be implemented as a circular buffer, line buffer, or other buffer structure stored in memory, such as SRAM. The buffer may include state indicators, such as read pointers, write pointers, and buffer capacity indicators, which may be used to track data availability and buffer utilization.

In some embodiments, the method 1600 may enable fine-grained, tile-level data exchange between operations, where subsets of data may be produced and consumed incrementally. Such operation may enable overlapping execution across multiple graph nodes and may support a streaming execution pipeline.

In some embodiments, determination of when a consumer operation may begin execution may be based on a consumption condition, which may specify a minimum amount of data required for execution. The consumption condition may be evaluated based on buffer state indicators or dependency tracking mechanisms, including token-based or counter-based systems.

In some embodiments, the steps of method 1600 may be performed in a different order, combined, or subdivided into additional steps. Additional steps may include buffer configuration, dependency signaling, or scheduling operations, depending on implementation requirements.

### 16.1 Allocating a Producer-Consumer Buffer

S1610, which includes allocating a producer–consumer buffer, may function to establish a memory-resident data exchange mechanism that enables asynchronous and decoupled execution between a producer operation and a consumer operation of a neural network graph. In a preferred embodiment, allocating the producer–consumer buffer includes reserving a region of on-chip memory and configuring the region as a circular buffer associated with a pair of operations. In such preferred embodiment, the producer–consumer buffer may include metadata defining buffer size, read and write pointer initialization, and access policies. However, in alternative embodiments, the producer–consumer buffer may be implemented as a line buffer, segmented buffer, or multi-producer/multi-consumer buffer supporting concurrent access patterns.

In some embodiments, allocating the producer–consumer buffer may include assigning a memory region within SRAM to serve as the Producer–Consumer Buffer 803. The allocation may be performed during a configuration phase by a runtime software stack or by a hardware controller, such as a token and operation manager, based on a mapping of a neural network graph. The allocation may include defining a base address, buffer capacity, and alignment constraints for efficient memory access.

In some embodiments, allocating the producer–consumer buffer may further include configuring buffer management parameters, including initialization of a write pointer and a read pointer. The write pointer may indicate a location within the buffer for storing newly produced data, and the read pointer may indicate a location for retrieving data for consumption. The configuration may also include defining wrap-around behavior to support circular buffer operation.

In some embodiments, allocating the producer–consumer buffer may include associating the buffer with a specific dataflow channel between a producer operation and a consumer operation. The association may be recorded in a buffer configuration structure stored in memory, enabling hardware components to reference the buffer during execution. The buffer may be configured to store execution tiles or other partial data units produced by the producer operation.

In some embodiments, allocating the producer–consumer buffer may include configuring access policies that allow concurrent read and write operations. Such policies may enable the producer operation to write data into the buffer while the consumer operation reads previously written data, thereby supporting asynchronous execution. The configuration may include defining conditions under which writes may be stalled, such as when the buffer is full, and conditions under which reads may be stalled, such as when insufficient data is available.

In some embodiments, allocating the producer–consumer buffer may include integrating the buffer with dependency tracking mechanisms, such as token-based or counter-based systems. For example, the buffer may be associated with resource counters that track data availability and buffer capacity. Updates to these counters may be triggered by write and read operations performed on the buffer.

In some embodiments, allocation of the producer–consumer buffer may be dynamically adjusted during execution based on workload characteristics. For example, buffer size may be increased or decreased, or buffer regions may be reassigned to different operations to optimize memory utilization and throughput.

In some embodiments, allocating the producer–consumer buffer as described may enable fine-grained, tile-level data exchange between operations and may provide a foundation for asynchronous execution in subsequent steps of method 1600.

### 16.2 Writing to the Producer-Consumer Buffer

S1620, which includes writing data corresponding to a first subset of an input tensor into the producer–consumer buffer, may function to incrementally deposit produced data into a shared buffer structure such that downstream operations may access the data without waiting for completion of full data generation. In a preferred embodiment, writing the data includes transferring one or more execution tiles generated by a producer operation into contiguous or non-contiguous regions of the producer–consumer buffer. In such preferred embodiment, the first subset of the input tensor corresponds to a tile-aligned portion of the data generated by the producer operation. However, in alternative embodiments, the first subset may include partial tiles, strided segments, channel slices, or dynamically sized data segments based on runtime conditions.

In some embodiments, writing the data may be performed by a buffer access cluster, such as Buffer Access Cluster, using one or more buffer accessors configured to execute write commands. The write operation may include computing destination addresses within the producer–consumer buffer using address generation logic, which may account for buffer layout, stride, and circular addressing behavior.

In some embodiments, writing the data may include issuing a write command from a hardware controller associated with the producer operation, such as an analog compute engine controller or a SIMD controller. The write command may specify a source location corresponding to output data of the producer operation and a destination location within the producer–consumer buffer. The data transfer may be performed through a data path interface and coordinated by an SRAM controller.

In some embodiments, writing the data may include updating a write pointer associated with the producer–consumer buffer. The write pointer may be advanced by an amount corresponding to the size of the written data, and may wrap around to a beginning of the buffer when an end of the buffer is reached, thereby supporting circular buffer operation.

In some embodiments, writing the data may include performing in-stream transformations during the write operation. For example, data may be scaled, quantized, normalized, or otherwise transformed as the data is written into the buffer. Such in-stream operations may reduce the need for additional compute operations and may improve efficiency of data movement.

In some embodiments, writing the data may include generating one or more tokenized dependency indicators corresponding to completion of the write operation. The tokens may indicate that a portion of data is now available for consumption and may be used to update resource counters associated with downstream operations.

In some embodiments, writing the data may include handling boundary conditions associated with execution tiles, such as padding regions or overlapping regions. The write operation may ensure that all required data elements for downstream computation are correctly stored in the producer–consumer buffer.

In some embodiments, writing the data corresponding to the first subset of the input tensor may be performed concurrently with continued computation of additional data by the producer operation. Such concurrent operation may enable overlapping data production and consumption, thereby supporting asynchronous execution and improving overall system throughput.

### 16.3 Updating Buffer State Indicator

S1630, which includes updating a buffer state indicator to reflect availability of the data within the producer–consumer buffer, may function to maintain a hardware-readable representation of data availability and buffer utilization for coordinating asynchronous execution between a producer operation and a consumer operation. In a preferred embodiment, updating the buffer state indicator includes updating at least one of a write pointer, a data availability counter, a buffer capacity counter, or a tokenized dependency indicator in response to completion of a write operation to the producer–consumer buffer. However, in alternative embodiments, the buffer state indicator may include a flag, bitmap, descriptor field, queue entry, memory-resident metadata structure, or any other suitable state-tracking mechanism.

In some embodiments, updating the buffer state indicator may include advancing a write pointer associated with the producer–consumer buffer based on an amount of data written during S1620. The write pointer may be advanced by a tile size, slice size, cache line size, burst size, or other write granularity. In circular buffer embodiments, the write pointer may wrap to a starting address or offset when the write pointer reaches an end boundary of the producer–consumer buffer.

In some embodiments, updating the buffer state indicator may include updating a data availability counter that indicates an amount of produced data available for consumption by the consumer operation. For example, the data availability counter may be incremented when an execution tile is written into the producer–consumer buffer. The updated data availability counter may be compared against a consumption threshold associated with the consumer operation to determine whether the consumer operation may begin execution.

In some embodiments, updating the buffer state indicator may additionally or alternatively include updating a buffer capacity counter that indicates remaining writable capacity within the producer–consumer buffer. For example, after the producer operation writes a data tile into the producer–consumer buffer, the buffer capacity counter may be decremented to reflect reduced available capacity. When the consumer operation later reads the data tile, the buffer capacity counter may be incremented to reflect newly available capacity.

In some embodiments, updating the buffer state indicator may include generating or transmitting one or more tokenized dependency indicators to a token and operation manager. A tokenized dependency indicator may identify a resource counter associated with the producer–consumer buffer and may include an update value representing production of data or reduction of buffer capacity. The token and operation manager may use the tokenized dependency indicator to update counter storage in SRAM and evaluate execution readiness conditions for the consumer operation or subsequent producer iterations.

In some embodiments, updating the buffer state indicator may include updating metadata associated with a specific execution tile or group of execution tiles. The metadata may identify a spatial coordinate, channel range, tile index, producer operation identifier, consumer operation identifier, or memory address range associated with the written data. Such metadata may enable a downstream operation to determine whether a required subset of input data is available for a particular tile processing window.

In some embodiments, updating the buffer state indicator may be performed atomically with completion of the write operation. For example, a buffer accessor may commit the written data to SRAM and update one or more state indicators in an indivisible or ordered sequence, thereby preventing a consumer operation from reading stale, incomplete, or partially committed data. In such embodiments, the buffer state indicator may not indicate availability of the data until the write operation is fully committed.

In some embodiments, updating the buffer state indicator may include notifying scheduling logic that the producer–consumer buffer has transitioned from an insufficient-data state to a sufficient-data state. The notification may cause the scheduling logic to evaluate a consumption condition for the consumer operation. In a related embodiment, updating the buffer state indicator may cause a resource counter to cross a threshold that triggers an operation counter update for the consumer operation.

In some embodiments, the buffer state indicator may be maintained in a memory-resident buffer configuration structure associated with the producer–consumer buffer. A buffer access cluster, SRAM controller, or token and operation manager may read or update the buffer configuration structure during data movement and scheduling operations. Storing buffer state in memory-resident structures may allow the number of tracked buffers to scale with memory capacity rather than with a fixed number of dedicated hardware registers.

In some embodiments, updating the buffer state indicator may enable producer and consumer operations to remain decoupled while maintaining correctness. The producer operation may continue writing additional data when buffer capacity remains available, and the consumer operation may begin execution when enough data is present, thereby supporting asynchronous and overlapped execution across the neural network graph.

### 16.4 Determining Sufficient Data Availability

S1640, which includes determining that a sufficient amount of data is available in the producer–consumer buffer to satisfy a consumption condition for the consumer operation, may function to establish a data-driven trigger point at which a consumer operation may begin execution without requiring completion of all data production by the producer operation. In a preferred embodiment, determining that the sufficient amount of data is available includes evaluating one or more buffer state indicators against a predefined consumption threshold associated with the consumer operation. In such preferred embodiment, the consumption threshold may correspond to a minimum number of execution tiles required to compute at least one output tile. However, in alternative embodiments, the consumption condition may be based on dynamic thresholds, multi-dimensional dependency conditions, or adaptive runtime policies.

In some embodiments, determining that the sufficient amount of data is available may include reading a data availability counter associated with the producer–consumer buffer and comparing the data availability counter to a consumption threshold. The data availability counter may represent a number of produced execution tiles, bytes, elements, or other quantifiable data units. The comparison may be performed by hardware logic, such as threshold evaluation logic within a token and operation manager.

In some embodiments, the consumption condition may be defined as a composite condition that includes (i) a data availability requirement, (ii) a buffer alignment or tile boundary requirement, and (iii) a resource availability requirement. For example, the consumer operation may require that a contiguous region of execution tiles corresponding to a tile processing window is available in the buffer and that the tiles align with a sliding window region for a convolution operation.

In some embodiments, determining that the sufficient amount of data is available may further include verifying that the data in the producer–consumer buffer corresponds to a valid and complete subset required for computation. Such verification may include checking metadata associated with stored execution tiles, including tile indices, spatial coordinates, or channel groupings, to ensure that all required data elements for a given computation are present.

In some embodiments, determining that the sufficient amount of data is available may include evaluating tokenized dependency indicators generated during S1630. The tokenized dependency indicators may update one or more resource counters stored in memory. The resource counters may be compared to threshold values associated with the consumer operation, and satisfaction of the threshold values may indicate that the consumption condition is met.

In some embodiments, determining that the sufficient amount of data is available may be performed in response to a dataflow trigger event, such as completion of a write operation to the producer–consumer buffer. In such embodiments, the evaluation may occur asynchronously and may be triggered automatically by hardware logic without intervention from a centralized processor.

In some embodiments, the consumption threshold may be dynamically adjusted based on runtime conditions, including data production rate, buffer utilization, or compute resource contention. For example, the threshold may be lowered to reduce latency or increased to improve throughput efficiency. Such dynamic adjustment may be performed by a runtime system or by adaptive hardware logic.

In some embodiments, determining that the sufficient amount of data is available may enable fine-grained scheduling of the consumer operation at a granularity corresponding to execution tiles or groups of tiles. The determination may therefore allow the consumer operation to begin processing a subset of input data while additional data continues to be produced by the producer operation.

In some embodiments, determining that the sufficient amount of data is available may represent a departure from conventional execution models that require complete availability of input tensors prior to execution. By enabling execution based on partial data availability, the method may support asynchronous and overlapped execution across operations, thereby improving overall system throughput and reducing latency.

### 16.5 Executing Consumer Operation

S1650, which includes initiating execution of the consumer operation based on the consumption condition without requiring completion of all data production by the producer operation, may function to enable asynchronous, data-driven execution of dependent operations in a neural network graph. In a preferred embodiment, initiating execution includes dispatching the consumer operation to a hardware controller immediately upon satisfaction of the consumption condition. In such preferred embodiment, execution may begin using only the subset of data currently available in the producer–consumer buffer. However, in alternative embodiments, initiation may include enqueueing the consumer operation for imminent execution, reserving compute resources, or triggering execution through event-driven signaling mechanisms.

In some embodiments, initiating execution of the consumer operation may include generating an operation dispatch command by a token and operation manager. The operation dispatch command may identify (i) input buffer locations corresponding to the available subset of execution tiles, (ii) output buffer locations for storing results, and (iii) operation parameters required for execution. The operation dispatch command may be transmitted over an operation bus to a hardware controller, such as a SIMD controller or an analog compute engine controller.

In some embodiments, initiating execution may include selecting an available compute resource from a heterogeneous compute domain. The selection may be based on operation type, hardware capability, current utilization, or scheduling priority. For example, a convolution operation may be assigned to an analog compute engine, while an activation operation may be assigned to a SIMD engine.

In some embodiments, initiation of execution may be performed without intervention from a centralized processor. Hardware scheduling logic may automatically detect that the consumption condition is satisfied, enqueue the consumer operation into an operation queue, and trigger execution when the corresponding hardware controller becomes available. Such hardware-driven initiation may reduce scheduling latency and improve responsiveness of the system.

In some embodiments, initiating execution may include reserving resources associated with the consumer operation, including buffer space for output data and internal state within the hardware controller. The reservation may prevent contention with other operations and may ensure that execution proceeds without interruption.

In some embodiments, initiation of execution may be repeated multiple times for a single consumer operation, where each initiation corresponds to a different subset of input data. For example, as additional execution tiles become available in the producer–consumer buffer, the consumer operation may be invoked iteratively to process successive subsets of data. Such repeated initiation may enable streaming execution of the consumer operation.

In some embodiments, initiating execution may include configuring the consumer operation to operate in a partial-data mode, where computation is performed only on the available subset of input data. The hardware controller may maintain internal state to support accumulation of results across multiple invocations until a complete output is generated.

In some embodiments, initiating execution based on the consumption condition may enable overlapping execution between the producer operation and the consumer operation. The producer operation may continue generating additional data while the consumer operation processes previously generated data, thereby improving utilization of compute resources.

In some embodiments, initiating execution without requiring completion of all data production may represent a departure from conventional execution models that enforce strict synchronization barriers. The described approach may enable fine-grained, asynchronous execution across operations, reducing latency and increasing throughput in dataflow processing systems.

### 16.6 Reading the Producer-Consumer Buffer

S1660, which includes reading, by the consumer operation, the data from the producer–consumer buffer concurrently with continued writing of additional data by the producer operation, may function to enable simultaneous data consumption and data production within a shared buffer structure, thereby supporting fully asynchronous and overlapped execution. In a preferred embodiment, reading includes retrieving one or more execution tiles from the producer–consumer buffer using a read pointer while the producer operation continues to write additional execution tiles using a write pointer. In such preferred embodiment, the read and write operations may occur on disjoint regions of the buffer, allowing concurrent access without contention. However, in alternative embodiments, synchronization mechanisms, arbitration logic, or partitioned buffer regions may be used to coordinate concurrent read and write operations.

In some embodiments, reading the data may include issuing a read command from a hardware controller associated with the consumer operation, such as a SIMD controller or an analog compute engine controller. The read command may specify a source address within the producer–consumer buffer corresponding to the subset of execution tiles identified for consumption. The data may be transferred from SRAM through a buffer access cluster to the compute resource executing the consumer operation.

In some embodiments, reading the data concurrently with continued writing may include maintaining separate read and write pointers that advance independently. The read pointer may be advanced based on consumption of data by the consumer operation, while the write pointer may be advanced based on production of data by the producer operation. The separation of pointers may allow the producer and consumer operations to progress independently, provided that buffer capacity constraints and data availability constraints are satisfied.

In some embodiments, reading the data may include verifying that the requested data has been fully written and committed by the producer operation. Such verification may include checking buffer state indicators, metadata flags, or tokenized dependency indicators to ensure that partially written or invalid data is not consumed. In some embodiments, read operations may be gated by threshold conditions that ensure sufficient contiguous data is available for correct computation.

In some embodiments, reading the data may include performing in-stream transformations as the data is retrieved from the producer–consumer buffer. For example, data may be normalized, scaled, or reformatted during transfer to the compute resource. Such in-stream operations may reduce the need for additional compute stages and may improve overall efficiency.

In some embodiments, reading the data may include updating buffer state indicators upon consumption of data. For example, a data availability counter may be decremented, and a buffer capacity counter may be incremented to reflect newly available space in the buffer. Additionally, tokenized dependency indicators may be generated to signal that data has been consumed, which may enable further production by the producer operation or trigger downstream operations.

In some embodiments, reading the data concurrently with continued writing may include handling wrap-around conditions in a circular buffer. The read operation may correctly interpret buffer boundaries and may seamlessly continue reading from a beginning of the buffer when the read pointer reaches an end boundary.

In some embodiments, concurrent reading and writing may be coordinated using memory arbitration logic within an SRAM controller or buffer access cluster. The arbitration logic may ensure fair and efficient access to memory resources while preventing conflicts between read and write operations.

In some embodiments, reading data concurrently with continued writing may enable a streaming execution model in which data continuously flows through the producer–consumer buffer. The consumer operation may process incoming data in a pipelined manner, while the producer operation continues generating additional data, thereby maximizing utilization of compute and memory resources.

In some embodiments, the concurrent read-write behavior described in S1660 may represent a departure from conventional double-buffering or staged execution approaches that require strict separation between production and consumption phases. By allowing simultaneous read and write access to a shared buffer, the method may achieve lower latency, higher throughput, and improved hardware efficiency in dataflow-based processing systems.

### 17. Method for Performing Data-Driven Scheduling Using Tokens

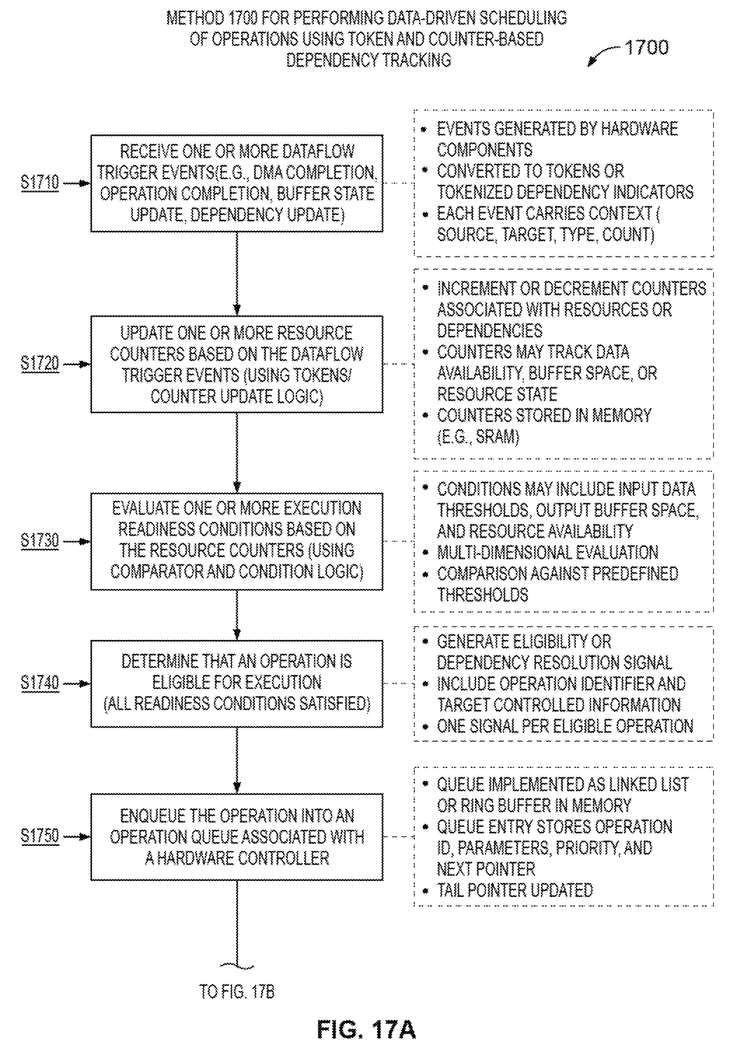

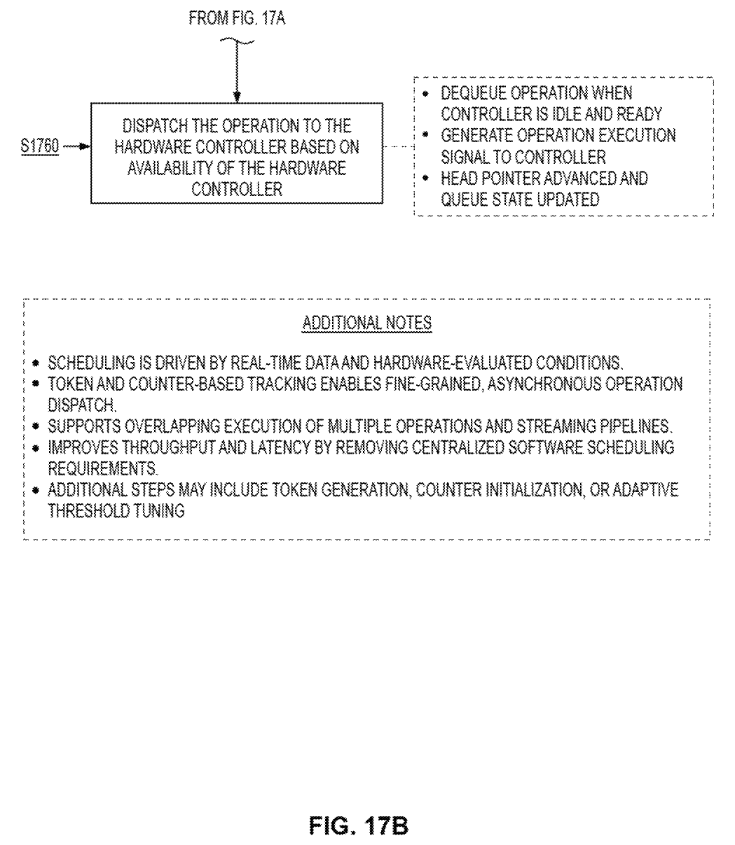

As shown in FIGS. 17A-B, the method 1700 for performing data-driven scheduling of operations using token and counter-based dependency tracking includes receiving one or more dataflow trigger events S1710, updating one or more resource counters based on the dataflow trigger events S1720, evaluating one or more execution readiness conditions based on the resource counters S1730, determining that an operation is eligible for execution S1740, enqueueing the operation into an operation queue associated with a hardware controller S1750, and dispatching the operation to the hardware controller based on availability of the hardware controller S1760.

In some embodiments, method 1700 may be performed by a dataflow processing unit, such as Dataflow Processing Unit 101, in which scheduling of operations is driven by hardware-evaluated dependency conditions rather than software-managed instruction sequencing. The method 1700 may leverage token-based signaling and counter-based state tracking to determine when operations are eligible for execution.

In some embodiments, the dataflow trigger events may correspond to completion of data movement operations, completion of compute operations, updates to buffer states, or other events that affect availability of resources or data. Such events may be converted into tokenized dependency indicators that propagate through the system.

In some embodiments, resource counters may be stored in memory, such as SRAM, and may represent quantities including data availability, buffer capacity, or dependency satisfaction. The counters may be updated based on tokens and may be evaluated against thresholds to determine readiness of operations.

In some embodiments, execution readiness conditions may be defined as multi-dimensional conditions that include input data availability, output buffer capacity, and hardware resource availability. The evaluation of such conditions may be performed using hardware logic without intervention from a centralized processor.

In some embodiments, enqueueing and dispatching operations may be performed using memory-resident queue structures, enabling scalable scheduling of a large number of operations. Operations may be scheduled dynamically based on real-time system state rather than static scheduling decisions.

In some embodiments, the method 1700 may enable fine-grained, asynchronous scheduling of operations at a granularity corresponding to execution tiles or partial data units. The method may therefore support overlapping execution across multiple operations and may improve throughput and latency relative to conventional scheduling approaches.

In some embodiments, the steps of method 1700 may be performed in a different order, combined, or subdivided into additional steps. Additional steps may include token generation, counter initialization, or adaptive threshold tuning, depending on implementation requirements.

### 17.1 Receiving Dataflow Trigger Events

S1710, which includes receiving one or more dataflow trigger events, may function to capture execution progress signals within a dataflow processing unit and convert such signals into actionable inputs for hardware-driven scheduling. In a preferred embodiment, the dataflow trigger events correspond to completion of data movement operations, completion of compute operations, or updates to buffer states within the dataflow processing unit. In such preferred embodiment, each dataflow trigger event may be associated with a tokenized dependency indicator that identifies a resource or operation affected by the event. However, in alternative embodiments, the dataflow trigger events may correspond to timer-based events, interrupt signals, threshold crossings, or other system-generated signals.

In some embodiments, receiving the one or more dataflow trigger events may include receiving event signals from multiple sources within the dataflow processing unit, including a buffer access cluster, one or more hardware controllers, and a memory controller. For example, a buffer accessor may generate a trigger event upon completion of a data transfer, and a compute engine may generate a trigger event upon completion of an operation on a subset of execution tiles.

In some embodiments, each dataflow trigger event may be converted into a tokenized dependency indicator that includes (i) an identifier of a target resource counter or operation counter, (ii) an update value, and (iii) a type of update, such as increment or decrement. The tokenized dependency indicator may be transmitted via a token propagation path to a token and operation manager.

In some embodiments, receiving the one or more dataflow trigger events may include storing the corresponding tokenized dependency indicators in a memory-resident token list structure. The token list structure may support chaining of tokens, enabling propagation of dependency updates across multiple operations. For example, completion of a first operation may generate tokens that update resource counters associated with multiple downstream operations.

In some embodiments, receiving the one or more dataflow trigger events may include performing filtering or aggregation of events. For example, multiple events corresponding to production of execution tiles may be aggregated into a single token update representing a batch of produced data. Such aggregation may reduce overhead associated with processing individual events.

In some embodiments, receiving the one or more dataflow trigger events may be performed asynchronously and may be triggered directly by hardware components without intervention from a centralized processor. The reception of events may be handled by dedicated hardware logic within the token and operation manager, enabling low-latency processing of dependency updates.

In some embodiments, receiving the one or more dataflow trigger events may include associating metadata with each event, where the metadata may identify a source operation, a destination operation, a buffer identifier, or a tile index. The metadata may be used in subsequent steps to determine how the event affects resource counters and execution readiness conditions.

In some embodiments, the dataflow trigger events may represent fine-grained progress of execution at a tile-level granularity. For example, completion of processing of a single execution tile may generate a trigger event, enabling downstream operations to be scheduled based on incremental progress rather than completion of entire operations.

In some embodiments, receiving the one or more dataflow trigger events may enable a fully data-driven scheduling model in which execution decisions are based on real-time system state. The reception and processing of trigger events may therefore form a foundation for updating counters, evaluating readiness conditions, and dispatching operations in subsequent steps of method 1700.

### 17.2 Updating Resource Counters

S1720, which includes updating one or more resource counters based on the dataflow trigger events, may function to maintain a quantitative representation of system state that reflects availability of data, buffer capacity, and dependency satisfaction for operations within a dataflow processing unit. In a preferred embodiment, updating the one or more resource counters includes incrementing or decrementing counter values stored in memory in response to tokenized dependency indicators derived from the dataflow trigger events. In such preferred embodiment, each resource counter may correspond to a specific resource, buffer, or dependency condition associated with one or more operations. However, in alternative embodiments, resource counters may be implemented as distributed registers, hierarchical counters, or composite counters representing aggregated system state.

In some embodiments, updating the one or more resource counters may include accessing a counter storage structure located in memory, such as SRAM, and modifying counter values using a token operation processor. Each tokenized dependency indicator received in S1710 may identify a target counter and an update value, and the update may be applied using arithmetic operations such as increment, decrement, or accumulation.

In some embodiments, the resource counters may represent quantities including (i) number of execution tiles available in a buffer, (ii) available buffer capacity for writing output data, (iii) number of completed upstream operations, or (iv) availability of compute resources. Each resource counter may be associated with a specific dependency condition for a corresponding operation or group of operations.

In some embodiments, updating the one or more resource counters may include performing atomic or ordered updates to ensure correctness in the presence of concurrent updates from multiple dataflow trigger events. For example, hardware logic may enforce serialization of updates to a given counter or may use atomic memory operations to prevent race conditions.

In some embodiments, updating the one or more resource counters may include propagating updates across multiple counters. For example, completion of a data transfer may increment a data availability counter and decrement a buffer capacity counter. Similarly, consumption of data may decrement a data availability counter and increment a buffer capacity counter.

In some embodiments, updating the one or more resource counters may include applying scaling factors or weighting factors to updates. For example, a token corresponding to a large data transfer may increment a counter by a value greater than one, representing multiple execution tiles or data units.

In some embodiments, updating the one or more resource counters may include maintaining separate counters for different dimensions of data, such as spatial dimensions, channel dimensions, or batch dimensions. Such multi-dimensional counters may enable fine-grained tracking of data availability across different portions of an input tensor.

In some embodiments, updating the one or more resource counters may include storing metadata associated with each counter update, such as a source of the update, a timestamp, or a tile identifier. The metadata may be used in subsequent steps to evaluate execution readiness conditions with greater precision.

In some embodiments, updating the one or more resource counters may be performed in a fully hardware-driven manner, without involvement of a centralized processor. The updates may occur in response to incoming tokenized dependency indicators and may be processed by dedicated hardware logic within a token and operation manager.

In some embodiments, the one or more resource counters may be dynamically allocated and scaled based on workload characteristics. For example, additional counters may be instantiated to track dependencies for newly introduced operations, or counters may be reconfigured to track different resources during runtime.

In some embodiments, updating the one or more resource counters may provide a continuously updated representation of system state that may be used in subsequent steps to evaluate execution readiness conditions. The counter-based approach may enable efficient, low-latency scheduling decisions and may support fine-grained, data-driven execution within the dataflow processing unit.

### 17.3 Evaluating Execution Readiness

S1730, which includes evaluating one or more execution readiness conditions based on the one or more resource counters, may function to determine whether sufficient system state conditions are satisfied to permit execution of an operation within a dataflow processing unit. In a preferred embodiment, evaluating the one or more execution readiness conditions includes comparing values of one or more resource counters against predefined threshold values associated with a target operation. In such preferred embodiment, the execution readiness conditions may represent minimum requirements for input data availability, output buffer capacity, and compute resource availability. However, in alternative embodiments, execution readiness conditions may include composite logical conditions, weighted conditions, or dynamically adjusted criteria based on runtime system behavior.

In some embodiments, evaluating the one or more execution readiness conditions may include retrieving counter values from a memory-resident counter storage structure and applying threshold comparison logic. The threshold comparison logic may determine whether each required condition is satisfied, such as whether a data availability counter exceeds a minimum tile threshold or whether a buffer capacity counter indicates sufficient free space.

In some embodiments, the execution readiness conditions may be defined as multi-dimensional conditions that require simultaneous satisfaction of multiple constraints. For example, an operation may require that (i) a minimum number of execution tiles are available for each input operand, (ii) sufficient buffer space exists for storing output tiles, and (iii) a hardware controller capable of executing the operation is available. The evaluation may therefore involve logical conjunctions (e.g., AND conditions) across multiple counters.

In some embodiments, evaluating the one or more execution readiness conditions may include assessing spatial and structural alignment of data. For example, in a convolution operation, the evaluation may verify that a contiguous region of execution tiles corresponding to a sliding window is available and that boundary conditions, such as padding or overlap regions, are satisfied.

In some embodiments, the evaluation may include interpreting metadata associated with resource counters or token updates. The metadata may identify tile indices, channel groups, or spatial coordinates, enabling the evaluation logic to determine whether a complete subset of required data for a computation is available.

In some embodiments, evaluating the one or more execution readiness conditions may be triggered by updates to resource counters. For example, when a counter value changes due to receipt of a tokenized dependency indicator, the evaluation logic may automatically re-evaluate conditions for one or more operations affected by the counter. This event-driven evaluation may enable low-latency scheduling decisions.

In some embodiments, evaluating the one or more execution readiness conditions may be performed by dedicated hardware logic within a token and operation manager. The hardware logic may continuously monitor counter values and perform comparisons without intervention from a centralized processor, thereby reducing scheduling overhead and latency.

In some embodiments, the execution readiness conditions may be dynamically configurable. For example, threshold values may be adjusted based on runtime performance metrics, such as throughput, latency, or resource utilization. Adaptive adjustment of readiness conditions may enable optimization of system performance under varying workloads.

In some embodiments, evaluating the one or more execution readiness conditions may include prioritizing operations based on readiness scores or priority levels. For example, multiple operations may satisfy readiness conditions simultaneously, and the evaluation logic may assign priority based on factors such as dependency depth, resource efficiency, or quality-of-service requirements.

In some embodiments, the evaluation of execution readiness conditions may support fine-grained scheduling at a tile-level granularity, allowing operations to be executed incrementally as data becomes available. This approach may enable overlapping execution across multiple operations and may improve overall system throughput.

In some embodiments, evaluating the one or more execution readiness conditions may represent a key aspect of a data-driven scheduling model, in which execution decisions are based on real-time system state rather than predetermined execution sequences.

### 17.4 Determining Operation Eligibility

S1740, which includes determining that an operation of the neural network graph is eligible for execution based on satisfaction of the one or more execution readiness conditions, may function to convert evaluated readiness states into a concrete scheduling decision for a specific operation. In a preferred embodiment, determining eligibility includes identifying that all required execution readiness conditions for a target operation are satisfied and marking the target operation as ready for execution within a scheduling framework. In such preferred embodiment, the determination may be performed by hardware logic within a token and operation manager without intervention from a centralized processor. However, in alternative embodiments, the determination may involve software-assisted arbitration, priority-based selection, or hybrid hardware-software coordination.

In some embodiments, determining that the operation is eligible for execution may include mapping satisfaction of execution readiness conditions to a specific operation identifier stored in an operation configuration structure. The operation identifier may correspond to a graph node, a tile-level operation instance, or a sub-operation associated with a larger computation. The determination may therefore be performed at a fine granularity corresponding to execution tiles or partial data units.

In some embodiments, the determination of eligibility may include evaluating multiple candidate operations that satisfy readiness conditions and selecting one or more operations based on scheduling policies. Such policies may include priority-based selection, fairness-based selection, or resource-aware selection. For example, an operation associated with a latency-critical path may be prioritized over other operations that are also ready for execution.

In some embodiments, determining that the operation is eligible may include verifying that no conflicting conditions exist that would prevent execution. For example, the determination may include confirming that required output buffer space remains available, that required input data has not been invalidated or overwritten, and that the target hardware controller is not reserved for a higher-priority operation.

In some embodiments, the determination may include associating the eligible operation with a specific execution context, including input buffer addresses, output buffer addresses, and operation parameters. The execution context may be derived from an operation configuration structure stored in memory and may be used in subsequent steps to dispatch the operation.

In some embodiments, determining that the operation is eligible may include generating an internal eligibility signal or flag that indicates readiness for scheduling. The eligibility signal may be stored in a memory-resident structure or may be propagated through hardware logic to trigger enqueueing of the operation into an operation queue.

In some embodiments, the determination may support multiple eligibility states for a given operation. For example, an operation may be partially eligible based on availability of a subset of required data, enabling incremental execution across multiple invocations. In such embodiments, the operation may be marked as eligible multiple times as additional data becomes available.

In some embodiments, determining that the operation is eligible may include updating an operation counter that aggregates readiness conditions. For example, satisfaction of multiple resource counters may cause an operation counter to reach a threshold value, indicating that the operation is ready for execution. This aggregation mechanism may enable efficient evaluation of complex dependency conditions.

In some embodiments, determining that the operation is eligible may be performed in response to a triggering event, such as a counter update or token arrival. The event-driven nature of the determination may enable low-latency scheduling decisions and may reduce reliance on polling-based mechanisms.

In some embodiments, determining eligibility based on real-time system state may enable dynamic and adaptive scheduling of operations, allowing the system to respond to variations in data availability, resource utilization, and execution progress. This approach may improve overall system efficiency compared to static scheduling approaches.

In some embodiments, the determination of operation eligibility may represent a key transition point between dependency evaluation and execution scheduling, enabling subsequent steps to enqueue and dispatch the operation for execution within the dataflow processing unit.

### 17.5 Enqueueing Operations

S1750, which includes enqueueing the operation into an operation queue associated with a hardware controller, may function to stage an eligible operation for execution in a manner that decouples readiness determination from actual execution timing. In a preferred embodiment, enqueueing includes inserting an operation descriptor corresponding to the eligible operation into a memory-resident operation queue associated with a target hardware controller. In such preferred embodiment, the operation queue may be implemented as a linked-list structure, circular queue, or ring buffer stored in SRAM. However, in alternative embodiments, enqueueing may include writing to a hardware FIFO, updating a queue pointer structure, or signaling a controller-local queue.

In some embodiments, enqueueing the operation may include constructing a queue entry that includes (i) an operation identifier, (ii) input buffer addresses, (iii) output buffer addresses, and (iv) operation parameters required for execution. The queue entry may further include metadata such as priority level, tile index, dependency context, or execution flags indicating partial-data execution mode.

In some embodiments, enqueueing may include writing the queue entry into a queue storage structure within SRAM, where the queue storage structure may maintain head and tail pointers to track insertion and removal of entries. The insertion may involve updating a tail pointer to reflect addition of the new queue entry. In circular queue implementations, the tail pointer may wrap to a starting position upon reaching a buffer boundary.

In some embodiments, enqueueing the operation may include associating the operation with a specific hardware controller queue, such as a queue corresponding to an analog compute engine controller, a SIMD controller, or a Copy Controller 110. The association may be determined based on operation type and resource mapping defined in an operation configuration structure.

In some embodiments, enqueueing may include performing priority-based insertion into the operation queue. For example, operations associated with latency-critical paths or higher priority levels may be inserted ahead of lower priority operations. In such embodiments, the queue may support priority sorting, multiple priority levels, or separate queues for different priority classes.

In some embodiments, enqueueing may include updating queue state indicators, such as queue occupancy counters, head/tail pointers, or availability flags. These indicators may be used by scheduling logic to determine when operations are available for dispatch and to prevent overflow conditions.

In some embodiments, enqueueing may include generating a notification or signal to a hardware controller indicating that a new operation is available for execution. The notification may be implemented as an interrupt, event signal, or flag within a controller interface.

In some embodiments, enqueueing the operation may be performed in a fully hardware-driven manner by a token and operation manager. Upon determining that the operation is eligible, the token and operation manager may directly insert the operation into the appropriate queue without software intervention.

In some embodiments, enqueueing may support multiple instances of the same operation corresponding to different subsets of execution tiles. Each instance may be represented as a separate queue entry, enabling streaming execution of the operation across multiple data segments.

In some embodiments, enqueueing the operation may include performing consistency checks to ensure that required resources remain available at the time of insertion. For example, enqueueing may verify that output buffer space has not been exhausted or that the operation has not been invalidated due to upstream changes.

In some embodiments, the use of memory-resident operation queues may enable scalability by allowing the number of queued operations to scale with available memory capacity rather than being limited by fixed hardware queue sizes. The enqueueing process may therefore support large-scale, fine-grained scheduling of operations in complex neural network graphs.

In some embodiments, enqueueing the operation into the operation queue may represent a transitional stage between determining eligibility and actual execution, allowing operations to be scheduled efficiently while accommodating variations in hardware resource availability.

### 17.6 Dispatching Operations

S1760, which includes dispatching the operation to the hardware controller based on availability of the hardware controller, may function to initiate execution of a queued operation by transferring the operation from a staging structure into an active execution context of a compute resource. In a preferred embodiment, dispatching includes dequeuing an operation entry from an operation queue and issuing a corresponding operation command to a hardware controller when the hardware controller indicates availability. In such preferred embodiment, the dispatch may be performed by hardware logic that monitors both queue state and controller readiness. However, in alternative embodiments, dispatching may include speculative dispatch, batched dispatch, or coordinated dispatch across multiple hardware controllers.

In some embodiments, dispatching the operation may include monitoring a controller availability signal associated with a hardware controller, such as an analog compute engine controller or a SIMD controller. The availability signal may indicate that the hardware controller has completed a prior operation and is ready to accept a new operation. Upon detecting availability, the system may dequeue a corresponding operation entry from the operation queue.

In some embodiments, dispatching may include constructing and transmitting an execution command over an operation bus. The execution command may include operation parameters, input buffer addresses, output buffer addresses, execution mode flags (e.g., partial-data execution mode), and any required metadata. The execution command may configure the hardware controller to begin execution using the specified subset of input data.

In some embodiments, dispatching may include transferring operation context information from memory-resident structures, such as an operation configuration structure, into controller-local registers or buffers. This transfer may prepare the hardware controller to execute the operation without further memory lookups, thereby reducing execution latency.

In some embodiments, dispatching the operation may include synchronizing access to shared resources, such as memory interfaces or interconnect bandwidth. For example, dispatching may be gated based on availability of memory bandwidth or absence of contention conditions, ensuring that execution proceeds efficiently without resource conflicts.

In some embodiments, dispatching may include issuing multiple operations in rapid succession to a hardware controller when the controller supports pipelined or queued execution. For example, a hardware controller may accept multiple operation commands and execute them sequentially or in a partially overlapped manner, improving throughput.

In some embodiments, dispatching may include handling partial-data execution contexts, where the operation corresponds to a subset of execution tiles. In such embodiments, the hardware controller may maintain internal state across multiple dispatches to accumulate results or process successive subsets of data. The dispatch mechanism may therefore support repeated invocation of the same operation across multiple data segments.

In some embodiments, dispatching may include generating execution start signals and updating internal tracking structures to indicate that the operation is in progress. Such tracking may include updating operation counters, marking queue entries as consumed, and generating tokens that reflect transition of the operation from a ready state to an active execution state.

In some embodiments, dispatching may be coordinated across multiple hardware controllers to enable parallel execution of multiple operations. For example, different operations may be dispatched simultaneously to different compute resources within a heterogeneous compute domain, enabling concurrent execution of independent graph nodes.

In some embodiments, dispatching may include implementing fairness or quality-of-service policies to ensure balanced utilization of hardware resources. For example, dispatch logic may prevent starvation of lower-priority operations or may allocate execution slots based on predefined scheduling policies.

In some embodiments, dispatching may be performed entirely in hardware without intervention from a centralized processor, enabling low-latency, high-throughput scheduling. The hardware-driven dispatch mechanism may respond immediately to changes in controller availability and queue state, providing efficient utilization of compute resources.

In some embodiments, dispatching the operation based on availability of the hardware controller may represent the final stage of a data-driven scheduling pipeline, translating readiness conditions and queueing decisions into actual execution. This approach may enable highly efficient, asynchronous execution of neural network operations within a dataflow processing unit.

### 18. Method for Operating a Dataflow Processing Unit

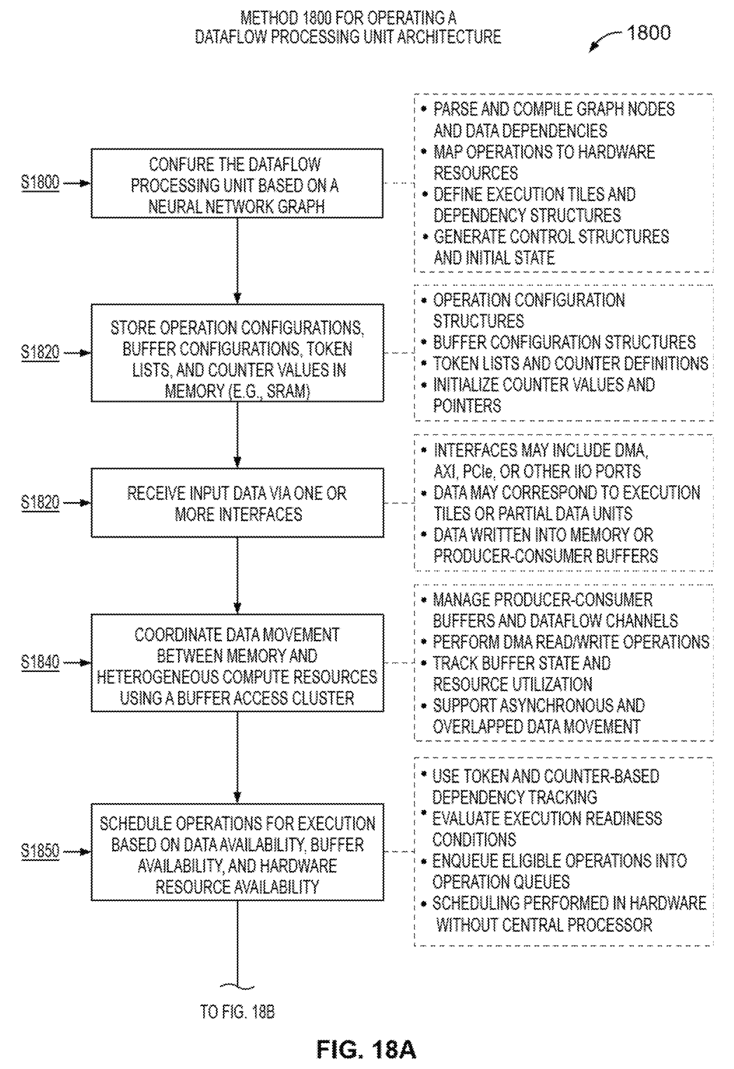

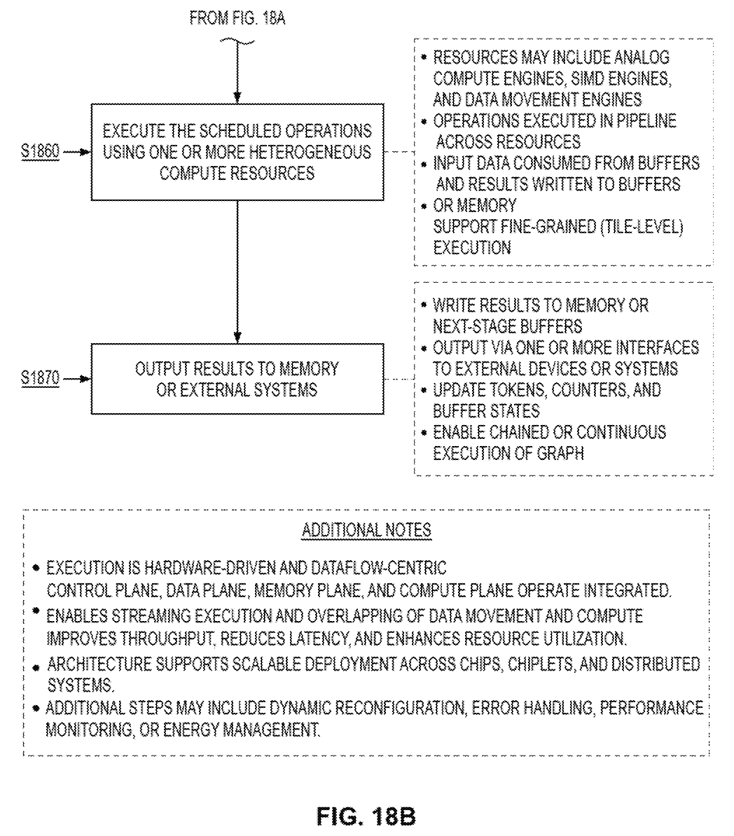

As shown in FIGS. 18A-B, the method 1800 for operating a dataflow processing unit architecture includes configuring the dataflow processing unit based on a neural network graph S1810, storing operation configurations, buffer configurations, token lists, and counter values in memory S1820, receiving input data via one or more interfaces S1830, coordinating data movement between memory and heterogeneous compute resources using a buffer access cluster S1840, scheduling operations for execution based on data availability, buffer availability, and hardware resource availability S1850, executing the scheduled operations using one or more heterogeneous compute resources S1860, and outputting results to memory or external systems S1870.

In some embodiments, method 1800 may be performed by a dataflow processing unit, such as Dataflow Processing Unit 101, operating within a system-on-chip or distributed computing environment. The method 1800 may integrate control-plane, data-plane, memory-plane, and compute-plane functionalities to enable efficient execution of a neural network graph.

In some embodiments, configuration of the dataflow processing unit may include compiling a neural network graph into memory-resident control structures, including operation configuration structures, buffer configuration structures, token lists, and counter definitions. Such configuration may enable hardware-driven execution without reliance on a centralized processor during runtime.

In some embodiments, the method 1800 may support execution using heterogeneous compute resources, including analog compute engines, SIMD engines, and data movement engines. The selection and utilization of such resources may be dynamically determined based on operation type and resource availability.

In some embodiments, data movement and computation may be coordinated using a buffer access cluster and producer–consumer buffers, enabling asynchronous and overlapped execution. The method 1800 may therefore support streaming execution of operations in which data flows continuously through multiple stages of computation.

In some embodiments, scheduling of operations may be performed using a token and counter-based mechanism, where execution readiness is determined based on real-time system state. Such scheduling may enable fine-grained, data-driven execution at a granularity corresponding to execution tiles or partial data units.

In some embodiments, execution of operations may occur in a pipelined manner across multiple compute resources, enabling concurrent processing of different portions of data. The method 1800 may therefore improve throughput and reduce latency relative to conventional execution models.

In some embodiments, the method 1800 may support scalability across multiple dataflow processing units, chips, or chiplets, enabling deployment in a range of environments, including edge devices and data center systems.

In some embodiments, the steps of method 1800 may be performed in a different order, combined, or subdivided into additional steps depending on implementation requirements. Additional steps may include dynamic reconfiguration, error handling, or performance optimization mechanisms.

### 18.1 Configuring the Dataflow Processing Unit

S1810, which includes configuring the dataflow processing unit based on a neural network graph, may function to translate a high-level computational representation into a set of hardware-executable control, memory, and scheduling structures. In a preferred embodiment, configuring the dataflow processing unit includes compiling the neural network graph into memory-resident configuration data structures that define operation execution, data movement, dependency relationships, and scheduling parameters. In such preferred embodiment, the configuration may include mapping graph nodes to heterogeneous compute resources and defining execution at a granularity corresponding to execution tiles. However, in alternative embodiments, configuration may be performed dynamically at runtime, partially offloaded to hardware, or adapted based on workload characteristics.

In some embodiments, configuring the dataflow processing unit may include receiving a neural network graph from a runtime software stack or host system and transforming the graph into a set of operation configuration structures. Each operation configuration structure may define an operation type, input and output buffer mappings, execution parameters (e.g., kernel size, stride, activation type), and associated dependency conditions.

In some embodiments, configuration may include partitioning input data and intermediate data into execution tiles and defining tile-level execution parameters. The configuration may specify tile dimensions, overlap regions, and alignment constraints required for correct computation. Such tile-level configuration may enable partial-data execution and streaming operation across the dataflow processing unit.

In some embodiments, configuring the dataflow processing unit may include generating buffer configuration structures that define producer–consumer buffers used for asynchronous data exchange between operations. The buffer configuration structures may include base addresses, buffer sizes, circular buffer parameters, and access policies enabling concurrent read and write operations.

In some embodiments, configuration may include generating token lists and defining resource counters used for dependency tracking and scheduling. The token lists may define how dataflow trigger events propagate through the system, and the resource counters may define thresholds for execution readiness conditions. Such configuration may enable a fully hardware-driven scheduling model.

In some embodiments, configuring the dataflow processing unit may include mapping operations to specific hardware controllers within a heterogeneous compute domain. For example, matrix multiplication operations may be mapped to analog compute engines, while element-wise operations may be mapped to SIMD engines. The mapping may consider hardware capabilities, performance characteristics, and resource availability.

In some embodiments, configuration may include initializing queue structures used for operation scheduling, including operation queues associated with different hardware controllers. The configuration may define queue sizes, priority levels, and insertion policies to support efficient scheduling.

In some embodiments, configuring the dataflow processing unit may include generating address generation parameters used by a buffer access cluster for performing scatter and gather operations. Such parameters may define how non-contiguous memory regions are accessed to assemble execution tiles.

In some embodiments, configuration may include performing optimization steps, such as reordering operations, fusing operations, or adjusting tile sizes to improve performance and resource utilization. The configuration process may therefore incorporate compiler-level optimizations tailored to the architecture of the dataflow processing unit.

In some embodiments, configuring the dataflow processing unit may be performed partially at compile time and partially at runtime. For example, static aspects of the neural network graph may be compiled into configuration structures, while dynamic aspects, such as input sizes or runtime conditions, may be configured during execution.

In some embodiments, configuring the dataflow processing unit as described may enable subsequent execution steps to proceed without continuous software intervention, thereby allowing the dataflow processing unit to operate in a largely autonomous, hardware-driven manner.

### 18.2 Storing Operation Configurations

S1820, which includes storing operation configurations, buffer configurations, token lists, and counter values in memory, may function to establish a unified, memory-resident control plane that governs execution, scheduling, and data movement within the dataflow processing unit. In a preferred embodiment, storing includes writing configuration and state structures into on-chip memory, such as SRAM, such that hardware components may directly access and update the structures during execution. In such preferred embodiment, the stored structures collectively define execution behavior without requiring continuous software intervention. However, in alternative embodiments, portions of the structures may be stored in off-chip memory, cached in local memory, or distributed across multiple memory hierarchies.

In some embodiments, storing operation configurations may include writing operation descriptors into an operation configuration structure. Each operation descriptor may include operation type, input buffer identifiers, output buffer identifiers, execution parameters, dependency relationships, and hardware mapping information. The operation configuration structure may be indexed by operation identifiers or graph node identifiers and may be accessed by a token and operation manager during scheduling and dispatch.

In some embodiments, storing buffer configurations may include writing definitions of producer–consumer buffers into a buffer configuration structure. The buffer configuration structure may include base addresses, buffer sizes, circular buffer parameters, stride definitions, and access permissions. The buffer configuration structure may further include associations between buffers and specific producer and consumer operations, enabling coordinated data exchange.

In some embodiments, storing token lists may include writing linked or indexed lists of tokenized dependency indicators into memory. Each token list may define how dataflow trigger events propagate through the system, including which resource counters are updated and how dependencies between operations are resolved. The token lists may support chaining, enabling a single event to trigger multiple downstream updates.

In some embodiments, storing counter values may include initializing and maintaining resource counters and operation counters within a counter storage structure. The counters may represent quantities such as data availability, buffer capacity, or dependency satisfaction. Initial counter values may be set during configuration and may be updated dynamically during execution based on tokenized dependency indicators.

In some embodiments, storing the operation configurations, buffer configurations, token lists, and counter values in memory may include organizing the structures into logically distinct regions of memory, such as separate regions for data storage, control structures, and scheduling structures. Such organization may enable efficient access patterns and reduce contention between data and control operations.

In some embodiments, storing the structures may include aligning data structures to memory boundaries optimized for hardware access, such as cache line boundaries or burst transfer sizes. Such alignment may improve memory throughput and reduce access latency.

In some embodiments, storing the structures may include encoding metadata within the structures to support fine-grained execution control. For example, operation configurations may include tile indices, buffer configurations may include region identifiers, and token lists may include propagation metadata. The metadata may enable hardware components to interpret and act upon the stored information efficiently.

In some embodiments, storing the structures may include enabling concurrent access by multiple hardware components. For example, a buffer access cluster may access buffer configurations, while a token and operation manager may access token lists and counter values. Memory arbitration logic may coordinate such concurrent access to ensure consistency and performance.

In some embodiments, storing the structures in memory may enable scalability by allowing the number of operations, buffers, tokens, and counters to scale with available memory capacity rather than being limited by fixed hardware resources. This memory-resident approach may support execution of large and complex neural network graphs.

In some embodiments, storing the structures may include dynamically updating the stored values during execution. For example, counter values may be updated in response to tokenized dependency indicators, and queue-related structures may be updated as operations are scheduled and dispatched. Such dynamic updates may maintain an up-to-date representation of system state.

In some embodiments, storing operation configurations, buffer configurations, token lists, and counter values in memory may provide a foundation for hardware-driven execution, enabling subsequent steps of method 1800 to operate efficiently and autonomously within the dataflow processing unit.

### 18.3 Receiving Input Data

S1830, which includes receiving input data by the dataflow processing unit via one or more interfaces, may function to ingest data into the system for processing in accordance with configured operations and dataflow dependencies. In a preferred embodiment, receiving the input data includes transferring data from an external source into on-chip memory using one or more high-bandwidth interfaces. In such preferred embodiment, the input data may correspond to input tensors associated with a neural network graph. However, in alternative embodiments, the input data may include streaming sensor data, batched data from storage, or intermediate data from another dataflow processing unit.

In some embodiments, receiving the input data may include receiving data via a host interface subsystem, such as a PCIe interface, where a host system transfers input tensors into the dataflow processing unit. In other embodiments, receiving the input data may include receiving data directly from a sensor interface, such as an image sensor interface, enabling real-time processing of streaming data without intermediate storage in a host system.

In some embodiments, receiving the input data may include transferring the input data into memory, such as SRAM or an external memory system, using a buffer access cluster. The buffer access cluster may perform data movement operations, including direct memory access (DMA), to efficiently move the input data into designated memory regions.

In some embodiments, receiving the input data may include partitioning the data into execution tiles as the data is received. For example, the buffer access cluster may perform scatter or gather operations to place portions of the input data into memory locations corresponding to execution tiles defined during configuration. Such partitioning may enable immediate availability of data for tile-based execution.

In some embodiments, receiving the input data may include performing in-stream transformations during data transfer. For example, input data may be normalized, quantized, reformatted, or otherwise transformed as it is written into memory. Such transformations may reduce the need for additional preprocessing operations and may improve efficiency.

In some embodiments, receiving the input data may include generating tokenized dependency indicators corresponding to availability of input data. For example, completion of data transfer for an execution tile may generate a token that updates a resource counter associated with data availability. Such updates may trigger evaluation of execution readiness conditions for operations that depend on the input data.

In some embodiments, receiving the input data may include buffering the data in producer–consumer buffers, enabling asynchronous consumption of the data by downstream operations. The buffering may allow operations to begin execution as soon as sufficient data is available, without waiting for all input data to be received.

In some embodiments, receiving the input data may include handling variable input sizes or dynamic data streams. For example, the dataflow processing unit may adapt buffer allocations and execution parameters based on the size or characteristics of the received data.

In some embodiments, receiving the input data may include coordinating with scheduling logic to ensure that data availability is reflected in resource counters and readiness conditions. Such coordination may enable seamless integration of data ingestion with data-driven scheduling.

In some embodiments, receiving input data via multiple interfaces may enable flexible deployment scenarios, including host-driven processing, sensor-driven processing, or distributed processing across multiple devices. The ability to ingest data efficiently may therefore support a wide range of applications and system architectures.

In some embodiments, receiving the input data as described may provide the initial data required for execution of operations within the dataflow processing unit, enabling subsequent steps of method 1800 to perform data movement, scheduling, and computation in a coordinated manner.

### 18.4 Coordinating Data Movement

S1840, which includes coordinating data movement between memory and heterogeneous compute resources using a buffer access cluster, may function to orchestrate efficient and flexible transfer of data across memory and compute domains within the dataflow processing unit. In a preferred embodiment, coordinating data movement includes issuing one or more buffer access commands that perform scatter, gather, and streaming transfers between memory locations and compute resources. In such preferred embodiment, the buffer access cluster may abstract memory access patterns and enable compute resources to operate on appropriately formatted data without direct involvement in address computation. However, in alternative embodiments, data movement coordination may include direct memory access operations initiated by compute engines, hierarchical data routing, or software-assisted transfer mechanisms.

In some embodiments, coordinating data movement may include generating buffer access commands based on buffer configuration structures and operation configuration structures stored in memory. Each buffer access command may define a source address, a destination address, a transfer size, a stride pattern, and an access mode. The commands may be issued by a token and operation manager or a dedicated data movement scheduler.

In some embodiments, coordinating data movement may include performing scatter operations to assemble execution tiles from non-contiguous memory regions. For example, input tensor data stored in a linear memory layout may be rearranged into tile-aligned structures required by a compute resource. Similarly, gather operations may be used to collect output data from multiple tiles and store the data in a contiguous memory format.

In some embodiments, coordinating data movement may include supporting in-stream operations during data transfer. For example, arithmetic transformations, data type conversions, or normalization operations may be applied as data is moved between memory and compute resources. Such in-stream processing may reduce the need for separate compute operations and may improve overall efficiency.

In some embodiments, coordinating data movement may include managing concurrent data transfers between multiple compute resources and memory. The buffer access cluster may include multiple buffer accessors capable of operating in parallel, enabling simultaneous data movement for different operations or different portions of data.

In some embodiments, coordinating data movement may include interfacing with a memory controller and an interconnect fabric to ensure efficient utilization of memory bandwidth. The coordination may include scheduling transfers to avoid contention, prioritizing critical data transfers, and balancing load across available memory channels.

In some embodiments, coordinating data movement may include updating buffer state indicators and generating tokenized dependency indicators upon completion of data transfers. For example, completion of a data transfer into a producer–consumer buffer may generate tokens that update resource counters associated with data availability, enabling downstream operations to be scheduled.

In some embodiments, coordinating data movement may include managing buffer capacity and ensuring that data is written to memory locations that have sufficient available space. The coordination may include checking buffer capacity counters and preventing write operations that would result in buffer overflow.

In some embodiments, coordinating data movement may include supporting data reuse and locality optimization. For example, data may be retained in local buffers or caches to reduce repeated memory accesses, and transfer patterns may be optimized to maximize reuse of data across multiple operations.

In some embodiments, coordinating data movement may include dynamically adapting transfer patterns based on runtime conditions, such as data access patterns, memory latency, or compute resource utilization. For example, transfer sizes or scheduling priorities may be adjusted to improve throughput or reduce latency.

In some embodiments, coordinating data movement between memory and heterogeneous compute resources may enable seamless integration of data movement with computation, allowing compute resources to operate on data as soon as it becomes available. This tight coupling between data movement and computation may support streaming execution and improve overall system performance.

In some embodiments, coordinating data movement using a buffer access cluster may represent a key architectural feature that decouples memory access complexity from compute logic, enabling scalable and efficient operation of the dataflow processing unit.

### 18.5 Scheduling Operations for Execution

S1850, which includes scheduling operations for execution based on data availability, buffer availability, and hardware resource availability, may function to orchestrate execution of operations within a dataflow processing unit using a data-driven scheduling framework. In a preferred embodiment, scheduling includes evaluating execution readiness conditions using resource counters and tokenized dependency indicators and selecting operations that satisfy the execution readiness conditions for enqueueing and dispatch. In such preferred embodiment, scheduling may be performed by a token and operation manager using memory-resident counter structures and queue structures. However, in alternative embodiments, scheduling may include hybrid hardware-software coordination, static scheduling overlays, or priority-based arbitration mechanisms.

In some embodiments, scheduling operations may include retrieving resource counter values from a counter storage structure stored in SRAM and comparing the resource counter values against threshold values associated with operations. Resource counter values may represent quantities including data availability in producer–consumer buffers, available buffer capacity for output data, and availability of hardware controllers. Threshold values may represent minimum requirements for execution of operations.

In some embodiments, scheduling operations may include evaluating multi-dimensional execution readiness conditions. Execution readiness conditions may require simultaneous satisfaction of multiple constraints, including input data availability for one or more execution tiles, availability of output buffer space, and availability of a target hardware controller. Evaluation of execution readiness conditions may be performed using hardware logic capable of evaluating logical conjunctions and threshold comparisons.

In some embodiments, scheduling operations may include selecting one or more candidate operations from a set of eligible operations. Selection may be based on scheduling policies, including priority-based policies, fairness-based policies, or throughput-optimized policies. Priority levels may be associated with operations based on graph topology, latency sensitivity, or quality-of-service requirements.

In some embodiments, scheduling operations may include performing tile-level scheduling, where execution of an operation is scheduled for a subset of execution tiles rather than an entire tensor. Tile-level scheduling may enable incremental execution and may allow operations to be invoked multiple times as additional data becomes available.

In some embodiments, scheduling operations may include generating operation queue entries corresponding to selected operations. Each operation queue entry may include operation identifiers, input and output buffer addresses, execution parameters, and metadata associated with execution context. Operation queue entries may be written into memory-resident queues associated with hardware controllers.

In some embodiments, scheduling operations may include resolving contention between operations competing for shared resources. Contention resolution may include arbitration mechanisms that consider priority levels, resource utilization, and fairness constraints. Arbitration logic may prevent starvation of lower-priority operations while maintaining efficient utilization of hardware resources.

In some embodiments, scheduling operations may include dynamically adjusting scheduling decisions based on runtime system state. Runtime system state may include data arrival rates, buffer utilization levels, and hardware controller utilization. Scheduling logic may adjust thresholds, priorities, or selection policies to optimize performance metrics, including throughput and latency.

In some embodiments, scheduling operations may include generating tokenized dependency indicators corresponding to scheduling decisions. For example, scheduling of an operation may generate tokens that reserve buffer capacity or mark hardware resources as allocated. Token propagation may update resource counters to reflect transition of operations from a ready state to a scheduled state.

In some embodiments, scheduling operations may be performed in a fully hardware-driven manner without intervention from a centralized processor. Hardware logic within a token and operation manager may continuously monitor resource counters, evaluate readiness conditions, and schedule operations in response to dataflow trigger events.

In some embodiments, scheduling operations based on data availability, buffer availability, and hardware resource availability may enable fine-grained, asynchronous execution across operations in a neural network graph. The scheduling approach may support overlapping execution, reduce idle time of compute resources, and improve overall system throughput.

In some embodiments, scheduling operations as described may represent a departure from conventional instruction-driven scheduling models by enabling a data-driven execution paradigm in which operations are triggered by availability of data and resources rather than by a predetermined execution sequence.

### 18.6 Executing Scheduled Operations

S1860, which includes executing the scheduled operations using one or more heterogeneous compute resources of the dataflow processing unit, may function to perform computation on input data in accordance with operation configurations and scheduling decisions generated in prior steps. In a preferred embodiment, executing the scheduled operations includes processing execution tiles using one or more compute engines selected from a heterogeneous set of compute resources, including analog compute engines, SIMD engines, and data movement engines. In such preferred embodiment, execution may be performed in a tile-wise, streaming manner, enabling incremental generation of output data. However, in alternative embodiments, execution may include batch processing, hybrid execution modes, or adaptive execution strategies based on runtime conditions.

In some embodiments, executing the scheduled operations may include receiving an operation command by a hardware controller associated with a selected compute resource. The operation command may include input buffer addresses, output buffer addresses, execution parameters, and metadata associated with the operation. The hardware controller may configure internal registers and execution pipelines based on the operation command.

In some embodiments, executing the scheduled operations may include retrieving input data corresponding to execution tiles from memory using a buffer access cluster. The buffer access cluster may perform scatter or gather operations to assemble input data in a format required by the compute resource. Retrieved data may be streamed into the compute resource without requiring intermediate storage in additional buffers.

In some embodiments, executing the scheduled operations may include performing computation using specialized compute engines. For example, an analog compute engine may perform matrix-vector multiplication using stored weights, while a SIMD engine may perform element-wise operations such as activation functions or normalization. Execution may be tailored to the capabilities of each compute resource.

In some embodiments, executing the scheduled operations may include maintaining internal state within a compute resource to support partial-data execution. For example, partial results corresponding to subsets of execution tiles may be accumulated across multiple invocations of an operation. Accumulation may occur within registers, local buffers, or memory structures using read-modify-write operations.

In some embodiments, executing the scheduled operations may include performing in-stream operations during data movement within the compute resource. For example, data may be transformed, scaled, or quantized as it flows through execution pipelines. Such in-stream processing may reduce the need for additional operations and may improve efficiency.

In some embodiments, executing the scheduled operations may include generating intermediate outputs corresponding to execution tiles and writing the intermediate outputs to memory, such as producer–consumer buffers. Writing of intermediate outputs may include updating buffer state indicators and generating tokenized dependency indicators to signal availability of data to downstream operations.

In some embodiments, executing the scheduled operations may include overlapping execution across multiple compute resources. For example, while a first compute resource processes a first subset of execution tiles, a second compute resource may process a second subset of execution tiles. Such parallel execution may improve throughput and reduce overall execution time.

In some embodiments, executing the scheduled operations may include handling dependencies between operations through token and counter-based mechanisms. Completion of an operation or generation of output data may trigger updates to resource counters, enabling scheduling of downstream operations.

In some embodiments, executing the scheduled operations may include monitoring execution progress and performance metrics. Hardware controllers may track metrics such as execution latency, throughput, and resource utilization, which may be used to adjust scheduling or execution parameters dynamically.

In some embodiments, executing the scheduled operations using heterogeneous compute resources may enable efficient utilization of specialized hardware capabilities. The ability to map operations to appropriate compute resources may improve performance relative to homogeneous execution models.

In some embodiments, executing the scheduled operations may represent a core stage of the dataflow processing pipeline, in which data is transformed and propagated through successive operations. The execution stage may operate in a streaming and asynchronous manner, enabling continuous flow of data and overlapping execution across operations.

### 18.7 Outputting Results

S1870, which includes outputting results generated by the scheduled operations to memory, a host subsystem, a downstream dataflow processing unit, or an output data destination, may function to externalize computed results and make computed results available for subsequent processing, storage, or consumption. In a preferred embodiment, outputting results includes writing output data corresponding to execution tiles or complete tensors into designated memory regions or transmitting output data through one or more system interfaces. In such preferred embodiment, outputting may occur incrementally as execution progresses, enabling streaming delivery of results. However, in alternative embodiments, outputting may include batched transfer, compression prior to transfer, or formatting based on destination requirements.

In some embodiments, outputting results may include writing data into a designated output buffer located in on-chip memory, such as SRAM, or off-chip memory, such as DRAM. Output buffer regions may be defined in buffer configuration structures and may include metadata specifying destination addresses, data layout, and access policies. Writing of output data may be performed by a buffer access cluster using write commands that define destination memory locations and transfer characteristics.

In some embodiments, outputting results may include transmitting data to a host subsystem via a host interface, such as a PCIe interface. The host subsystem may retrieve output data for further processing, storage, or display. Transmission to the host subsystem may include use of direct memory access operations to efficiently move data without burdening a central processing unit.

In some embodiments, outputting results may include transmitting data to a downstream dataflow processing unit or another processing element through an interconnect fabric or network-on-chip. Such transmission may enable pipelined or distributed processing across multiple devices. Output data may be formatted and packetized according to communication protocols used by the interconnect.

In some embodiments, outputting results may include performing in-stream transformations during data transfer. For example, output data may be quantized, normalized, encoded, or compressed as data is written to memory or transmitted across an interface. Such transformations may reduce memory footprint or bandwidth requirements.

In some embodiments, outputting results may include generating tokenized dependency indicators corresponding to availability of output data. Tokenized dependency indicators may update resource counters associated with downstream operations or systems, enabling continuation of data-driven execution across system boundaries.

In some embodiments, outputting results may include updating buffer state indicators, including write pointers, data availability counters, and buffer capacity counters. Buffer state updates may ensure correct tracking of data availability and memory utilization.

In some embodiments, outputting results may include supporting tile-level output streaming, where output data corresponding to individual execution tiles is made available as soon as computation for each execution tile is complete. Tile-level streaming may enable downstream systems or operations to begin processing without waiting for completion of an entire tensor.

In some embodiments, outputting results may include coordinating with scheduling logic to ensure that output buffer capacity is managed correctly and that data is not overwritten before consumption. Coordination may involve checking buffer capacity counters and enforcing write constraints.

In some embodiments, outputting results may include handling multiple output destinations simultaneously. For example, output data may be written to memory while also being transmitted to a downstream system. Such multi-destination output may be supported through replication of data paths or through staged transfers.

In some embodiments, outputting results generated by scheduled operations may enable integration of the dataflow processing unit into larger systems, including edge devices, data center systems, and distributed processing environments. Output mechanisms may therefore support flexible deployment and interoperability.

In some embodiments, outputting results may represent a final stage of a dataflow execution pipeline, where computed data is made externally visible while maintaining continuous operation of upstream computation and data movement stages.

FIG. 19 illustrates an example embodiment of a tile-based neural network execution model 1910 configured to perform computation using subsets of data corresponding to execution tiles. In some embodiments, the tile-based neural network execution model 1910 may include an Input Node 1901, a Convolution Operation Node 1902, an Activation Operation Node 1903, a MaxPool Operation Node 1904, a Reshape Operation Node 1905, a General Matrix Multiplication (Gemm) Operation Node 1906, a SoftMax Operation Node 1907, and an Output Node 1908 arranged as a neural network graph.

In some embodiments, the Convolution Operation Node 1902 may be configured to perform a convolution operation using a kernel size of 4×4, a stride of 4, and a plurality of filters. The Convolution Operation Node 1902 may receive input data from the Input Node 1901 and may generate intermediate output data for consumption by the Activation Operation Node 1903. A Convolution Tile Execution Structure 1912 may represent execution of the Convolution Operation Node 1902 using a plurality of execution tiles processed sequentially over time.

In some embodiments, the Convolution Tile Execution Structure 1912 may include a plurality of tile execution instances corresponding to Tile 0, Tile 1, Tile 2, and Tile 3. Each tile execution instance may consume a subset of input data and may generate a corresponding subset of output data. Such arrangement may enable execution of the Convolution Operation Node 1902 prior to availability of an entire input tensor.

In some embodiments, the MaxPool Operation Node 1904 may perform pooling operations using subsets of data generated by upstream operations. A MaxPool Tile Execution Structure 1913 may represent execution of the MaxPool Operation Node 1904 using multiple execution tiles processed over time. The MaxPool Tile Execution Structure 1913 may include a plurality of tile execution instances configured to consume subsets of intermediate data and generate corresponding pooled outputs.

In some embodiments, a Convolution Tile Information Structure 1911 may define characteristics associated with execution of the Convolution Operation Node 1902, including quantities of input data consumed and output data produced for each execution interval. A MaxPool Tile Information Structure 1914 may define characteristics associated with execution of the MaxPool Operation Node 1904, including quantities of input data consumed and output data produced during tiled execution.

In some embodiments, execution of the neural network graph may proceed using partial-data availability, such that downstream operations may begin execution prior to completion of all upstream processing. Such arrangement may enable overlapping execution of operations, reduced memory utilization, and increased hardware utilization efficiency.

In some embodiments, the tile-based execution model illustrated in FIG. 19 may be implemented using producer–consumer buffering, token-based dependency tracking, and data-driven scheduling mechanisms as described elsewhere in the present application. Execution tiles may correspond to spatial regions, channel groupings, matrix partitions, or other subdivisions of data structures.

In some embodiments, execution ordering, tile size, tile count, and tile dependency relationships may be determined during compilation or runtime configuration based on hardware resource constraints, memory availability, and execution throughput requirements.

### 20. Parallel Hardware Mapping and Concurrent Graph Execution

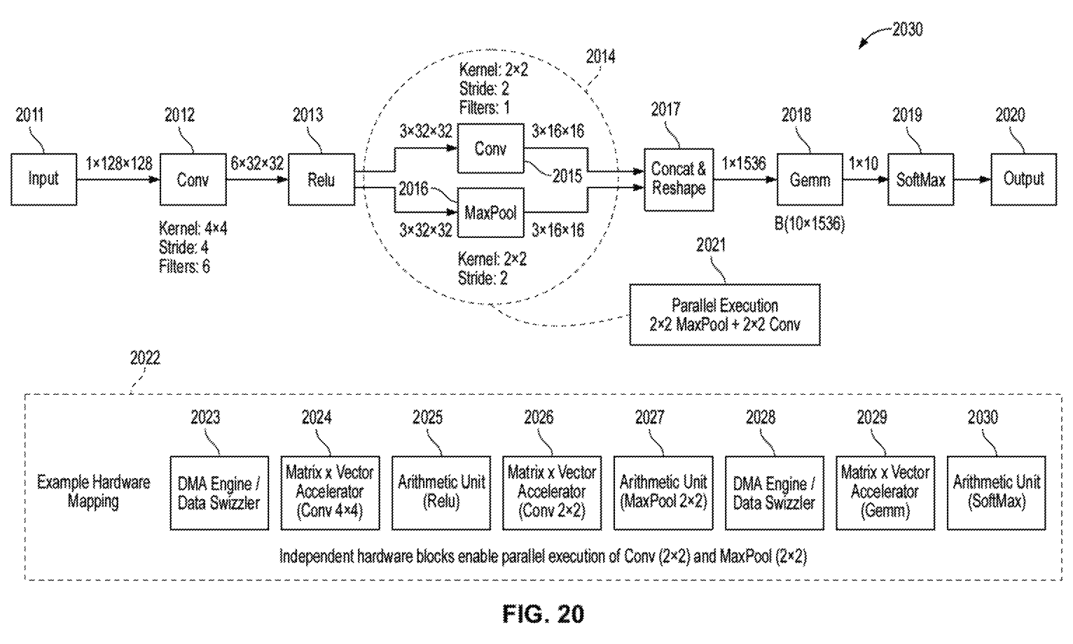

FIG. 20 illustrates an example embodiment of a parallel execution model 2010 configured to enable concurrent execution of multiple operations of a neural network graph within a dataflow processing architecture. In some embodiments, the parallel execution model 2010 may include an Input operation 2011, a first convolution operation 2012, a Relu operation 2013, a parallel execution region 2014, a second convolution operation 2015, a MaxPool operation 2016, a Concat and Reshape operation 2017, a Gemm operation 2018, a SoftMax operation 2019, and an Output operation 2020.

In some embodiments, the Input operation 2011 may provide input tensor data to the first convolution operation 2012. The first convolution operation 2012 may perform convolution processing using a first kernel configuration, including a 4×4 kernel, stride value of 4, and six filters, thereby generating intermediate feature map data. The intermediate feature map data may be provided to the Relu operation 2013 for application of one or more activation functions.

In some embodiments, the parallel execution region 2014 may define a portion of the neural network graph in which multiple operations execute concurrently based on availability of input data and hardware resources. The parallel execution region 2014 may include the second convolution operation 2015 and the MaxPool operation 2016 operating in parallel on data generated by the Relu operation 2013.

In some embodiments, the second convolution operation 2015 may perform convolution processing using a 2×2 kernel, stride value of 2, and one or more filters. The MaxPool operation 2016 may perform pooling operations using a 2×2 pooling window and stride value of 2. The second convolution operation 2015 and the MaxPool operation 2016 may independently consume subsets of input data corresponding to execution tiles or partial tensor regions.

In some embodiments, execution of the second convolution operation 2015 and the MaxPool operation 2016 may occur concurrently using separate hardware resources. The parallel execution model 2010 may thereby permit overlapping execution of operations whose dependency conditions have been satisfied. Such arrangement may reduce idle time of hardware resources and may improve throughput of the dataflow processing architecture.

In some embodiments, outputs generated by the second convolution operation 2015 and the MaxPool operation 2016 may be provided to the Concat and Reshape operation 2017. The Concat and Reshape operation 2017 may combine output tensors generated by the parallel operations and may reorganize tensor dimensions for downstream processing.

In some embodiments, the Gemm operation 2018 may perform one or more matrix multiplication operations on output data generated by the Concat and Reshape operation 2017. Output data generated by the Gemm operation 2018 may be provided to the SoftMax operation 2019, which may generate classification probabilities or other normalized outputs. The Output operation 2020 may output final inference results generated by the neural network graph.

In some embodiments, the parallel execution model 2010 may include a parallel execution indicator 2021 configured to identify operations eligible for concurrent execution. The parallel execution indicator 2021 may indicate that the second convolution operation 2015 and the MaxPool operation 2016 may execute simultaneously using independent hardware controllers or compute engines.

In some embodiments, the parallel execution model 2010 may further include an example hardware mapping region 2022 configured to illustrate mapping of graph operations onto heterogeneous hardware resources. The example hardware mapping region 2022 may include a DMA Engine and Data Swizzler 2023, a Matrix × Vector Accelerator 2024 associated with the first convolution operation 2012, an Arithmetic Unit 2025 associated with the Relu operation 2013, a Matrix × Vector Accelerator 2026 associated with the second convolution operation 2015, an Arithmetic Unit 2027 associated with the MaxPool operation 2016, a DMA Engine and Data Swizzler 2028 associated with data movement operations, a Matrix × Matrix Accelerator 2029 associated with the Gemm operation 2018, and an Arithmetic Unit 2030 associated with the SoftMax operation 2019.

In some embodiments, the DMA Engine and Data Swizzler 2023 and the DMA Engine and Data Swizzler 2028 may perform memory transfer operations, tensor layout transformations, or data formatting operations to support execution of downstream operations. The Matrix × Vector Accelerator 2024 and the Matrix × Vector Accelerator 2026 may perform convolution and matrix-vector computation operations. The Matrix × Matrix Accelerator 2029 may perform matrix multiplication operations associated with fully connected layers or generalized matrix operations.

In some embodiments, the Arithmetic Unit 2025, the Arithmetic Unit 2027, and the Arithmetic Unit 2030 may perform element-wise arithmetic operations, pooling operations, normalization operations, activation operations, or probability computations. The hardware resources illustrated within the example hardware mapping region 2022 may operate concurrently to support streaming execution of neural network graph operations.

In some embodiments, operations of the parallel execution model 2010 may be scheduled dynamically based on data availability, dependency satisfaction, and hardware resource availability. The parallel execution model 2010 may thereby support overlapping execution of graph operations at a granularity corresponding to execution tiles or partial data units.

In some embodiments, execution of operations within the parallel execution model 2010 may be coordinated using producer–consumer buffers, token-based dependency tracking, and data-driven scheduling mechanisms as described elsewhere in the present application. The parallel execution model 2010 may thereby enable improved compute resource utilization, reduced execution latency, and increased throughput relative to serial layer-by-layer execution approaches.

### 21. Buffer Allocation and Line-Buffer Execution Architecture

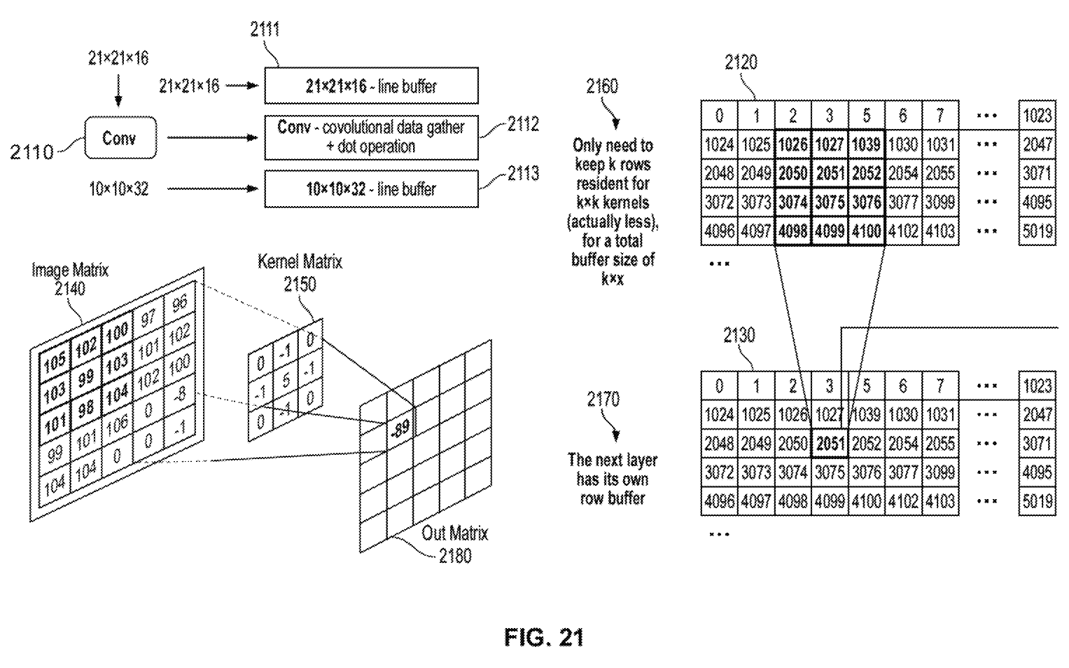

FIG. 21 illustrates an example embodiment of a buffer allocation and line-buffer execution architecture 2110 configured to support tiled execution of neural network operations within a dataflow processing system. In some embodiments, the buffer allocation and line-buffer execution architecture 2110 may include a convolution operation block 2110, an input line buffer 2111, a convolution data gather and dot operation block 2112, and an output line buffer 2113.

In some embodiments, the input line buffer 2111 may temporarily store subsets of input activation data associated with an Image Matrix 2140. The input line buffer 2111 may be implemented as a circular buffer, line buffer, SRAM structure, register array, or other memory structure configured to maintain a subset of rows corresponding to an active convolution window. The convolution data gather and dot operation block 2112 may perform convolution-related computations using data stored within the input line buffer 2111 and coefficients associated with a Kernel Matrix 2150.

In some embodiments, the convolution operation block 2110 may perform tiled execution in which subsets of data are incrementally loaded into the input line buffer 2111 while previously loaded subsets are concurrently processed. Such arrangement may enable partial-data execution and overlapping of data movement and computation operations.

In some embodiments, the output line buffer 2113 may temporarily store output values generated by the convolution data gather and dot operation block 2112 prior to propagation to downstream operations. The output line buffer 2113 may correspond to a line-buffer structure associated with a subsequent processing stage, including a pooling operation, activation operation, normalization operation, or additional convolution operation.

In some embodiments, the Image Matrix 2140 may represent an input activation tensor partitioned into rows, columns, channels, tiles, or other subdivisions. The Kernel Matrix 2150 may represent convolution filter coefficients used to generate output values within an Output Matrix 2180. The Output Matrix 2180 may store output activation values generated from convolution operations performed on subsets of the Image Matrix 2140.

In some embodiments, only a subset of rows associated with the Image Matrix 2140 may be maintained within the input line buffer 2111 at a given time. A Buffer Residency Constraint 2160 may define a quantity of rows maintained in memory during execution of a convolution operation associated with a kernel of size k×k. Such arrangement may reduce overall memory requirements relative to storage of an entire feature map.

In some embodiments, a first line-buffer structure 2120 may correspond to an active processing stage, and a second line-buffer structure 2130 may correspond to a downstream processing stage. The second line-buffer structure 2130 may independently maintain rows associated with downstream execution operations, enabling concurrent execution across multiple pipeline stages. A Subsequent Layer Buffer Structure 2170 may represent independent buffering resources allocated for downstream operations.

In some embodiments, allocation sizes associated with the input line buffer 2111 and the output line buffer 2113 may be statically determined during compilation or configuration of a neural network graph. Buffer allocation decisions may depend on kernel size, stride configuration, tiling strategy, hardware concurrency constraints, memory hierarchy constraints, data reuse characteristics, and bandwidth availability.

In some embodiments, the buffer allocation and line-buffer execution architecture 2110 may enable efficient producer–consumer execution, reduced memory utilization, reduced external memory access frequency, improved data locality, and overlapping execution of multiple operations within a streaming execution pipeline.

Embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the preferred embodiments of the invention without departing from the scope of this invention defined in the following claims.

We claim:

1. A method of accelerating an execution of a neural network graph comprising:
receiving at an input data buffer of a neural network graph an input dataset being partitioned into a plurality of execution tiles, wherein each execution tile of the plurality of execution tiles comprises a subset of the input dataset;
wherein:
the neural network graph is configured with a partial data condition that, when satisfied, causes an execution of the neural network graph using a minimum of a given execution tile of the plurality of execution tiles;
the execution of the neural network graph is configured to repeat a plurality of instances based on a number of execution tiles within the plurality of execution tiles;
causing the execution of the neural network graph based on identifying a storage of an execution tile of the plurality of execution tiles within the input data buffer, wherein the execution of the neural network graph is repeated for the plurality of instances until a tile output is computed for each execution tile of the plurality of execution tiles and the tile output is stored at an output data buffer of the neural network graph.

2. The method according to claim 1, wherein:
the neural network graph comprises a plurality of data transformations represented as a plurality of graphical nodes connected by graphical edges; and
each execution tile of the plurality of execution tiles is propagated through a sequence of the plurality of data transformations until the tile output is independently computed for each execution tile.

3. The method according to claim 1, further comprises:
configuring a token counter for executing each of the plurality of instances of the neural network graph, wherein the token counter is configured based on the number of execution tiles of the plurality of execution tiles.

4. The method according to claim 3, wherein an accumulation of each of the plurality of execution tiles generates an execution token that, when detected, satisfies the partial data condition for causing the execution of the neural network graph.

5. The method according to claim 1, wherein causing the execution of the neural network graph comprises initiating execution of a downstream graphical node of the neural network graph prior to competition of generation of a full tensor output of the input dataset by an upstream graphical node.

6. The method according to claim 5, wherein the downstream graphical node consumes a first subset of tensor data generated by the upstream graphical node while the upstream graphical node concurrently generates a second subset of tensor data.

7. The method according to claim 1, wherein the partial data condition is satisfied based on detection of a threshold quantity of stored tensor data or a threshold quantity of one or more execution tiles.

8. The method according to claim 1, wherein:
the plurality of execution tiles are processed in a pipelined execution sequence;
a first execution tile is consumed by a downstream graphical node of the neural network graph while a second execution tile is concurrently generated by an upstream graphical node.

9. The method according to claim 1, wherein the plurality of execution tiles are generated during a compilation process configured to partition the input dataset according to memory constraints or tensor dimensions.

10. The method according to claim 3, wherein the token counter is incremented or decremented responsive to completion of processing by the neural network graph associated with an execution tile of the plurality of execution tiles.

11. The method according to claim 1, wherein:
the output data buffer comprises a producer-consumer buffer; and
the tile output generated for each execution tile is stored within the producer-consumer buffer accessible by a downstream graphical node.

12. A dataflow processing system for accelerating an execution of a neural network graph, the dataflow processing system comprising:
one or more compute resources;
a memory storing input data and intermediate data;
a buffer access cluster configured to move data between the memory and the one or more compute resources; and
a token and operation manager configured to schedule execution of operations of the neural network graph,
wherein the token and operation manager is configured to:
receive a neural network graph comprising a plurality of operations and data dependencies;
partition input data associated with at least one operation into a plurality of execution tiles;
identify, for a target operation, a subset of execution tiles required to initiate execution of the target operation;
determine that a partial-data execution condition is satisfied based on availability of the subset of execution tiles and without requiring availability of all input data associated with the target operation;
dispatch the target operation to at least one of the one or more compute resources based on the partial-data execution condition;
cause generation of one or more intermediate tile outputs based on execution of the target operation using the subset of execution tiles; and
make the one or more intermediate tile outputs available to at least one downstream operation prior to completion of processing of all execution tiles associated with the target operation.

13. The dataflow processing system of claim 12, wherein the partial-data execution condition comprises a multi-dimensional readiness condition that requires (i) availability of a minimum number of execution tiles corresponding to a tile processing window of the target operation, (ii) availability of output buffer capacity for storing generated intermediate tile outputs, and (iii) availability of at least one compute resource capable of executing the target operation.

14. The dataflow processing system of claim 12, wherein the token and operation manager is further configured to repeatedly dispatch the target operation for execution across successive subsets of execution tiles, such that the target operation is executed incrementally in a streaming manner as additional execution tiles become available.

15. The dataflow processing system of claim 12, wherein making the one or more intermediate tile outputs available comprises writing the one or more intermediate tile outputs to a producer–consumer buffer and generating one or more tokenized dependency indicators that update one or more resource counters associated with the at least one downstream operation.

16. A method for accelerating an execution of a neural network graph using a dataflow processing system, the method comprising:
receiving a neural network graph comprising a plurality of operations and data dependencies;
partitioning input data associated with at least one operation into a plurality of execution tiles;
identifying, for a target operation, a subset of execution tiles required to initiate execution of the target operation;
determining that a partial-data execution condition is satisfied based on availability of the subset of execution tiles and without requiring availability of all input data associated with the target operation;
dispatching the target operation to at least one compute resource based on the partial-data execution condition;
generating one or more intermediate tile outputs based on execution of the target operation using the subset of execution tiles; and
making the one or more intermediate tile outputs available to at least one downstream operation prior to completion of processing of all execution tiles associated with the target operation.

17. The method of claim 16, wherein determining that the partial-data execution condition is satisfied comprises evaluating a multi-dimensional readiness condition including (i) availability of a minimum number of execution tiles corresponding to a tile processing window, (ii) availability of output buffer capacity, and (iii) availability of a compute resource capable of executing the target operation.

18. The method of claim 16, wherein dispatching the target operation comprises repeatedly dispatching the target operation across successive subsets of execution tiles such that execution of the target operation is performed incrementally in a streaming manner.

19. The method of claim 16, wherein making the one or more intermediate tile outputs available comprises writing the one or more intermediate tile outputs to a producer–consumer buffer and generating one or more tokenized dependency indicators corresponding to availability of the one or more intermediate tile outputs.

20. The method of claim 16, wherein generating the one or more intermediate tile outputs comprises performing execution of the target operation on a subset of input data corresponding to a tile processing window and accumulating partial results across multiple subsets of execution tiles to produce a complete output.
